(19) United States
(12) Patent Application Publication
(10) Pub. No.: US 2025/0342004 A1
(43) Pub. Date: Nov. 6, 2025

(54) SOUND SWAPPING OF WEARABLE PLAYBACK DEVICES AND A PLAYBACK ZONE

(71) Applicant: Sonos, Inc., Goleta, CA (US)

(72) Inventors: Alexia Delhoume, Boston, MA (US); Rory Arnold, Glasgow (GB); Sangah Park, Boston, MA (US); Andrew S. T. Lee, Glasgow (GB)

(21) Appl. No.: 19/200,330

(22) Filed: May 6, 2025

Related U.S. Application Data
(60) Provisional application No. 63/643,389, filed on May 6, 2024.
(60) Provisional application No. 63/653,660, filed on May 30, 2024.
(60) Provisional application No. 63/696,589, filed on Sep. 19, 2024.
(60) Provisional application No. 63/696,613, filed on Sep. 19, 2024.

(51) Int. Cl. G06F 3/16; G06F 3/0484

(52) U.S. Cl. CPC G06F 3/165; G06F 3/0484

(57) ABSTRACT

Example technologies described herein relate to sound swapping of a wearable playback device such as “smart” headphones and earbuds with a playback zone of a media playback system. During a “pull swap,” audio playing on one or more playback devices in the playback zone is transitioned to playing back on the wearable playback device in a swap playback session. Conversely, with a “push swap,” the swap playback session ends and playback of the audio is transitioned back to the playback zone.

### CROSS-REFERENCE TO RELATED APPLICATIONS

This application claims the benefit of priority to U.S. Patent Application No. 63/643,389, filed May 6, 2024, U.S. Patent Application No. 63/653,660, filed May 30, 2024, U.S. Patent Application No. 63/696,589, filed Sep. 19, 2024, and U.S. Patent Application No. 63/696,613, filed Sep. 19, 2024, each of which is incorporated herein by reference in its entirety.

### FIELD OF THE DISCLOSURE

The present technology relates to consumer goods and, more particularly, to methods, systems, products, features, services, and other elements directed to voice-assisted control of media playback systems or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings where:

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the playback device of FIG. 2A.

FIG. 2C is a diagram of an example voice input.

FIG. 2D is a graph depicting an example sound specimen in accordance with aspects of the disclosure.

FIGS. 3A, 3B, 3C, 3D and 3E are diagrams showing example playback device configurations in accordance with aspects of the disclosure.

FIG. 4 is a functional block diagram of an example controller device in accordance with aspects of the disclosure.

FIGS. 5A and 5B are controller interfaces in accordance with aspects of the disclosure.

FIG. 6 is a message flow diagram of a media playback system.

FIG. 7A is a functional block diagram of an example wearable playback device in accordance with aspects of the disclosure.

FIGS. 7B and 7C are isometric diagrams of an example wearable playback device in accordance with aspects of the disclosure.

FIGS. 8A, 8B, and 8C are diagrams illustrating an example home theatre room and example home theatre sound swap in the example home theatre room in accordance with aspects of the disclosure.

FIG. 9A is a block diagram illustrating an example sound swap architecture in accordance with aspects of the disclosed technology.

FIG. 9B is a block diagram illustrating example sound swap topology and example data structures representing such topology in accordance with aspects of the disclosed technology.

FIGS. 10A, 10B, 10C, 10D, and 10E are message flow diagrams for setup and initiation of sound swap in accordance with aspects of the disclosed technology.

FIGS. 11A, 11B, 11C, and 11D are diagrams illustrating example sound swaps with different headphone and home theatre primary states in accordance with aspects of the disclosed technology.

FIGS. 12A, 12B, 12C, 12D, 12E, 12F, 12G, 12H, 12I, and 12J are example graphical user interface elements for setup of sound swap in accordance with aspects of the disclosed technology.

FIGS. 13A, 13B, 13C, 13D, 13E, 13F, 13G, 13H, 13I, 13J, 13K, 13L, 13M, 13N, 130, 13P, 13Q, 13R, 13S, 13T, 13U, 13V, 13W, 13X, and 13Y are example graphical user interface elements for sound swap in accordance with aspects of the disclosed technology.

FIGS. 14A, 14B, 14C, 14D, 14E, and 14F are example graphical user interface elements for sound swap in accordance with aspects of the disclosed technology.

FIG. 15 is a flow diagram of an example method to facilitate sound swap in accordance with aspects of the disclosed technology.

FIG. 16 is a flow diagram of an example method to facilitate sound swap in accordance with aspects of the disclosed technology.

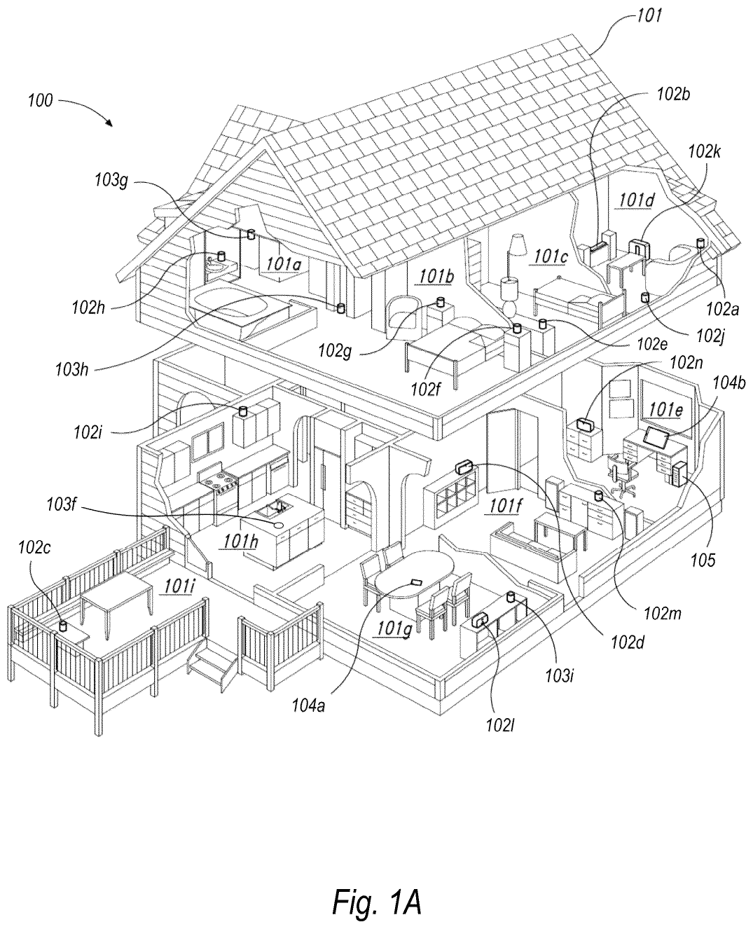

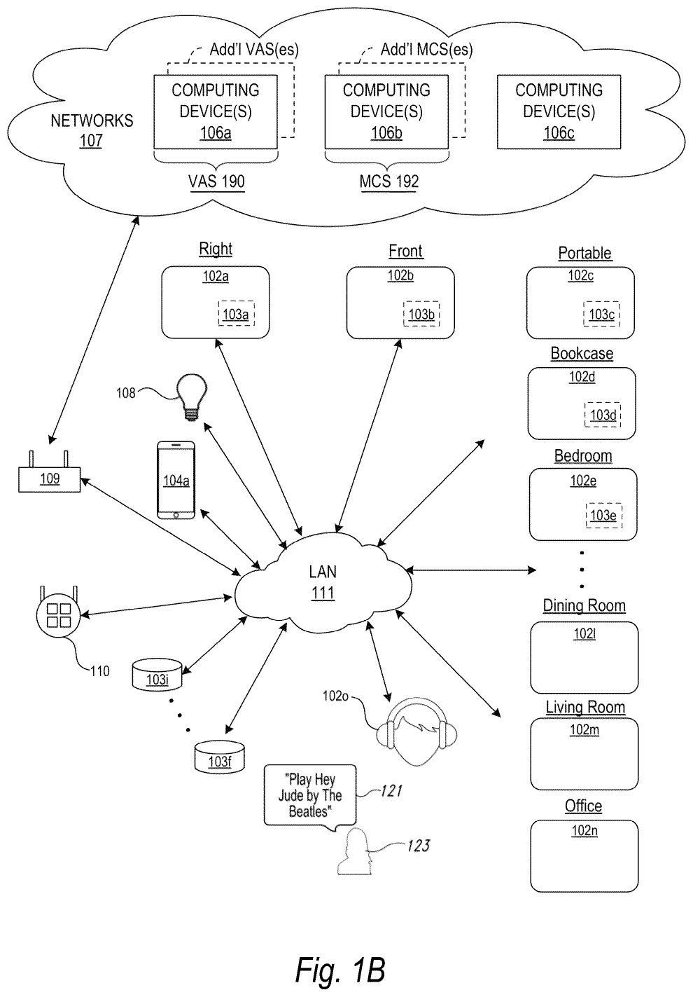

The drawings are for purposes of illustrating example embodiments, but it should be understood that the inventions are not limited to the arrangements and instrumentality shown in the drawings. In the drawings, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### DETAILED DESCRIPTION

### I. Overview

Example technologies described herein relate to sound swapping of a wearable playback device such as “smart” headphones and earbuds with a playback zone of a media playback system. During a “pull swap,” audio playing on one or more playback devices in the playback zone is transitioned to playing back on the wearable playback device in a swap playback session. Conversely, with a “push swap,” the swap playback session ends and playback of the audio is transitioned back to the playback zone.

To facilitate home theatre usage, a playback device in the playback zone may be connected to a television via an input interface (e.g., via a high-definition multimedia (HDMI) cable and corresponding ports). When audio is received from the television, this playback device (referred to herein as “a home theatre primary”) plays back all or some of the audio. The playback device may also stream audio signals representing some or all of the television audio to other playback devices in the zone, such as to additional playback devices configured as surrounds or to a subwoofer.

One example use case of sound swapping is playback of the television audio on the wearable playback device. During a “pull swap,” television audio playing on the one or more playback devices is transitioned to playing back on the wearable playback device. To facilitate this transition, during a swap playback session, the playback device streams one or more audio channels representing television audio playing in the playback zone to the wearable playback device for playback. Conversely, with a “push swap,” the swap playback session ends and playback of the television audio is transitioned back to the playback zone. From the user's perspective, the pull swap transitions the playback from out loud playback on the home theatre primary to personal playback on the wearable playback device and the push swap reverses this transition and transitions playback from personal playback on the wearable playback device to out loud playback on the home theatre primary.

A sound swap involves both a source and a target. Example technologies involve a pairing phase between the wearable playback device and a swap-eligible playback device to pre-designate possible sources and targets. During this pairing phase, the swap-eligible playback device adds the wearable playback device as a trusted accessory. Similarly, the wearable device adds the swap-eligible playback device as a trusted home theatre primary.

The pairing phase may also involve exchange of authentication information to facilitate future sound swaps. For instance, the swap-eligible playback device may share a pre-shared key for a wireless local area network (WLAN) with the wearable playback device. The wearable playback device may then use the pre-shared key to connect to the WLAN and stream audio during a swap playback session.

Given this pre-pairing, a sound swap may be initiated with minimal user involvement. Within examples, a pull swap may be initiated via a particular input (e.g., a long press) to a button or other physical interface on a housing of the wearable device. In this case, the target and source are automatically designed as the wearable device and the home theatre primary, respectively, by virtue of the pre-pairing. Conversely, when there is an active swap playback session, the same input may be used to initiate a push swap. Here, the target and source are automatically designed as the home theatre primary and the wearable device, respectively, to reverse the pull swap. In contrast, headphones using Bluetooth alone could be paired with a television, but involve time-intensive and multi-step process via menus to re-connect the headphones and change the output.

Example media playback systems may use controller devices (e.g., smartphones or other mobile devices with a controller app installed) to control functions of the media playback systems. A wearable playback device may be paired to a particular controller device via Bluetooth (e.g., Bluetooth Low Energy) and/or other technology for determining proximity (e.g., ultrawideband (UWB), ultrasonic audio chirp, which allows that controller device to control playback on the wearable device (in addition to the playback devices in the media playback system) via a graphical user interface. This graphical user interface may also include a control to initiate a swap playback session with trusted home theatre primaries. Similar to the initiation via the physical control on the wearable playback device, the target and source need not be designated at the time of initiation, as the devices are pre-paired.

In some cases, a wearable playback device may be paired with more than one trusted home theatre primary. In that case, the source of a sound swap may be automatically selected from among the trusted home theatre primaries based on which trusted home theatre primary is discoverable via a Bluetooth connection (e.g., a Bluetooth Low Energy connection), as such a connection indicates proximity. In further examples, the user may be prompted to select among the trusted home theatre primaries using the graphical user interface of the controller device. In such examples, to facilitate selection, the nearest trusted home theatre primary (e.g., as determined by Bluetooth discoverability) may be pre-selected in the prompt, so that the user need only confirm that device if they desire for the sound swap source to be that home theatre primary.

Further, more than one wearable playback device may be paired to a trusted home theatre primary. Such configuration facilitates multiple concurrent wearable playback devices in a swap playback session. In such sessions, the home theatre primary streams the television audio to each wearable playback device. In some examples, the number of concurrent wearable playback devices in a swap playback session is programmatically limited to a particular number (e.g., two) to facilitate reliable streaming performance during the swap playback session. If the sound swap is implemented with a higher bandwidth streaming technology, the programmatic limitation may be revised upwards (e.g., to four or more) or lifted altogether, depending on the capabilities of the wireless technology used for streaming.

While television audio has been described above by way of example, the example technologies may also be used with other content sources, such as an audio line-in or streaming audio. In contrast to television audio or line-in audio, which is received via a physical input interface, streaming audio need not be received via a home theatre primary or other playback device that includes the physical input interface. Instead, the wearable playback device (or by proxy, its paired controller device) may start streaming the transitioned audio from the source. This arrangement may free up the source playback device to play back other audio, or to save power by going into a sleep or suspend mode.

As noted above, example technologies relate to sound swapping. An example may include: while a first home theatre swap session is active on a wireless headphone, detecting, by one of (a) a controller device or (b) the wireless headphone, a home theatre swap event for the wireless headphone, wherein the wireless headphone is configured to play back one or more first audio tracks that are streamed from a playback device during the first home theatre swap session, and wherein the one or more first audio tracks are based on first audio received via an input interface from a television; in response to the first home theatre swap command, initiating a home theatre push swap according to the home theatre swap event, wherein the home theatre push swap ends the first home theatre swap session, and wherein the wireless headphone ceases playback of the one or more first audio tracks when the first home theatre swap session ends; while no home theatre swap session is active on the wireless headphone, receiving, by one of (a) the controller device or (b) the wireless headphone, a home theatre swap command for the wireless headphone; and in response to the home theatre swap command, initiating a home theatre pull swap according to (i) a state of the playback device and (ii) a state of the wireless headphone, wherein the home theatre pull swap starts a second home theatre swap session, wherein the wireless headphone is configured to play back one or more second audio tracks that are streamed from the playback device during the second home theatre swap session, and wherein the one or more second audio tracks are based on second audio received via the input interface from the television.

Another example may include receiving, via a graphical user interface displayed on a controller device, input data representing a command to initiate swap pairing of the wireless headphone; based on receiving the command to initiate the swap pairing, sending, via a first wireless local area network (WLAN) to a playback device, data representing a command to add the wireless headphone as a trusted accessory for swap; receiving, via the first WLAN from the playback device, a pre-shared key for a second WLAN; sending, via a Bluetooth personal area network, data representing (i) a command to add the playback device as a paired home theatre primary and (ii) the pre-shared key, wherein the wireless headphone adds the playback device as a trusted playback device for swap; receiving, by one of (a) the controller device or (b) the wireless headphone, a home theatre swap command for the wireless headphone; and in response to the home theatre swap command, initiating a home theatre pull swap, wherein the home theatre pull swap starts a home theatre swap session and causes the wireless headphone to join the second WLAN using the pre-shared key, wherein the wireless headphone is configured to play back one or more audio tracks that are streamed from the playback device via the second WLAN during the home theatre swap session, and wherein the one or more audio tracks are based on audio received via an input interface of the playback device from a television.

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one element or function is a necessary result of another function or element. For the sake of brevity, functions are generally described as being based on another function when a functional link exists; however, such disclosure should be understood as disclosing either type of functional relationship.

### II. Example Operation Environment

FIGS. 1A and 1B illustrate an example configuration of a media playback system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b, (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-1020), network microphone devices 103 (identified individually as “NMDs” 103a-102i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A).

In embodiments described below, one or more of the various playback devices 102 may be configured as portable playback devices, while others may be configured as stationary playback devices. For example, the headphones 1020 (FIG. 1B) are a portable playback device, while the playback device 102d on the bookcase may be a stationary device. As another example, the playback device 102c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices 102, 103, and 104 and/or other network devices of the MPS 100 may be coupled to one another via point-to-point connections and/or over other connections, which may be wired and/or wireless, via a network 111, such as a LAN including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related embodiment, the Left playback device 102j may communicate with other network devices, such as the playback device 102b, which may be designated as the “Front” device, via a point-to-point connection and/or other connections via the NETWORK 111.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a VAS and at least one remote computing device associated with a media content service (“MCS”). For instance, in the illustrated example of FIG. 1B, remote computing devices 106 are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the playback devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 1021, 102m, and 102n, which are named “Bedroom,” “Dining Room,” “Living Room,” and “Office,” respectively. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the network 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. application Ser. No. 15/438,749 filed Feb. 21, 2017, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. application Ser. No. 15/438,749.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 102l, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. patent application No.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the NETWORK 111 (FIG. 1B) may be eliminated and the single playback device 102 and/or the single NMD 103 may communicate directly with the remote computing devices 106-d. In some embodiments, a telecommunication network (e.g., an LTE network, a 5G network, etc.) may communicate with the various playback, network microphone, and/or controller devices 102-104 independent of a LAN.

### a. Example Playback & Network Microphone Devices

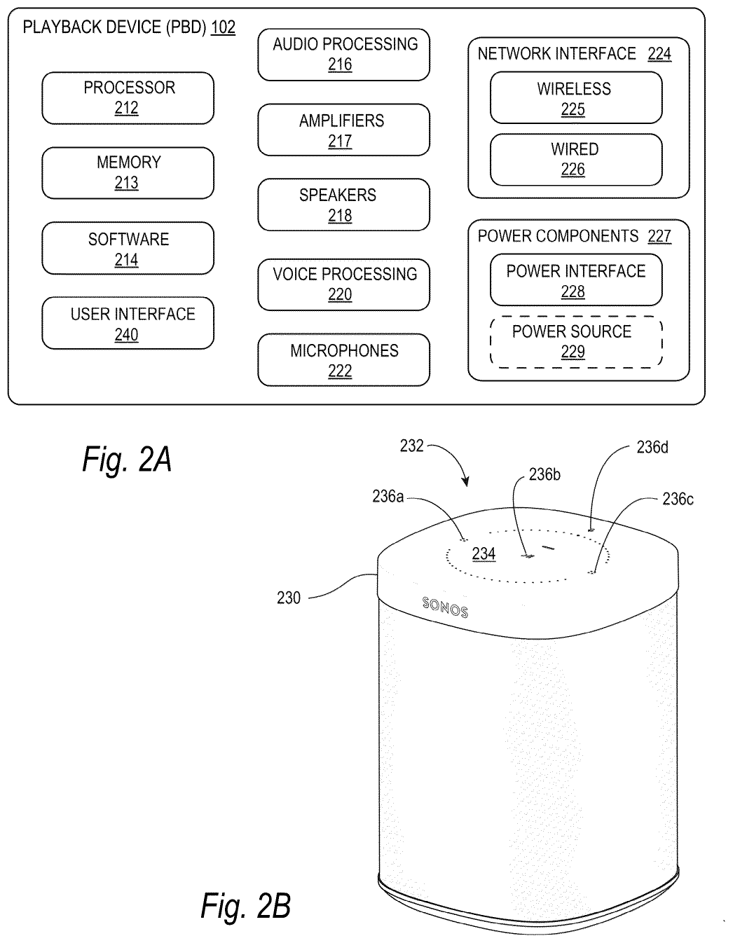

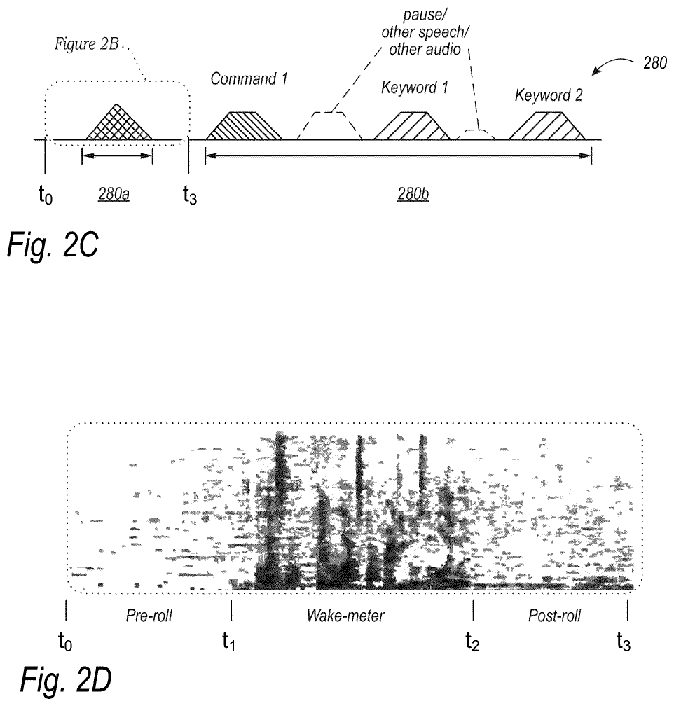

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the playback device to external speakers. In certain embodiments, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A include both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the playback device 102.

By way of illustration, SONOS, Inc. presently offers (or has offered) for sale certain playback devices that may implement certain of the embodiments disclosed herein, including a “PLAY: 1,” “PLAY: 3,” “PLAY: 5,” “PLAYBAR,” “CONNECT: AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIG. 2A or 2B or to the SONOS product offerings. For example, a playback device may include, or otherwise take the form of, a wired or wireless headphone set, which may operate as a part of the MPS 100 via a network interface or the like. In another example, a playback device may include or interact with a docking station for personal mobile media playback devices. In yet another example, a playback device may be integral to another device or component such as a television, a lighting fixture, or some other device for indoor or outdoor use.

FIG. 2C is a diagram of an example voice input 280 that may be processed by an NMD or an NMD-equipped playback device. The voice input 280 may include a keyword portion 280a and an utterance portion 280b. The keyword portion 280a may include a wake word or a local keyword.

In the case of a wake word, the keyword portion 280a corresponds to detected sound that caused a VAS wake-word event. In practice, a wake word is typically a predetermined nonce word or phrase used to “wake up” an NMD and cause it to invoke a particular voice assistant service (“VAS”) to interpret the intent of voice input in detected sound. For example, a user might speak the wake word “Alexa” to invoke the AMAZON® VAS, “Ok, Google” to invoke the GOOGLE® VAS, or “Hey, Siri” to invoke the APPLE® VAS, among other examples. In practice, a wake word may also be referred to as, for example, an activation-, trigger-, wakeup-word or -phrase, and may take the form of any suitable word, combination of words (e.g., a particular phrase), and/or some other audio cue.

The utterance portion 280b corresponds to detected sound that potentially comprises a user request following the keyword portion 280a. An utterance portion 280b can be processed to identify the presence of any words in detected-sound data by the NMD in response to the event caused by the keyword portion 280a. In various implementations, an underlying intent can be determined based on the words in the utterance portion 280b. In certain implementations, an underlying intent can also be based or at least partially based on certain words in the keyword portion 280a, such as when keyword portion includes a command keyword. In any case, the words may correspond to one or more commands, as well as a certain command and certain keywords.

A keyword in the voice utterance portion 280b may be, for example, a word identifying a particular device or group in the MPS 100. For instance, in the illustrated example, the keywords in the voice utterance portion 280b may be one or more words identifying one or more zones in which the music is to be played, such as the Living Room and the Dining Room (FIG. 1A). In some cases, the utterance portion 280b may include additional information, such as detected pauses (e.g., periods of non-speech) between words spoken by a user, as shown in FIG. 2C. The pauses may demarcate the locations of separate commands, keywords, or other information spoke by the user within the utterance portion 280b.

Based on certain command criteria, the NMD and/or a remote VAS may take actions as a result of identifying one or more commands in the voice input. Command criteria may be based on the inclusion of certain keywords within the voice input, among other possibilities. Additionally, state and/or zone-state variables in conjunction with identification of one or more particular commands. Control-state variables may include, for example, indicators identifying a level of volume, a queue associated with one or more devices, and playback state, such as whether devices are playing a queue, paused, etc. Zone-state variables may include, for example, indicators identifying which, if any, zone players are grouped.

In some implementations, the MPS 100 is configured to temporarily reduce the volume of audio content that it is playing upon detecting a certain keyword, such as a wake word, in the keyword portion 280a. The MPS 100 may restore the volume after processing the voice input 280. Such a process can be referred to as ducking, examples of which are disclosed in U.S. patent application Ser. No. 15/438,749, incorporated by reference herein in its entirety.

FIG. 2D shows an example sound specimen. In this example, the sound specimen corresponds to the sound-data stream (e.g., one or more audio frames) associated with a spotted wake word or command keyword in the keyword portion 280a of FIG. 2A. As illustrated, the example sound specimen comprises sound detected in an NMD's environment (i) immediately before a wake or command word was spoken, which may be referred to as a pre-roll portion (between times to and t1), (ii) while a wake or command word was spoken, which may be referred to as a wake-meter portion (between times t1 and t2), and/or (iii) after the wake or command word was spoken, which may be referred to as a post-roll portion (between times t2 and t3). Other sound specimens are also possible. In various implementations, aspects of the sound specimen can be evaluated according to an acoustic model which aims to map mels/spectral features to phonemes in a given language model for further processing. For example, automatic speech recognition (ASR) may include such mapping for command-keyword detection. Wake-word detection engines, by contrast, may be precisely tuned to identify a specific wake-word, and a downstream action of invoking a VAS (e.g., by targeting only nonce words in the voice input processed by the playback device).

ASR for local keyword detection may be tuned to accommodate a wide range of keywords (e.g., 5, 10, 100, 1,000, 10,000 keywords). Local keyword detection, in contrast to wake-word detection, may involve feeding ASR output to an onboard, local NLU which together with the ASR determine when local keyword events have occurred. In some implementations described below, the local NLU may determine an intent based on one or more keywords in the ASR output produced by a particular voice input. In these or other implementations, a playback device may act on a detected command keyword event only when the playback devices determines that certain conditions have been met, such as environmental conditions (e.g., low background noise).

### b. Example Playback Device Configurations

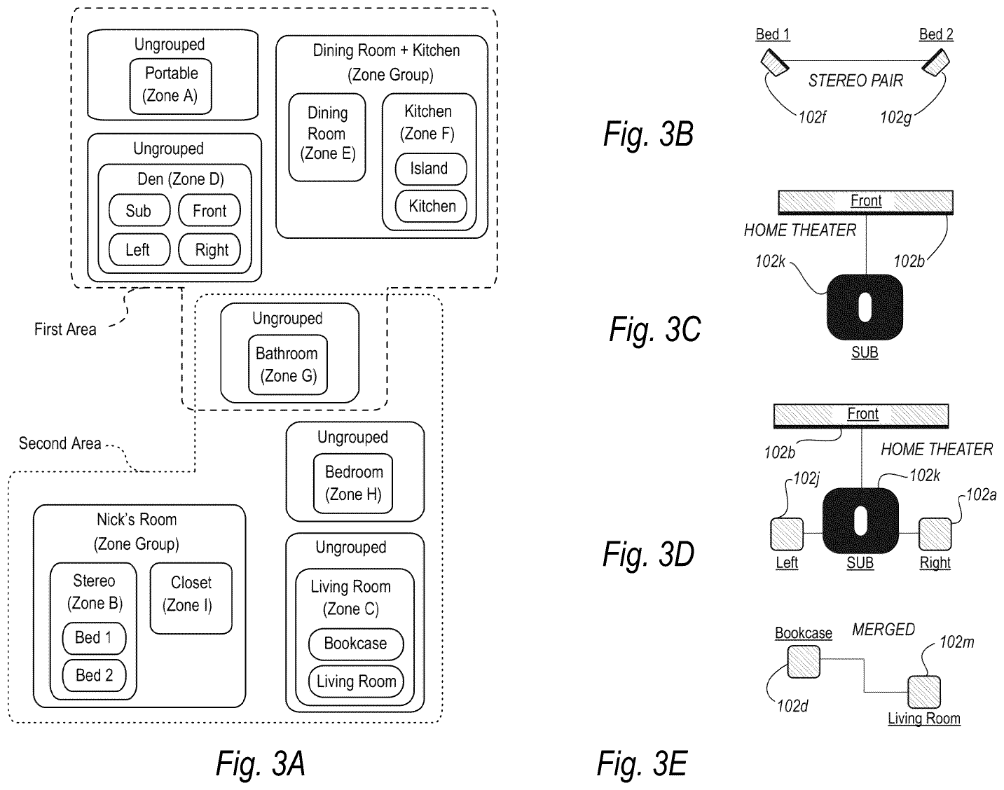

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various embodiments, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the playback devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in previously referenced U.S. patent application Ser. No. 15/438,749. In some embodiments, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room+Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the MPS 100, which may be shared from time to time among the devices so that one or more of the devices have the most recent data associated with the system.

In some embodiments, the memory 213 of the playback device 102 may store instances of various variable types associated with the states. Variables instances may be stored with identifiers (e.g., tags) corresponding to type. For example, certain identifiers may be a first type “al” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In embodiments described below, the memory 213 is configured to store a set of command data for selecting a particular VAS when processing voice inputs. During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone.

For instance, the user may be in the Office zone where the playback device 102n is playing the same hip-hop music that is being playing by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

### c. Example Controller Devices

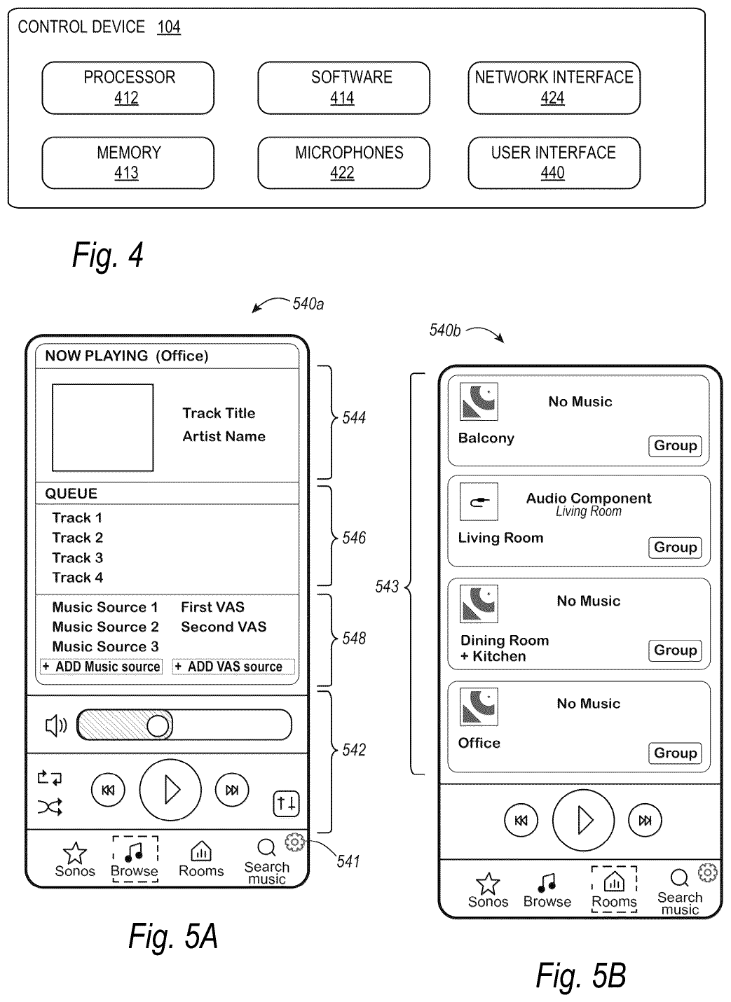

FIG. 4 is a functional block diagram illustrating certain aspects of a selected one of the controller devices 104 of the MPS 100 of FIG. 1A. Such controller devices may also be referred to herein as a “control device” or “controller.” The controller device shown in FIG. 4 may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

As shown in FIG. 4, the controller device 104 also includes a user interface 440 that is generally configured to facilitate user access and control of the MPS 100. The user interface 440 may include a touch-screen display or other physical interface configured to provide various graphical controller interfaces, such as the controller interfaces 540a and 540b shown in FIGS. 5A and 5B. Referring to FIGS. 5A and 5B together, the controller interfaces 540a and 540b includes a playback control region 542, a playback zone region 543, a playback status region 544, a playback queue region 546, and a sources region 548. The user interface as shown is just one example of an interface that may be provided on a network device, such as the controller device shown in FIG. 4, and accessed by users to control a media playback system, such as the MPS 100. Other user interfaces of varying formats, styles, and interactive sequences may alternatively be implemented on one or more network devices to provide comparable control access to a media playback system.

The playback control region 542 (FIG. 5A) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The playback control region 542 may also include selectable icons that, when selected, modify equalization settings and/or playback volume, among other possibilities.

The playback zone region 543 (FIG. 5B) may include representations of playback zones within the MPS 100. The playback zones regions 543 may also include a representation of zone groups, such as the Dining Room+Kitchen zone group, as shown.

In some embodiments, the graphical representations of playback zones may be selectable to bring up additional selectable icons to manage or configure the playback zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 543 (FIG. 5B) may be dynamically updated as playback zone or zone group configurations are modified.

The playback status region 544 (FIG. 5A) may include graphical representations of audio content that is presently being played, previously played, or scheduled to play next in the selected playback zone or zone group. The selected playback zone or zone group may be visually distinguished on a controller interface, such as within the playback zone region 543 and/or the playback status region 544. The graphical representations may include track title, artist name, album name, album year, track length, and/or other relevant information that may be useful for the user to know when controlling the MPS 100 via a controller interface.

The playback queue region 546 may include graphical representations of audio content in a playback queue associated with the selected playback zone or zone group. In some embodiments, each playback zone or zone group may be associated with a playback queue comprising information corresponding to zero or more audio items for playback by the playback zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 5A and 5B, the graphical representations of audio content in the playback queue region 646 (FIG. 5A) may include track titles, artist names, track lengths, and/or other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 548 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to one or both of the NMDs 102a and 102b in the Living Room shown in FIG. 1A, and a second VAS to the NMD 103f in the Kitchen. Other examples are possible.

### d. Example Audio Content Sources

The audio sources in the sources region 548 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some embodiments audio content may be provided by one or more media content services.

Example audio content sources may include a memory of one or more playback devices in a media playback system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media playback system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

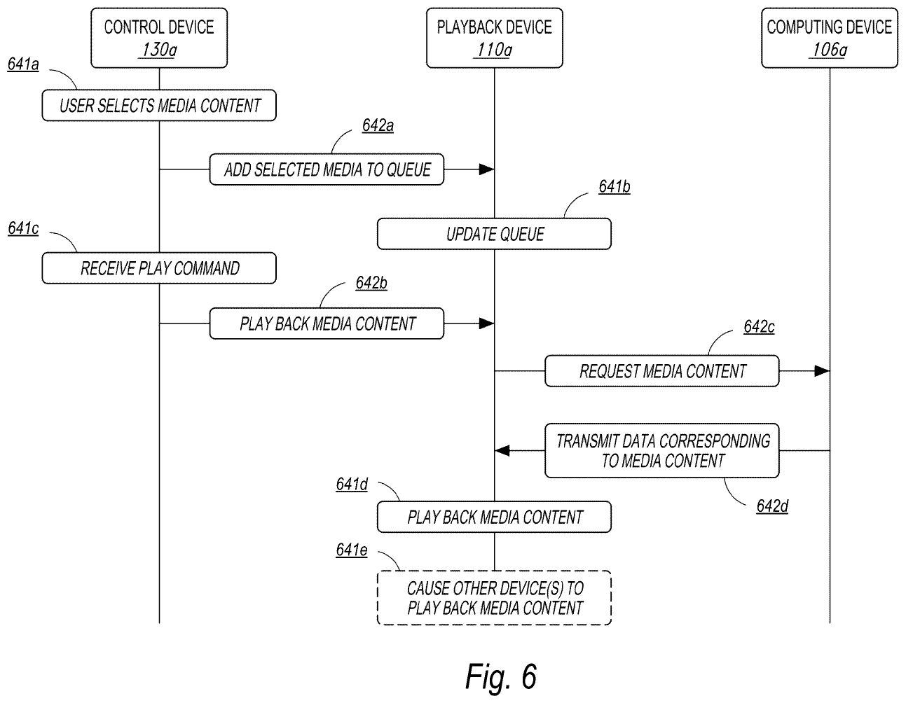

FIG. 6 is a message flow diagram illustrating data exchanges between devices of the MPS 100. At step 641a, the MPS 100 receives an indication of selected media content (e.g., one or more songs, albums, playlists, podcasts, videos, stations) via the control device 104. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 104 transmits a message 642a to the playback device 102 (FIGS. 1A-1C) to add the selected media content to a playback queue on the playback device 102.

At step 641b, the playback device 102 receives the message 642a and adds the selected media content to the playback queue for play back.

At step 641c, the control device 104 receives input corresponding to a command to play back the selected media content. In response to receiving the input corresponding to the command to play back the selected media content, the control device 104 transmits a message 642b to the playback device 102 causing the playback device 102 to play back the selected media content. In response to receiving the message 642b, the playback device 102 transmits a message 642c to the computing device 106 requesting the selected media content. The computing device 106, in response to receiving the message 642c, transmits a message 642d comprising data (e.g., audio data, video data, a URL, a URI) corresponding to the requested media content.

At step 641d, the playback device 102 receives the message 642d with the data corresponding to the requested media content and plays back the associated media content.

At step 641e, the playback device 102 optionally causes one or more other devices to play back the selected media content. In one example, the playback device 102 is one of a bonded zone of two or more players (FIG. 1M). The playback device 102 can receive the selected media content and transmit all or a portion of the media content to other devices in the bonded zone. In another example, the playback device 102 is a coordinator of a group and is configured to transmit and receive timing information from one or more other devices in the group. The other one or more devices in the group can receive the selected media content from the computing device 106, and begin playback of the selected media content in response to a message from the playback device 102 such that all of the devices in the group play back the selected media content in synchrony.

Within examples, such messages may conform to one or more protocols or interfaces (e.g., an Application Programming Interface). A platform API may support one or more namespaces that include controllable resources (e.g., the playback devices 102 and features thereof). Various functions may modify the resources and thereby control actions on the playback devices 102. For instance, HTTP request methods such as GET and POST may request and modify various resources in a namespace. Example namespaces in a platform API include playback (including controllable resources for playback), playbackMetadata (including metadata resources related to playback), volume (including resources for volume control), playlist (including resources for queue management), and groupVolume (including resources for volume control of a synchrony group), among other examples. Among other examples, such messages may conform to a standard, such as universal-plug-and-play (uPnP).

### III. Example Sound Swap

As noted in the Overview, example technologies described herein relate to sound swapping of wearable playback devices, such as headphones and earbuds, with non-wearable playback devices. Such technologies may allow a user to conveniently switch between listening to content out-loud and listening to content privately. For instance, when others in a household go to sleep, a user may continue watching television, albeit quietly, by swapping sound between a playback zone playing the television audio and their headphones. To the user, the audio should be perceived as a seamless swap where the content listed on the headphones continues from where out-loud playback ended such that the user does not miss any of the content being played back. In some instances, there may be a slight overlap or simultaneous playback of audio (e.g., 5 ms-1 s) to facilitate a seamless experience.

### a. Example Wearable Playback Devices

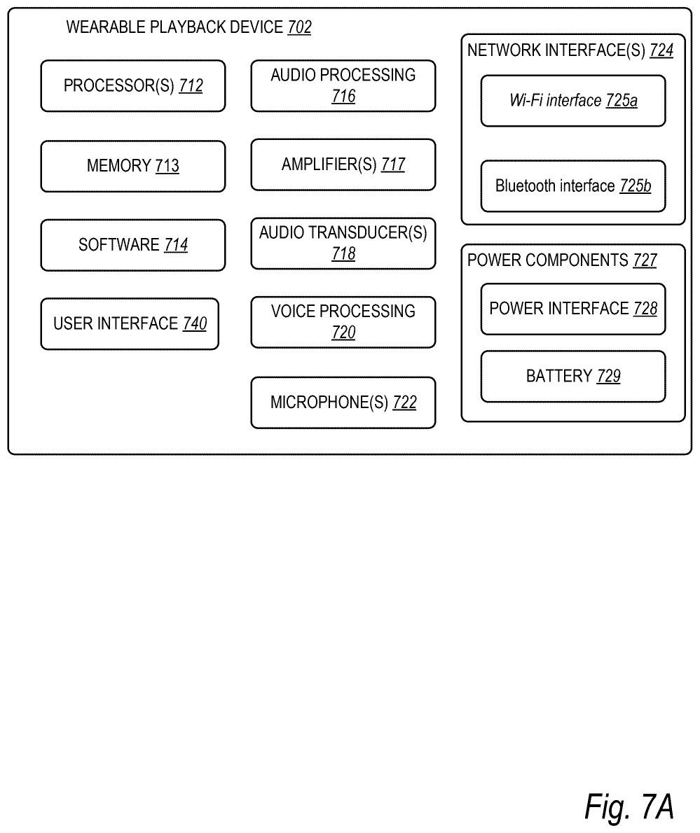

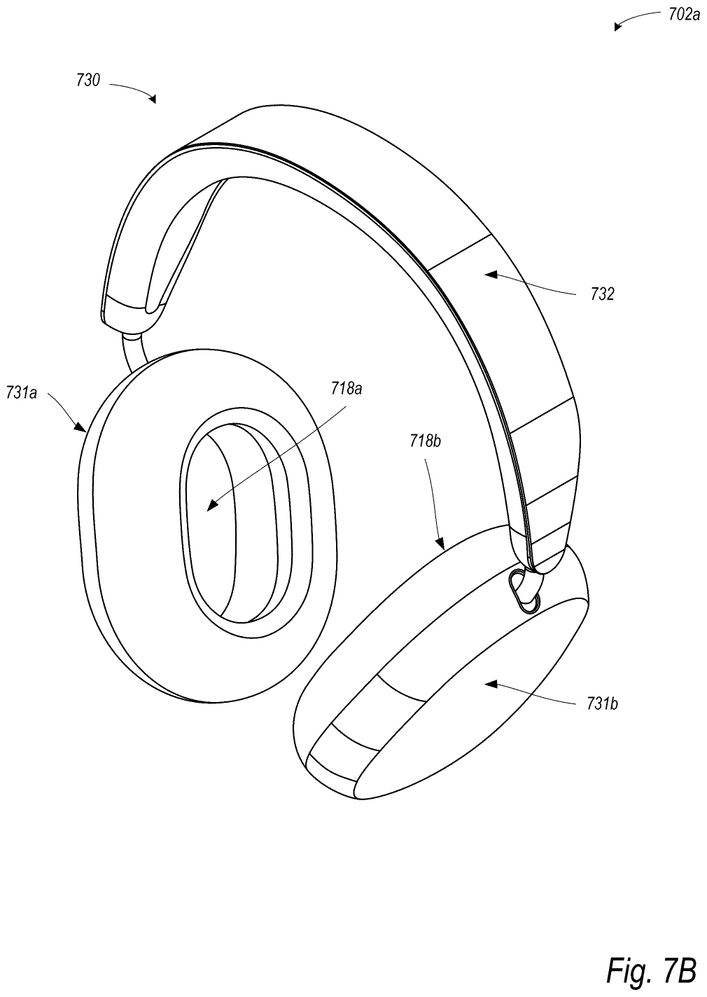

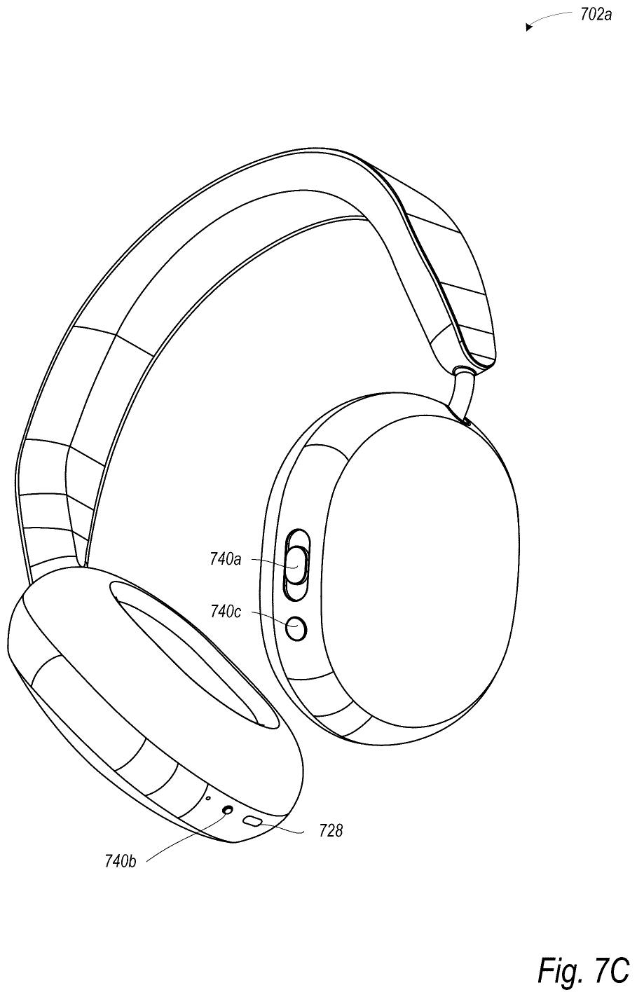

FIG. 7A is a functional block diagram illustrating certain aspects of an example wearable playback device 702. As shown in the functional block diagram, the wearable playback device 702 may include the same or similar components as the playback device(s) 102 described in the preceding section. For instance, the processor(s) 712 may be the same as or similar to the processor(s) 212, the memory 713 may be the same as or similar to the memory 213, and likewise for the other components shown in FIG. 2A. As such, the descriptions of these components is not repeated.

Moreover, like the software 214, the software 714 may configure the wearable playback device 702 to function as a part of the media playback system 100 (FIGS. 1A and 1B). For instance, the wearable playback device 702 may interact with the playback devices 102, the NMDs 103, and/or the controller devices 104 in various ways, as is described in further detail throughout. Yet, given their different form factors and associated usage patterns, the playback devices 102 and the wearable playback device 702 may also function differently. For instance, the wearable playback device 702 might not be configured as part of a playback zone (e.g., one of the rooms 101 shown in FIG. 1A) but instead interact with the rooms in various ways (e.g., sound swapping).

Moreover, the components of the wearable playback device 702 may be adapted or configured to facilitate usage patterns common with wearable devices. For instance, the power components 727 include a battery 729 to power the electrical components such as the processor(s) 712, the memory 713, the audio processing 716, the amplifier(s) 717, the voice processing 720, and/or the network interfaces 724. Yet further, the power components 727 include a power interface 728 configured to receive current and thereby charge the battery 729. The power interface 728 may include a direct current (DC) interface such as a USB connection (e.g., USB Type-C), as well as other suitable connections.

Similar to the network interface(s) of the playback device 102 (FIG. 2A), the wearable playback device includes network interface(s) 724. The network interfaces 724 include a Wi-Fi interface 725a and a Bluetooth interface 725b. The Wi-Fi interface 725a may conform to a standard, such as one or more of the IEEE 802.11 standards, to facilitate wireless network communication with other network devices over wireless local area networks such as the LAN 111 (FIG. 1B). Similarly, the Bluetooth interface 725b may conform to a standard, such as the 802.15 standard or other Bluetooth standards such as Audio over BLE or LE audio, to facilitate wireless network communication with other Bluetooth-compatible devices over personal local area networks. In some examples, the Bluetooth interface 725b is compatible with Bluetooth Low Energy (BLE) so as to provide similar performance and range as Bluetooth albeit with relatively lower power consumption. The standards used may be point-to-point, multicast, and/or broadcast based standards.

To facilitate wearable use, the components of the wearable playback device 702 are housed in a housing or housings that facilitates such use. Examples include headphones and earbud housings. To illustrate, FIGS. 7B and 7C show a pair of headphones 702a, which is one example of the wearable playback device 702. Earbud form factors may include carrying cases to charge the earbuds and provide additional communication options for the earbuds. In some examples, the carrying case or other adapter may include the technology to facilitate swap functionality as described herein. In some embodiments, the home theater primary 102b may continue playing back the audio while also sending one or more channels representing the audio to the headphones 702a. This feature allows users in or near the home theatre primary and headphone users who may walk away from the home theatre primary 102b to continue enjoying the audio content.

In some instances, for the sake of brevity, references to the headphones 702 are used as shorthand to refer to wearable playback devices, such as the wearable playback device 702, generally, although such devices may be implemented in different wearable form factors other than headphones (e.g. earbuds). Other form factors of example wearable playback devices include wearable goggles, such as augmented reality (AR) goggles and/or virtual reality (VR) goggles. Yet further, the disclosure of example wearable playback devices may also apply to certain portable playback devices, such as hand-carryable battery-powered speakers.

As shown in FIG. 7B, the headphones 702a include a housing 730, which includes earcups 731 (labeled individually as an earcup 731a and an earcup 731b) connected by a headband 732. The earcups 731 carry audio transducers 718 configured for audio playback. In particular, the earcup 731a includes an audio transducer 718a and the earcup 731b includes an audio transducer 718b.

As shown in FIG. 7C, the housing 730 carries a power interface 728. The power interface 728 in this example is a USB Type-C port as shown. When a USB Type-C cable is connected to this port and an appropriate charger, the headphones 702a may charge the battery 729 and/or power the electrical components of the headphones 702a directly.

As also shown in FIG. 7C, the housing 730 carries a user interface 740, which includes a slider control 740a, a button control 740b, and a button control 740c. Some or all of these controls may be multi-function. For instance, a control, such as the slider control 740a, may be pressed, pressed-and-held, and/or pressed-and-continued-held, to trigger different functions. Yet further, these functions may also be context specific.

To illustrate, in an example control scheme, the slider control 740a is slidable in different directions to adjust volume upwards or downwards. The slider control 740a is also pressable to toggle between play and pause states. Yet further, the slider control 740a can be pressed-and-held (e.g., for a threshold period of time, such as three seconds) to trigger a sound swap. The direction of the sound swap (i.e., push or pull) depends on context. As another example of multi-function control, the button control 740b can be pressed once to toggle power-on and power-off (e.g., sleep) states or pressed-and-held to enter Bluetooth pairing mode. The button 740c is pressable to toggle between ANC (acoustic noise cancellation) mode and hear-through mode.

While certain exterior components are shown in FIGS. 7B and 7C, other components of the wearable playback device 702 as illustrated in FIG. 7A are carried internally and not shown in these drawings. Such components may be carried internally to the earcups 731 and/or the headband 730. For other form factors, such as earbuds, the components may be divided into two or more housings (e.g., left and right earbuds), perhaps with some components (such as a processor, memory, and software) being implemented in both housings to facilitate individual operation and/or operation as a combined wearable device 702.

### b. Example Home Theatre Sound Swap

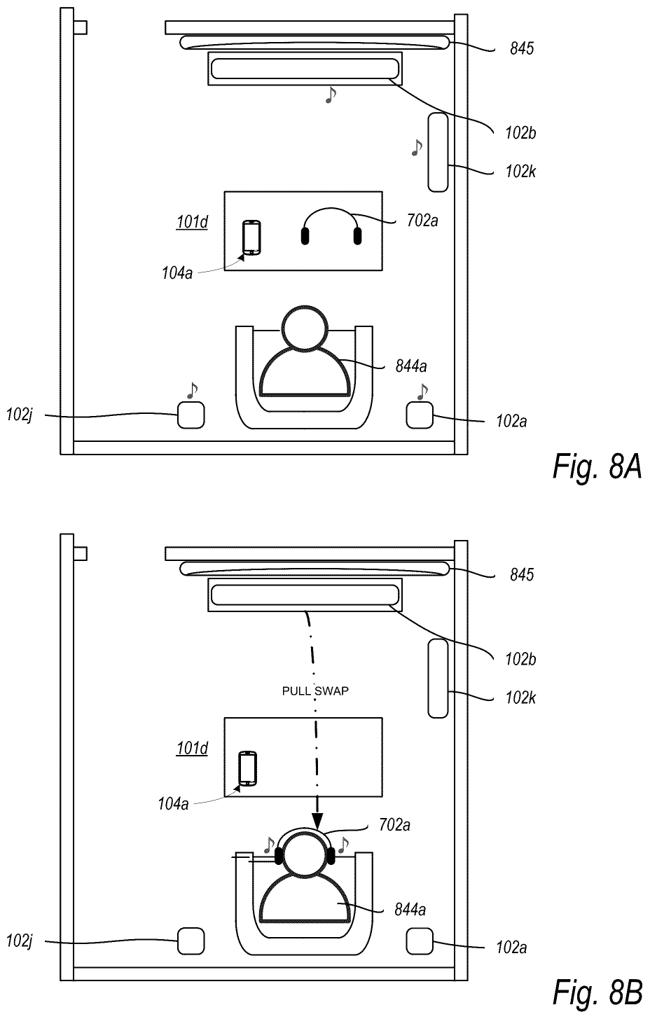

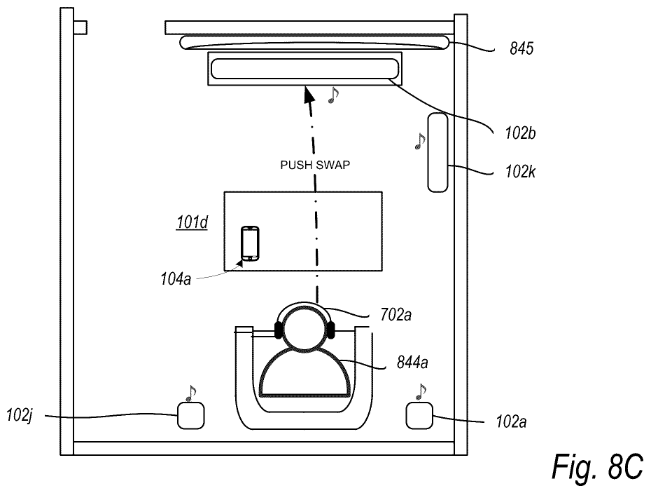

As noted above, one type of sound swap is a home theatre sound swap in which television audio received from a TV is swapped from out-loud playback on a playback device 102 to personal playback on a wearable playback device 702. FIG. 8A illustrates an example room configured as a home theatre, which in this example is the den 101d (FIG. 1A). The den 101d includes the playback device 102b, which is connected to a television 845 via an input interface (e.g., an HDMI, optical, or other connection). The den 101d also includes satellites, which include the playback device 102a and the playback device 102j, as well as a subwoofer (the playback device 102k).

In FIG. 8A, the user 844a is listening to audio received from the television 845 by the playback device 102b. The playback device 102b can play back a portion of the audio (e.g., the front channels center, left, and right) and distribute other portions of the audio to the satellites and/or the subwoofer for playback. As noted above, a playback device, such as the playback device 102b, that receives audio from a television (or other A/V source) and then plays and/or distributes that audio can be referred to as a home theatre primary. In some instances, the playback device 102b is also referred to as the home theatre primary 102b.

In the example of FIG. 8A, the headphones 702a are sitting on the table presently unused because the user 844a is listening to playback out-loud on the playback devices 102 in the den 101d. At some point, user 844a may determine to switch from out-loud playback to personal playback on the headphones 702a (perhaps if another member of the household is trying to sleep in the adjacent bedroom 101c (FIG. 1A) or for any other reason). In this case, the user may trigger a pull swap (e.g., using the slider control 740a on the headphones 740a or using a graphical user interface on the controller device 104a).

As shown in FIG. 8B, the pull swap transitions playback of the home theatre (television) audio from the home theatre primary 102b (and, if present, bonded satellites) and starts a home theatre swap session for playback of that audio on the headphones 702a. During the home theatre swap session, the home theatre primary 102b continues to receive audio from the television 845 (as this device is the only device that is presently connected to the television). However, instead of playing back the audio, the home theatre primary 102b sends one or more channels representing the audio to the headphones 702a.

The home theatre primary 102b may mix or otherwise process the television audio into channels suitable for playback on the headphones 702a. For instance, the home theatre primary 102b may process surround sound audio from the television 845 into spatial (binaural audio) for immersive playback on the headphones 702a. In other examples, the home theatre primary 102b may downmix surround sound audio to stereo audio. Other examples are possible as well.

Eventually, the home theatre swap session may end, either by user control, or by some triggering event, as discussed in more detail below. The system may then perform a push swap to transition playback of the home theatre audio back to the playback devices 102b of the den 101d, as illustrated by FIG. 7C. In the example of FIG. 7C, following the push swap, the playback devices 102b of the den 101d are again playing the home theatre audio.

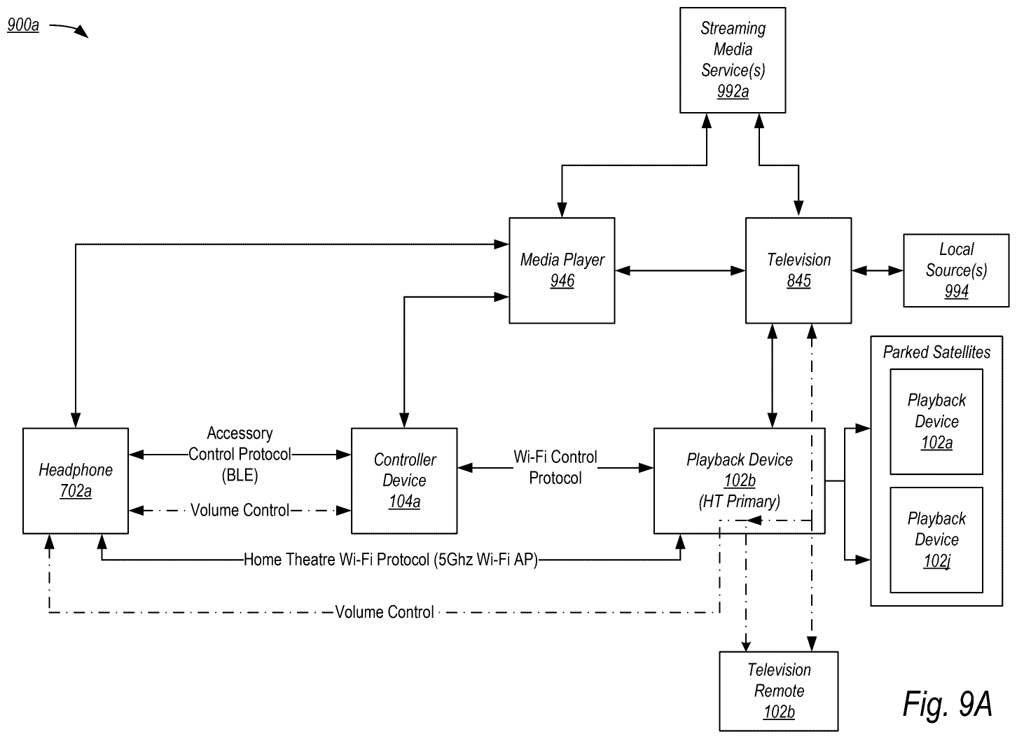

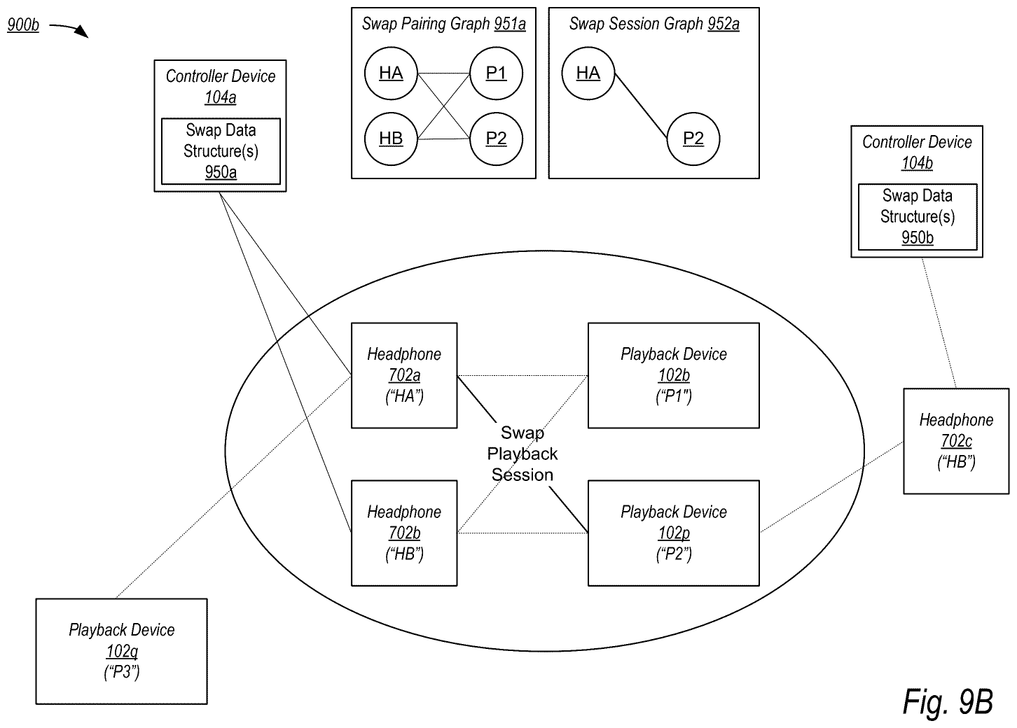

FIG. 9A is a block diagram illustrating an example sound swap architecture 900a in accordance with aspects of the disclosed technology. As shown, the architecture 900a includes the headphone 702a (as one example of suitable wearable playback devices 702), the controller device 104a (as a representation of suitable controller devices 104), and the playback device 102b (as a representation of suitable home theatre primary devices). The architecture 900a also includes the television 845, which receives media (e.g., audio and/or video) from streaming media services 992a and/or local sources 994 (e.g., disc players, gaming consoles, streaming sticks, and the like).

As shown in FIG. 9A, the controller device 104a acts as a conduit for communications between the headphones 702 and a playback device 102b (as well as other playback devices 102 in the media playback system 100). To facilitate this arrangement, the headphones 702 are paired with the controller device 104a via Bluetooth LE (BLE) and also associated in a controller application installed on the controller device 104a. Commands input to the user interface 740 on the headphones 702a are transmitted using BLE to the controller device 104a, and then transmitted from the controller device 104a to the home theatre primary over Wi-Fi (e.g., the LAN 111 shown in FIG. 1B). Similarly, commands input to the user interface 540 are transmitted from the controller device 104a to the home theatre primary over Wi-Fi (e.g., the LAN 111 shown in FIG. 1B).

During a home theatre swap session, the home theatre primary forms acts as an access point for a wireless local area network (e.g., a 5 Ghz Wi-Fi network), which the headphones 702a connect to and use to stream the home theatre audio. The satellites (i.e., the playback device 102a and playback device 102j) are parked on another wireless local area network (e.g., a 2.4 Ghz Wi-Fi network) provided by the home theatre primary during the home theatre swap session. Notably, these wireless networks are in addition to wireless local area networks provided by a home router/access point combination or other networking infrastructure. In some instances, the home theatre primary may use another protocol or standard to connect to and stream home theatre audio to the headphones (702a). The protocol or standard may be a broadcast-based standard such as Audio over BLE, LE Audio, or Auracast, among other examples.

Also shown in FIG. 9A is a media player 946. The media player 946 can operate as a source for the television 845 (e.g., to output video from the streaming media service(s) 992a). In some examples, the media player 946 operates as a home theatre primary in place of the playback device 102b. In this example, the playback device 10b may be parked similarly to the playback devices 102a and 102j.

During the home theatre swap session, the television remote 102b can control the volume of the headphones 702a by signaling the home theatre primary over RF or infrared (among other suitable communications mediums). Generally, the television remote 102b can also control the volume of out-loud playback by the playback device 102b and the satellites during home theatre usage outside of the home theatre swap session. The controller device 104a is also able to send transport controls (e.g., play/pause/etc) and volume adjustments to the headphones 702a over BLE.

Note that volume refers to how loud audio playback sounds to a user, but is also a state stored in state information for a playback device 102 and wearable playback devices 702 (collectively referred to as players). Changes to a volume setting for a player modify the state information, and thus change the amount of amplification and apparent loudness of playback to a user. A mute state (i.e., muted or not muted) can similarly be represented in the state information. This state information can be maintained on the players themselves, by the control device(s) 104, or in the cloud (e.g., the computing devices 106c). The control devices 104 access the state information to display graphical indications of volume and/or mute states in the user interface 440 (e.g., via the controller interface 540a (FIG. 5A)).

During a sound swap, such as a home theatre sound swap, certain volume adjustments may be made to the playback devices 102 and/or wearable playback devices 702 involved in the swap. When a home theatre swap session begins on the headphones 702a (following a pull swap from the home theatre primary 102b), the current volume setting state of the home theatre primary 102b is sent to the headphones 702a. The headphones 702a will use the current volume setting state of the home theatre primary 102b is used to match its volume to that of the home theatre primary 102b. In some examples, the volume setting is sent as a sound pressure level decibels (SPL dBs) to account for differences among various models of home theatre primary (e.g., more/less powerful amplifiers and/or transducer designs).

In some examples, the current state of the home theatre primary 102b influences changes to its volume state and that of the headphones 702 during a sound swap. For instance, if the home theatre primary 102b is muted when a pull swap is initiated, the headphones 702 may set their volume setting to a default value (e.g., 60%) rather than matching the volume level of the home theatre primary 102b. As another example, if the home theatre primary 102b is in a group when a pull swap is initiated, the home theatre primary 102b leaves the group and, if necessary, delegates group coordinator responsibility to a remaining group member.

Further, the playback state of the home theatre primary 102b influences behavior during a sound swap. For instance, if the home theatre primary 102b is actively playing television audio when the pull swap is initiated, the out-loud playback of the television audio by the home theatre primary 102b is faded-out and playback of the television audio following the swap is faded-in (perhaps without modifying the volume setting of the home theatre primary 102b). In some examples, the fade-out is delayed slightly to allow the headphones 702b to transition to ambient acoustic noise cancellation. Conversely, if the home theatre primary 102b is not actively playing television audio when the pull swap is initiated, the fade-out may be skipped.

Continuing the example where the home theatre primary 102b is not actively playing television audio when a pull swap is triggered, the home theatre primary 102b may attempt to start playback of television audio. This behavior may be referred to as TV auto-play. For example, to carry out auto-play, the home theatre primary 102b may switch the playback source to a particular input (e.g., an HDMI or optical port on the home theatre primary 102b) connected to the television 845. Further, the home theatre primary 102b may attempt to turn on the television 845 (e.g., via HDMI CEC).

During a home theatre swap session, the home theatre primary 102b sends television audio to the headphones 702a and does not send audio to the its own playback pipeline or to satellites (e.g., the playback device 102a or the playback device 102j). The home theatre primary 102b may receive volume change or mute state change commands during the home theatre swap session, but instead of applying those commands to itself or its satellite(s), forwards the commands to the headphones 702b to modify its state. When the television is connected via a compatible interface, such as HDMI, CEC messages indicating the change in volume state are sent to the television 845. Most models of the television 845 will display a volume bar or other indication of volume of the headphones 702a on-screen in response to receipt of the CEC message(s).

Similar to a pull swap, a state or states of the headphones 702b may influence behavior on the home theatre primary 102b when a push swap is initiated. For instance, the headphones 702b may send their volume setting to the home theatre primary 102b, which may match its volume setting to that of the headphones 702b. Further, when the push swap is triggered when the headphones 702b are actively playing the television audio, the headphones 702b fade-out and the home theatre primary 102b fade-in to the newly-matched volume level when swapping the audio during the push swap. When the push swap is triggered when the headphones 702b are not actively playing the television audio, the fade-out is skipped and the home theatre primary 102b may forego volume matching (and may instead revert to/remain at its previous volume level prior to the swap session).

In some cases, a home theatre swap session is unintentionally ended, perhaps due to a network disconnect or a drained battery on the headphones 702a). In such instances, the home theatre primary 102b temporarily mutes itself, and then re-enables out-loud audio. Here, no fade-in or fade-out is applied to the headphones 702a or the home theatre primary 102b (since there was no audio playing).

In some instances, an additional wearable playback device 702 may join a home theatre swap session. For instance, a second pair of headphones 702b may join concurrently with the headphones 702a. In this scenario, no fade-in or fade-out is applied (so as to avoid disruption of the on-going session). However, the second pair of headphones 702 may similarly match volume of the home theatre primary 102b.

To further illustrate example sound swap technologies with one or more multiple wearable playback devices, FIG. 9B is a block diagram illustrating example sound swap topology 900b and example data structures representing such topology. The sound swap topology 900b includes multiple headphones 702 (the headphones 702a and the headphones 702b), multiple controller devices 104 (the controller device 104a and the controller device 104b) and multiple home theatre primaries (the playback device 102b, a playback device 102p and a playback device 102q). An example household might include multiple users 844 (each with one or more headphones 702 and paired controller device(s) 104) as well as multiple home theatre primaries (e.g., connected to televisions in different rooms like the den 101d, a living room, a rec room, a bedroom, among other possibilities.

To facilitate home theatre swaps, each headphone 702 may undergo a pairing phase with each swap-eligible playback device (e.g., the home theatre primaries) that the user(s) 844 may wish to sound swap with. This designates possible sources and targets. The user(s) 844 uses a graphical user interface on a controller device 104 to initiate and control the pairing phase.

For instance, the user 844a may use the controller device 104a to initiate pairing of the playback device 102b with the headphone 702a. During this pairing, the swap-eligible playback device 102b adds the headphones 702a as a trusted accessory. Similarly, the headphones 702b add the swap-eligible playback device 102b as a trusted home theatre primary. This process may be repeated for other swap-eligible playback devices 102 that the user 844a desires to set-up with the headphone 702a, as well as performed for other headphones 702, such as the headphones 702b.

The pairing phase may also involve exchange of authentication information to facilitate future sound swaps. For instance, the playback device 102b may share a pre-shared key for a wireless local area network (WLAN) with the wearable playback device. As described in connection with FIG. 9A, during a home theatre swap session, the headphones 702 connect to this network to stream home theatre audio.

To facilitate swap control and display status information to the user(s) 844, the controller devices 104 may maintain data representing the pre-pairings between wearable playback devices 702 and home theatre primaries. As shown in FIG. 9B, this may take the form of one or more swap data structures 950 maintained on each controller device 104. For instance, the controller device 104a may maintain a swap data structure 950a and the controller device 104b may maintain a swap data structure 950b.

The swap data structure 950 may include a swap pairing graph 951 representing each trusted home theatre primary stored in each trusted accessory, each trusted accessory stored in each swap-eligible playback device, and the pre-pairings created between them. To illustrate, the swap pairing graph 951a shows the headphones 702a and the headphones 702b each storing the playback device 102b and the playback device 102p as trusted home theatre primaries, and the playback device 102b and the playback device 102p each storing the headphones 702a and the headphones 702b as trusted accessories.

The swap data pairing graph(s) 951 may be populated by the controller devices 104 querying each connected accessory for trusted home theatre primaries and also querying each swap-eligible playback device for trusted accessories. For instance, the controller device 104a may populate the swap data pairing graph 951a by querying the headphones 702a and the headphones 702b for trusted home theatre primaries and querying the swap-eligible playback devices 102b, 102p, and 102q for trusted accessories.

The swap data structure 950 may include a swap session graph 952 representing devices in an active home theatre swap session. For instance, the swap session graph 952a is representative of an active home theatre swap session including the headphones 702a and the playback device 102p. The controller device 104a may populate the swap session graph 952a by querying each swap-eligible playback device 102a for connected accessories (here, the headphones 702a).

The headphone 702c in FIG. 9B represents a powered-off wearable playback device 702. Since its powered off, the headphone 702c does not respond to queries and therefore does not appear as trusted or connected accessory (even if the headphone 702c had been previously paired). By excluding powered-off from certain portions of the swap data structure 950b, the controller devices 104 can prevent the unavailable device from being shown as available for home theatre swap. When the headphone 702c is powered on, the controller device 104b may query the headphone 702c and populate the swap data structure 950b to enable home theatre swap.

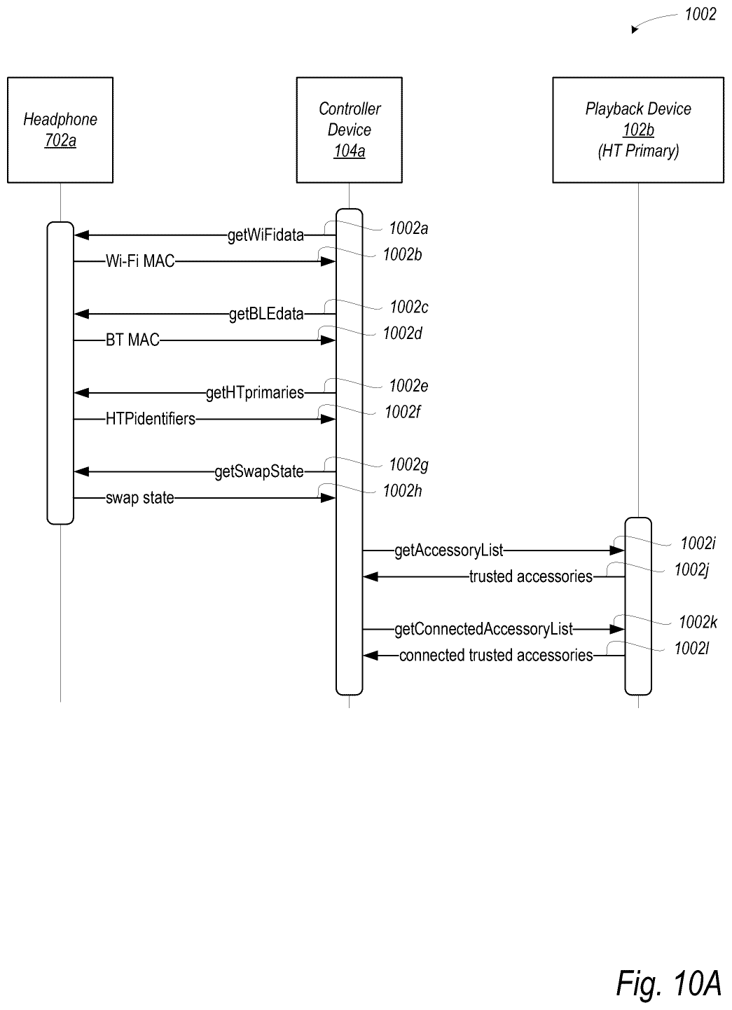

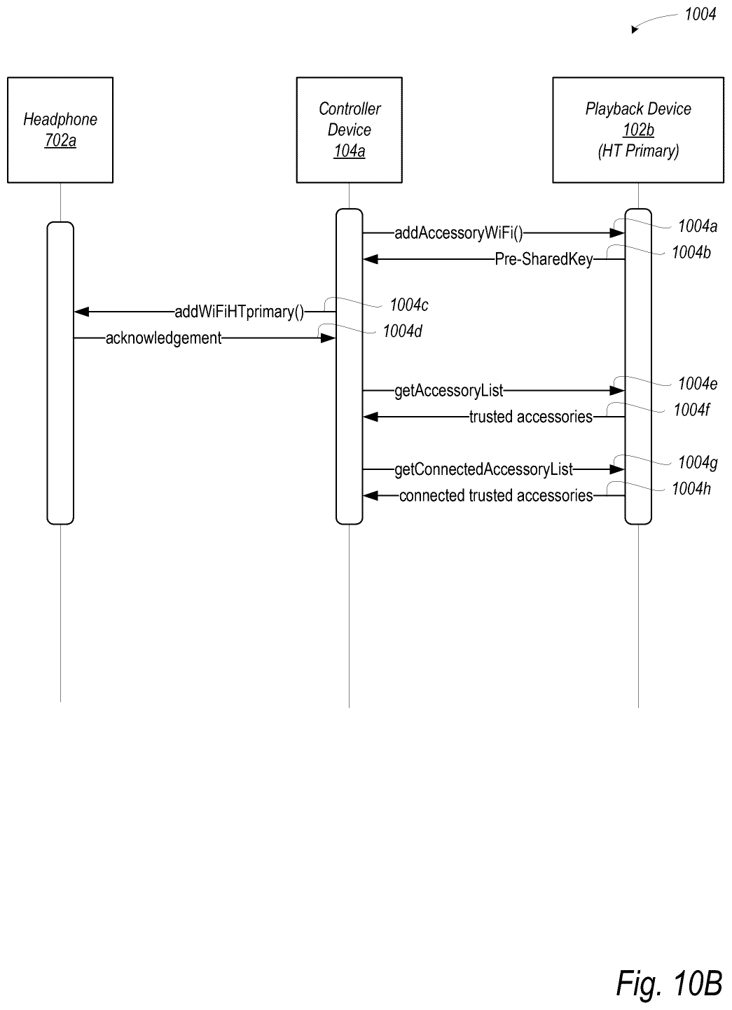

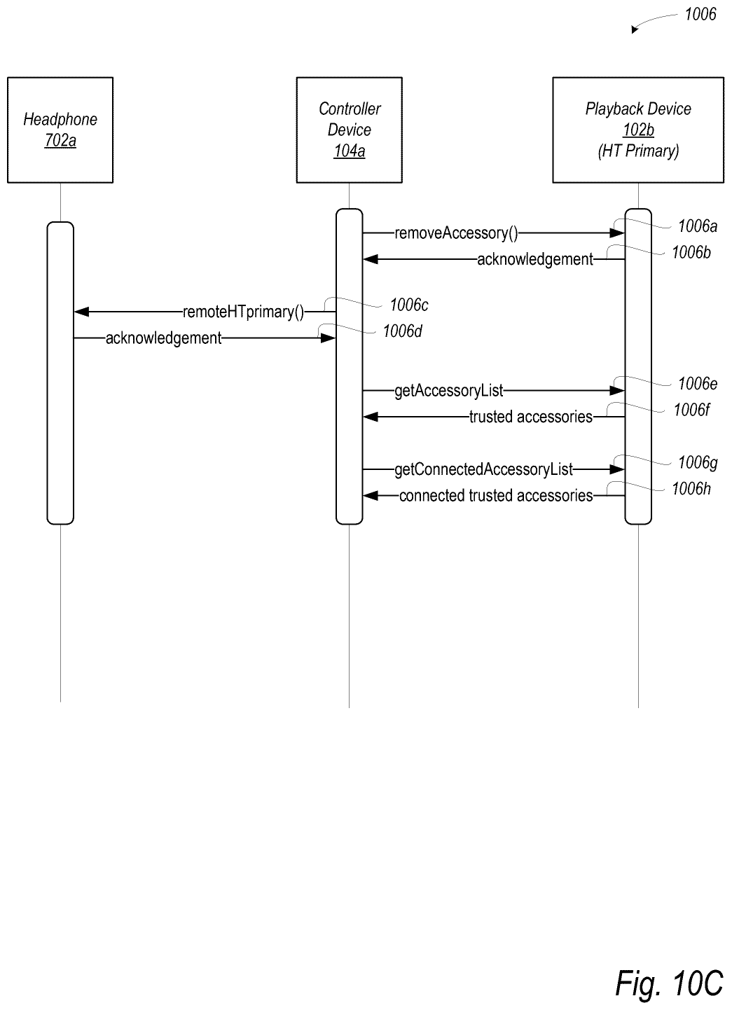

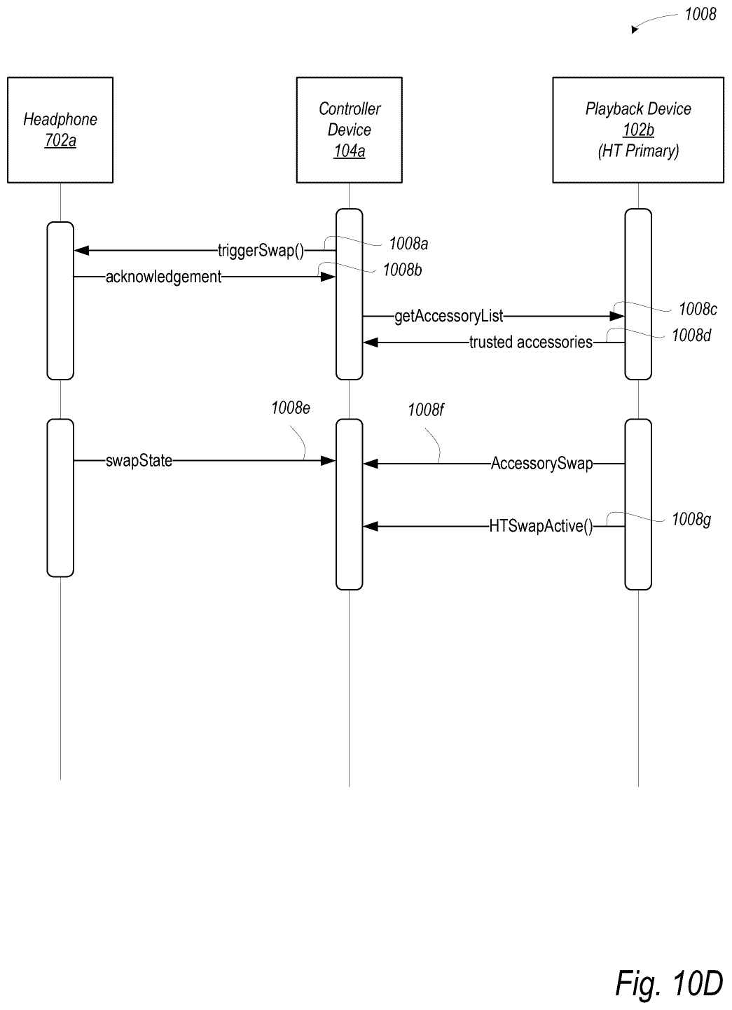

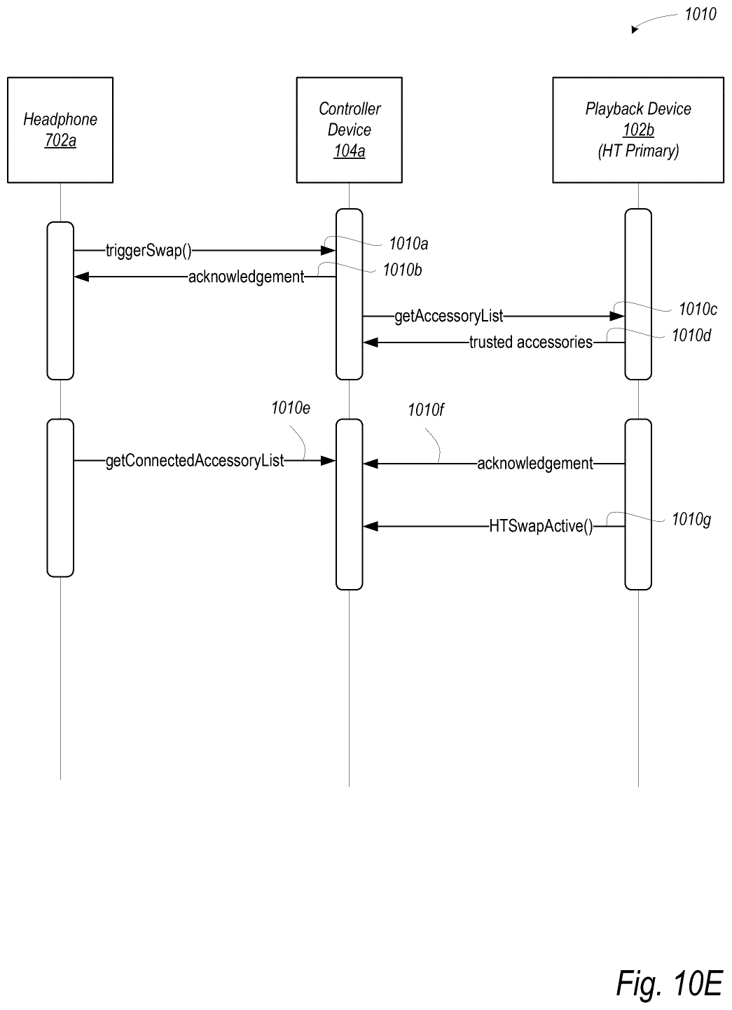

To further illustrate example aspects of sound swap, FIGS. 10A, 10B, 10C, 10D, and 10E are message flow diagrams for setup and initiation of sound swap. The example message flows may be transmitted via the example Wi-Fi and/or Bluetooth connections illustrated in FIG. 9A, among other suitable networks. For instance, the wearable playback device(s) 702 may communicate with the controller device(s) 104 via Bluetooth, and the controller device(s) 104 may communicate with the home theatre primary over Wi-Fi.

FIG. 10A illustrates an example message flow 1002 to facilitate example state/information queries, such as WiFi/BT data, trusted home theatre primaries, swap state, trusted accessories, and connected accessories. The message flow 1002 of FIG. 10A represents an example of the controller device 104a making an initial determination of swap topology. The controller device 104a may use the message flow 1002 to establish, populate, and/or update the swap data structure 950 (FIG. 9B).

The message flow diagram 1002 includes message exchange to get network interface information from the headphone 702a. In particular, at 1002a, the controller device 104a sends a get WiFidata message to the headphone 702a to request its WiFidata. At 1002b, the headphone 702a responds with its Wi-Fi MAC address (medium access control address), which is a unique identifier assigned to the Wi-Fi interface 725a (FIG. 7A) of the headphones 702a. At 1002c, the controller device 104a sends a getBLEdata message to the headphone 702a to request its BTdata. The headphone 702a responds with its Bluetooth MAC address, which is a unique identifier assigned to the BT interface 725b (FIG. 7A) of the headphones 702a.

The message flow diagram 1002 also includes message exchange to get trusted HT primary information from the headphone 702a. At 1002e, the controller device 104a sends a getHTprimaries message to the headphone 702a to request its trusted HT primaries. At 1002f, the headphone 702a responds with its HTPidentifiers which are identifiers representing each home theatre primary that has been paired with the headphone 702a (and is therefore trusted).

The controller device 104a may use this information to populate the swap pairing graph 951a for the headphone 702a. In particular, since the headphone 702a responded to this query, the controller device 104a can consider the headphone 702a as available for home theatre swap. Powered-off wearable playback device 702, such as the headphones 702c (FIG. 9B), would not respond to this query and thus would not be considered available for swap.

The message flow diagram 1002 further includes message exchange to get swap state information from the headphone 702a. At 1002g, the controller device 104a sends a getSwapState message to the headphone 702a to request its swap state. At 1002h, the headphone 702a responds with its swap state, which identifies which home theatre primary (if any) that the headphone 702a is presently in a home theatre swap session with. The controller device 104a may use this information to populate the swap session graph 952 for the headphone 702a.

The message flow diagram 1002 also includes message exchange to get trusted accessory information from the playback device 102 (also referred to as the home theatre primary 102b). At 1002i, the controller device 104a sends a getAccessoryList message to the home theatre primary 102b to request its trusted accessories, which include paired wearable playback devices 702 such as the headphones 702a. At 1002j, the home theatre primary 102b responds with a list of trusted accessories such as wearable playback devices that have been paired with the home theatre primary 102b (and are therefore trusted). The controller device 104a may use this information to populate the swap pairing graph 951a for the headphone 702a.

The message flow diagram 1002 further includes message exchange to get connected accessory information from the playback device 102b. At 1002k, the controller device 104a sends a getConnectedAccessoryList message to the home theatre primary 102b to request its connected accessories, which include wearable playback devices 702 that are currently connected to the home theatre primary 102b in a home theatre swap session. At 10021, the home theatre primary 102b responds with a list of connected accessories (e.g., the headphones 702a). The controller device 104a may use this information to populate the swap session graph 952a for the headphone 702a.

In some cases, trusted home theatre primary information queried from the headphones 702a and trusted accessory information queried from the playback device 102b might not match. For instance, if the headphones 702a are reset (e.g., factory reset), then the trusted home theatre primary information queried from the headphones 702a would not show the playback device 102b but the trusted accessory information queried from the playback device 102b would show the headphones 702a from prior to the reset. In this case, the headphones 702a would need to be re-paired with the playback device 102b to enable further home theatre swaps.

FIG. 10B illustrates example message flow 1004 to facilitate set-up of the headphone 702a as a trusted accessory for the playback device 102b and also set-up of the playback device 102b as a trusted home theatre primary for the headphones 702b, as well as example querying of the playback device 102b to populate the swap data structure 950a. At 1004a, the controller device 104a sends an addAccessoryWiFi( ) message to the playback device 102b. The arguments of the addAccessoryWiFi( ) message may include the Wi-Fi MAC, BT MAC, and/or other metadata identifying the headphones 702a. In response, at 1004b, the playback device 102b adds the headphones 702a as a trusted accessory and sends back a pre-shared key for a wireless local area network (here a WPA-PSK). The pre-shared key enables joining of a network during a home theatre swap session.

At 1004c, the controller device 104a sends an addWifiHTPrimary( ) to the headphones 702a to cause the headphones 702a to add the playback device 102b as a trusted home theatre primary. The arguments of the addWifiHTPrimary( ) message may include a playerSerial containing a serial number identifying the playback device 102b and/or the a pre-shared key. At 1004d, the headphones 702a send back an acknowledgement.

After the headphones 702a are added as a trusted accessory for the playback device 102b and the playback device 102b is added as a trusted home theatre primary for the headphones 702a, the controller device 104a may update its swap data structures 950. For instance, as discussed above in connection with FIG. 10A, at 1004e, the controller device 104a sends a getAccessoryList message to the home theatre primary 102b to request its trusted accessories, which include paired wearable playback devices 702 such as the headphones 702a. At 1004f, the home theatre primary 102b responds with a list of trusted accessories such as wearable playback devices that have been paired with the home theatre primary 102b (and are therefore trusted). The controller device 104a may use this information to populate the swap pairing graph 951a for the headphone 702a.

The message flow diagram 1004 further includes message exchange to get connected accessory information from the playback device 102b. At 1004e, the controller device 104a sends a getConnectedAccessoryList message to the home theatre primary 102b to request its connected accessories, which include wearable playback devices 702 that are currently connected to the home theatre primary 102b in a home theatre swap session. At 1004h, the home theatre primary 102b responds with a list of connected accessories (e.g., the headphones 702a). The controller device 104a may use this information to populate the swap session graph 952a for the headphone 702a.

FIG. 10C illustrates example message flow 1006 to facilitate removal of the headphone 702a as a trusted accessory for the playback device 102b and also removal of the playback device 102b as a trusted home theatre primary for the headphones 702b, as well as example querying of the playback device 102b to populate the swap data structure 950a.

Then, at 1006c, the controller device 104a sends a remove WifiHTPrimary( ) to the headphones 702a to cause the headphones 702a to remove the playback device 102b as a trusted home theatre primary. The arguments of the remove WifiHTPrimary( ) message may include the playerSerial identifying the playback device 102b. At 1006d, the headphones 702a send back an acknowledgement. At 1006e, 1006f, 1006g, and 1006h, the message flow 1006 includes the similar querying of the playback device 102b for trusted/connected accessory information as previously discussed. Here, following removal of the headphones 702a as a trusted accessory, such querying will not return the headphones 702a.

FIG. 10D illustrates example message flow 1008 to initiate a home theatre swap session and query states. At 1008a, the controller device 104a sends a triggerSwap( ) message to the headphones 702a. The controller device 104a may send this message after receiving input data representing a swap command. Upon receipt of the triggerSwap( ) the headphones 702a initiate a pull or push swap (depending on context—i.e., whether or not a swap session is in progress) and at, 1008b, sends back an acknowledgement. At 1008c, the controller device 104a queries for trusted accessories, and at 1008d, the playback device 102b responds, similar to the querying described above.

The controller device 104a can receive swap events from either the accessory or the player. To illustrate, at 1008e, the controller device 104a receives a swapState message from the headphone 702a indicating the swap state of the headphones 702a. At 1008f, the controller device 104a receives an AccessorySwap message which indicates which accessory the playback device 102b is presently swapped with. At 1008g, the playback device 102b sends an HTSwapActive message to the controller device 104a, which includes tunneled UPnP information).

FIG. 10E illustrates example message flow 1010 to initiate a home theatre swap session and query states. At 1010a, the headphones 702a send a triggerSwap( ) message to the controller device 104. The headphones 702a may send this message after receiving input data representing a swap command (e.g., via the control 740a). Upon receipt of the triggerSwap( ) at 1010b, the controller device 104 sends back an acknowledgement. At 1010c, the controller device 104a queries for trusted accessories, and at 1010d, the playback device 102b responds, similar to the querying described above.

As discussed above in connection with FIG. 7D, the controller device 104a can receive swap events from either the accessory or the player. To illustrate, at 1010e, the controller device 104a receives a swapState message from the headphone 702a indicating the swap state of the headphones 702a. At 1010f, the controller device 104a receives an AccessorySwap message which indicates which accessory the playback device 102b is presently swapped with. At 1010g, the playback device 102b sends an HTSwapActive message to the controller device 104a, which includes tunneled UPnP information).

Within examples, the results of a sound swap may depend on the respective states of the wearable playback device(s) and home theatre primary that are participating in the sound swap.

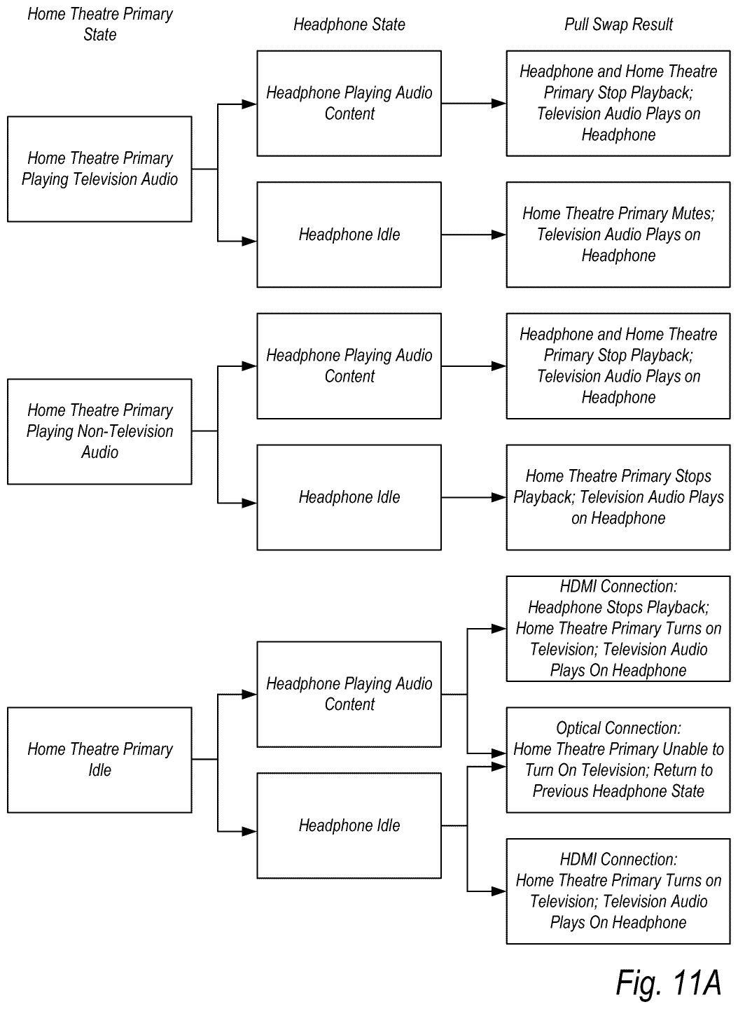

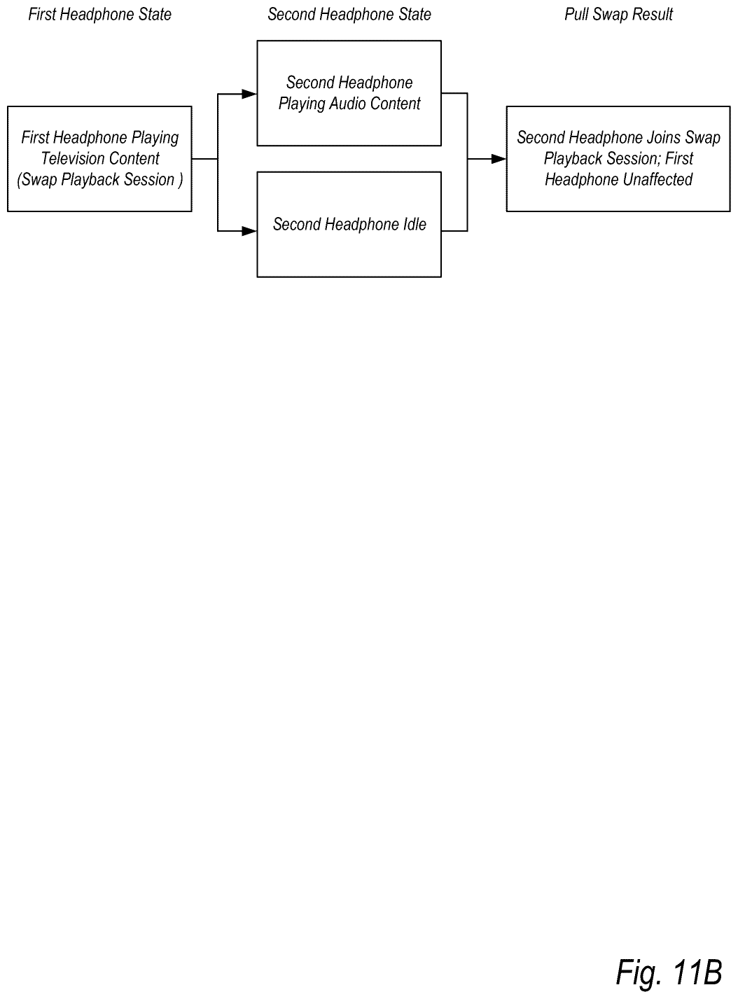

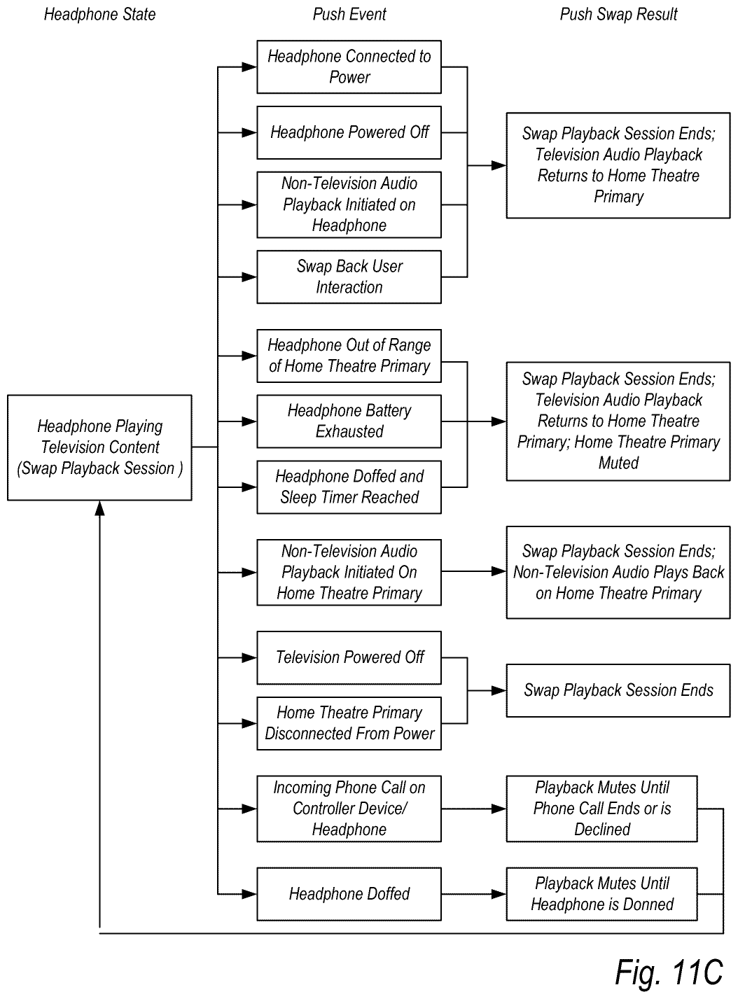

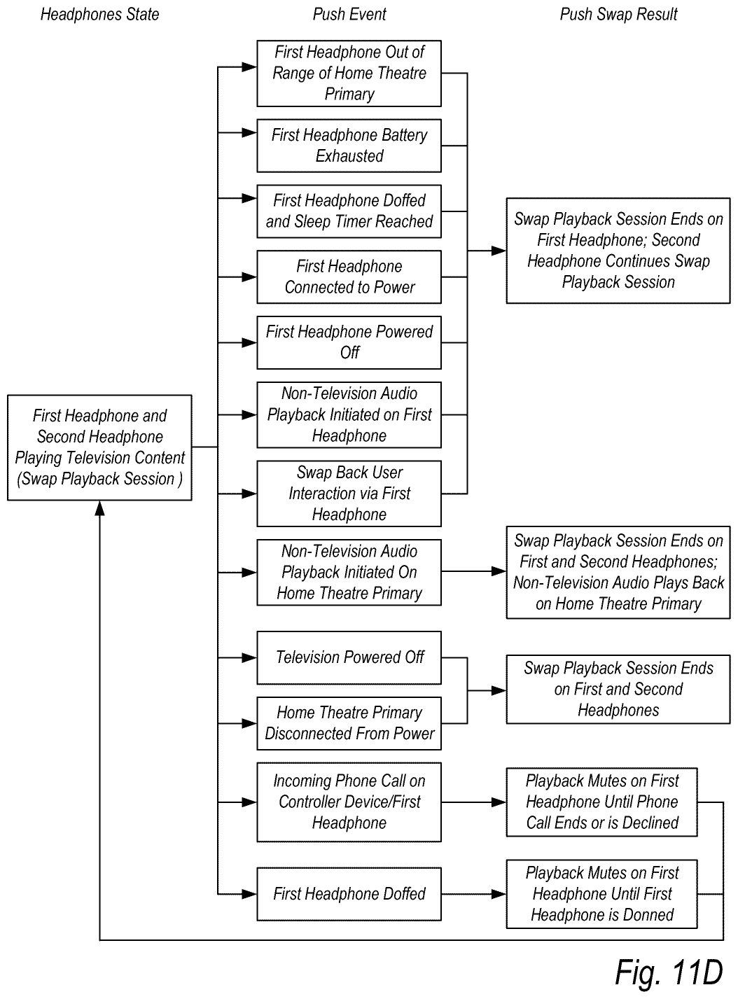

FIGS. 11A, 11B, 11C, and 11D are diagrams illustrating example sound swaps with different headphones and home theatre primary states. When initiating a sound swap, a wearable playback device 702 may reference state information representing one or more of its own states or one or more states of the home theatre primary that sound is being swapped with. The wearable playback device may then sound swap with different results based on these states.

More particularly, FIG. 11A shows different results for a pull swap based on the respective states of the home theatre primary and the headphones. As shown in the diagram, example states of the home theatre primary include (i) playing television audio, (ii) playing non-television audio, such as music, from a non-television source such as a computing device 106b of a media content service 192 (FIG. 1B), or (iii) being in an idle state where content is not being played back presently. Similarly, example states of the headphones include (i) playing audio content or (ii) idle (i.e., not presently playing audio content).

As shown in FIG. 11A, these respective states combine for seven different results of a pull swap. For instance, if the home theatre primary 102b is playing non-television audio and swaps with the headphones 702a while the headphones 702a are playing audio content, the headphones 702a and the home theatre primary 102b will stop playback of their respective content, and the television audio will start playing on the headphones 702a, as per the diagram of FIG. 11A. Other example results can be determined by looking at the respective states and following the diagram to the coordinating result.

In some cases, the type of connection between the home theatre primary and the television can further influence the pull swap results. For instance, with an HDMI connection, the home theatre primary 102b may be able to turn on the television 845 using CEC (assuming compatibility) and thus going from an idle state on the home theatre primary 102b to a result where the home theatre primary 102b turns on the television and television audio plays on the headphones 702a is possible, per the diagram. In contrast, with an optical connection, the home theatre primary 102b is unable to turn on television 845 because optical connections lack control functionality. As such, this connection leads to different results than an HDMI connection given similar states. In further examples, when an optical connection is used, control of the television 845 may occur via a different medium, such as an IR transmitter from the headphones 702a or the home theatre primary 102b so that similar states may results in similar results with different types of connection.

FIG. 11B is a diagram illustrating results of a pull swap when a second headphone is added to a home theatre swap session via a pull swap. As shown, here the results do not differ based on the respective states of the first headphone already in the session and the second headphone that is joining. As such, this diagram illustrates how a second headphone, regardless of its playing or idle state, can join a swap session without affecting the first headphone.

Turning now to pull results, FIG. 11C shows different results for a push swap based on the headphone state and the push event causing the pull swap. Such push events may be detected by one of the wearable playback device 702, the home theatre primary 102, and/or the controller device 104, among other connected devices. When such an event is detected, the wearable playback device 702 may initiate a pull swap with different results, as shown.

In particular, as illustrated in FIG. 11C, when a headphone is playing television content as part of a home theatre swap session, different push events may cause that session to end with various results. For instance, if the push event is one of (a) the headphone being connected to power (e.g., via the power interface 728), (b) the headphone being powered off, (c) non-television audio being initiated on the headphone (e.g., from a non-television source via a controller 104), or (d) a swap back user interaction (i.e., an explicit command to swap back), the swap playback session ends with television audio being returned in to the home theatre primary. As a further example, in some examples, such as if the home theatre swap session is with a media streamer (e.g., the media player 946) that is operating as a home theatre primary), playback is paused instead of ending the swap playback session.

In contrast, if the push event is one of (a) the headphone being out of range of the home theatre primary, (b) the headphone battery being exhausted, or (c) the headphone doffed (i.e., worn) when the sleep timer is reached, the swap playback session ends with television audio being returned to the home theatre primary but with the home theatre primary being in a mute state. Such difference in results may prevent unexpected or unwanted out-loud playback based on certain push events that may occur without direct action from the user 844.

As illustrated with several of the push events, during a home theatre swap session, a user may end such a session by playing non-television audio. As noted above, when non-television audio is initiated on the headphone, the playback session ends and playback of the television audio is returned to the home theatre primary. Conversely, when non-television audio is initiated on the home theatre primary, the playback session ends with the non-television audio playing on the home theatre primary.

Other example push events involve external triggers such as a change in television power state, disconnection of the home theatre primary form power, or an incoming phone call. As shown in FIG. 11C, the power states both end the swap playback session without returning any ongoing playback to the home theatre primary. In contrast, rather than ending the session, an incoming phone call causes a mute state (or a pause state) until the phone call ends or the call is declined. Similarly, removal of the headphone (i.e., doffing) also pauses playback until the headphone is put back on (i.e., donned).

FIG. 11D shows different results for a push swap when two headphones are in the home theatre swap session. In contrast to the results in FIG. 11C, when two headphones are in the same session, many of the push events will not end the session for both devices. Instead, such events will end the session on that headphone only, and the second headphone will continue the session. Examples of these push events include (a) first headphone out of range of home theatre primary, (b) first headphone battery exhausted, (c) first headphone doffed while the sleep timer is reached, (d) first headphone connected to power, (e) first headphone powered off, (f) playback of non-television audio initiated on the first headphone, and (g) the first headphone is connected to line-in audio via a physical interface (e.g., USB, auxiliary jack).

In contrast, other push events will end the playback session on both headphones. For instance, when non-television playback is initiated on the home theatre primary, the swap session will end for both pairs of headphones and playback of the television audio returns to the home theatre primary. Similarly, when the television is powered off, or the home theatre primary is disconnected from power, the session ends for both headphones.

Some push events will mute playback of the television audio only on one headphone. For example, when a call comes in to a paired controller device, only playback on the paired headphone is paused—the other headphone continues playing. Similarly, if one headphone is doffed, playback will mute on that headphone but continue on the other. In some instances, two headphones may be connected to the same controller device. When a call comes in, playback may be paused on one or both headphones, and the user may select which headphone to receive the call via a button press on the headphone.

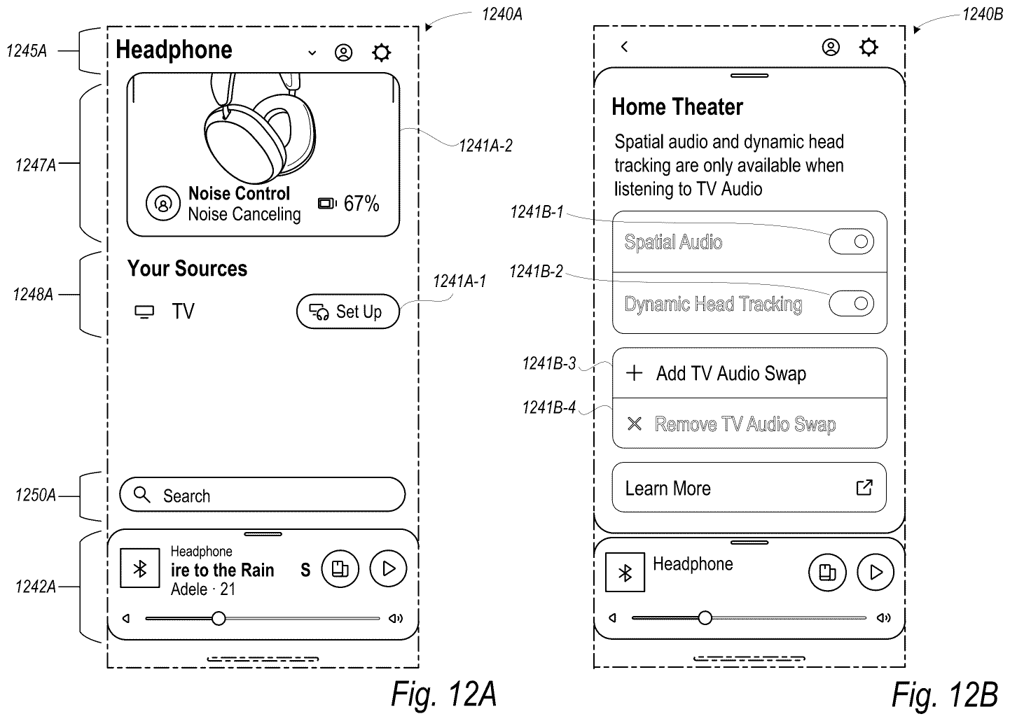

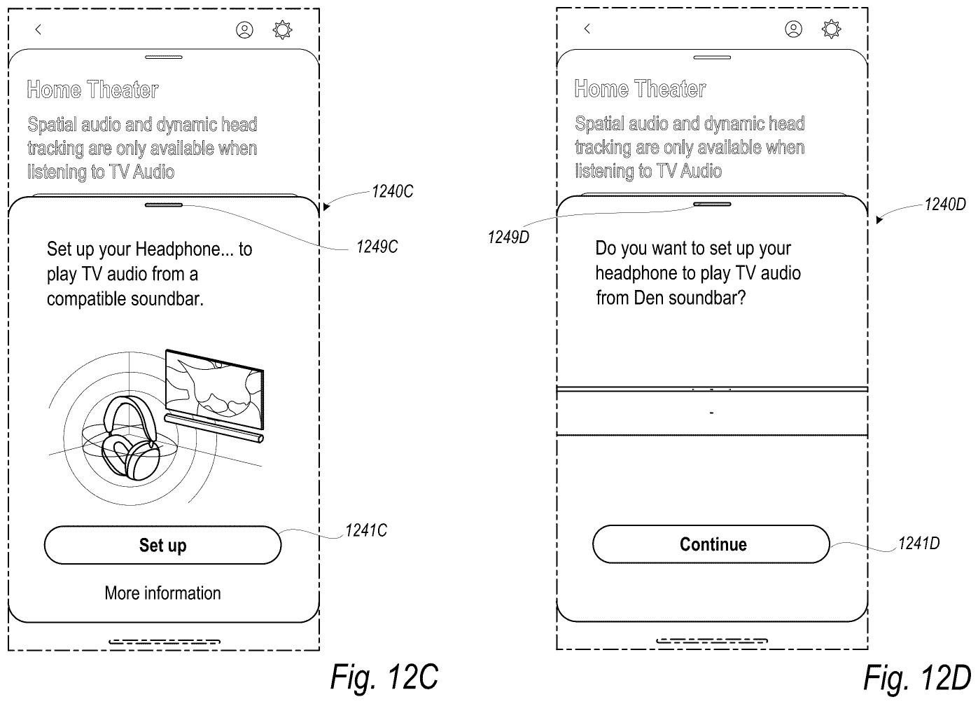

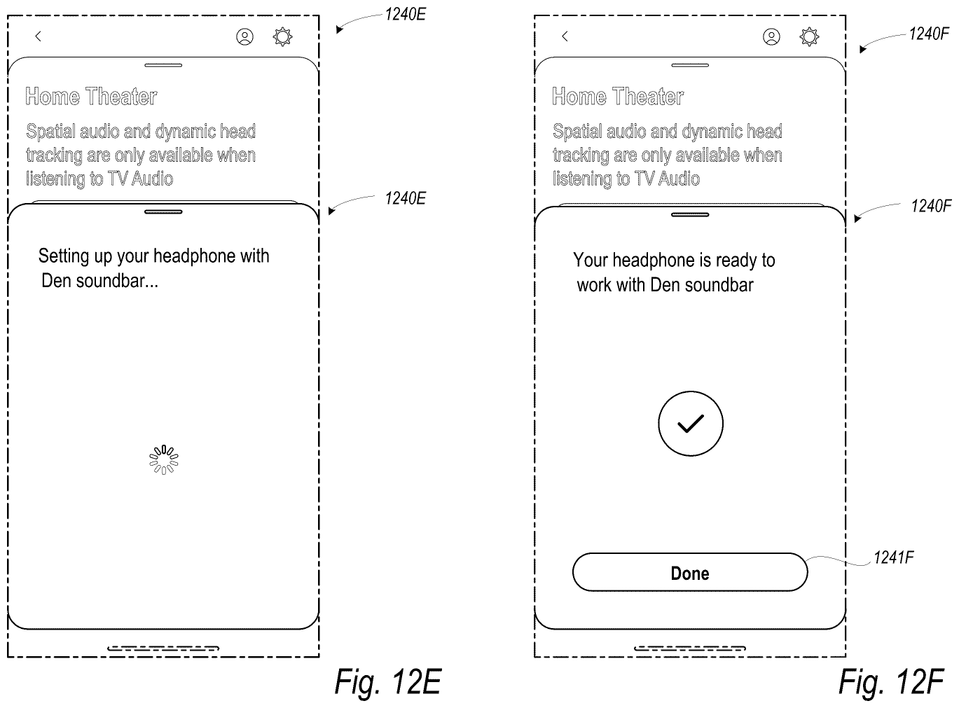

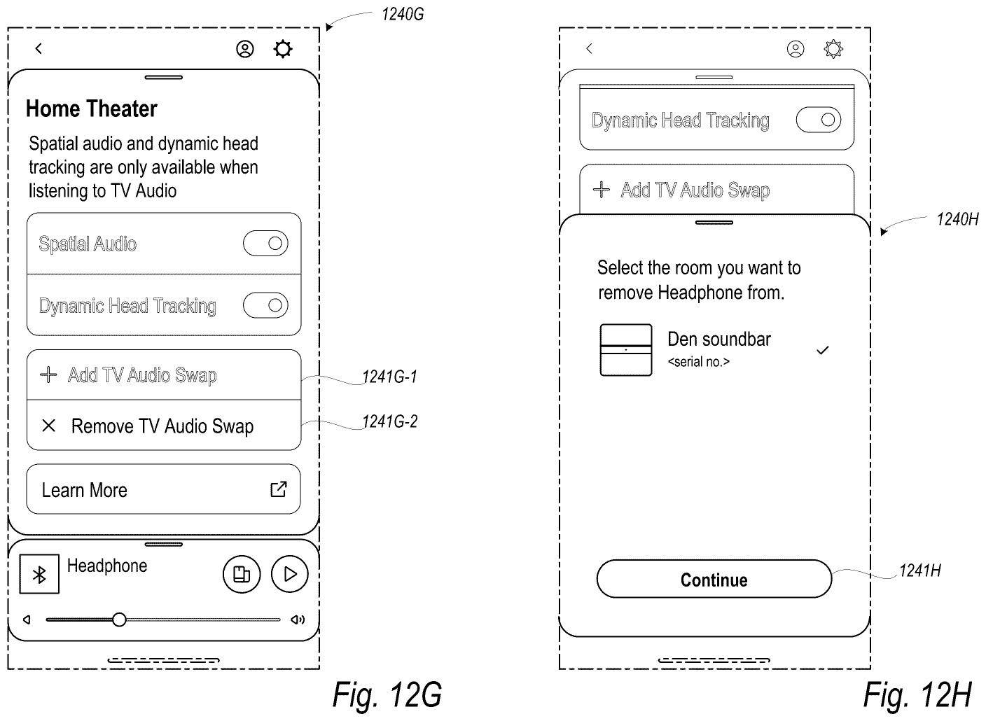

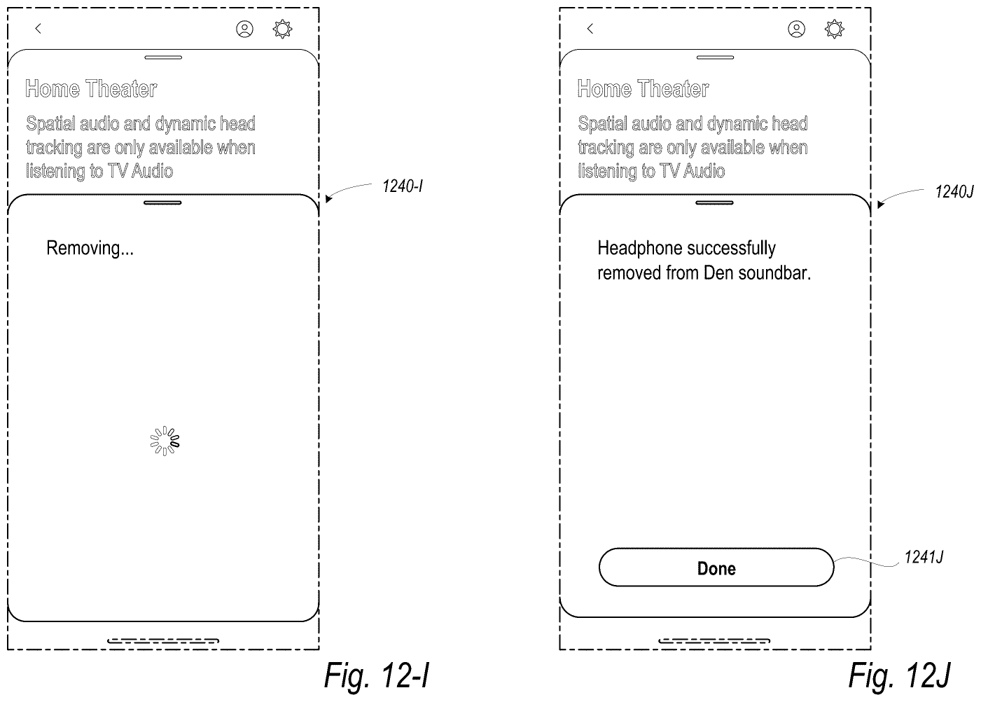

Shifting now to example controller interfaces, FIGS. 12A-12J show example controller interfaces 1240A-1240J (referred to collectively as the controller interfaces 1240) with graphical user interface elements for setup of sound swap. As noted above, the controller devices 104 may be used for setup and configuration of sound swap. To illustrate such control, the control interfaces 1240 are examples of graphical elements that may be displayed by the controller devices 104 to facilitate sound swap setup.

In particular, FIG. 12A shows a controller interface 1240A. In this example, a headphone (e.g., the headphones 702a) has already been setup with the controller device 104 that is displaying the controller interface 1240A (e.g., the controller device 104a) and is currently connected over Bluetooth to the controller device 104. The controller interface 1240A includes a control target region 1245A showing that the headphones 702a (named “Headphone”) are presently under control. Using the drop-down arrow to the right of the “Headphone” device name, a user may open a drop-down menu (not shown) to swap between control of the headphones 702a and the playback devices 102.

Below the control target region 1245A, the controller interface 1240A includes a headphone status region 1247A, a sources region 1248A, a search region 1250A, and a playback control/status region 1242A. The headphone status region 1247A shows that noise cancelling is currently enabled on the headphones 702a and that the battery level of the headphones 702a is presently 67%. Selecting (e.g., tapping) the headphone status region 1247A toggles the headphones 702a between ANC (active noise cancelling) mode, aware mode (i.e., passthrough, so that the user can hear external environmental sound), or off (both modes disabled). The playback control/status region 1242A includes transport controls (e.g., play/pause) and volume controls (here, a volume slider), as well as metadata indicating a currently playing audio track (by Adele) via Bluetooth (as indicated with the Bluetooth symbol).

The search region 1250A provides a search bar for searching sources registered with the media playback system (e.g., as described in connection with section II. d above). In some instances, the search region 1250A may be omitted when active control and/or the now playing screen is currently on the headphone. When the headphone is connected to the control device via Bluetooth, support for searching sources registered with the media playback system might not be available.

The controller interface includes two selectable controls 1241A that, when selected, cause the controller device 104a to display portions of the controller application graphical user interface related to setup. The selectable control 1241A-1 launches a setup wizard to configure of a trusted relationship with the playback device 102b (connected to the television 845) while the selectable control 1241A-2 launches a general configuration interface from which the setup wizard can be reached.

To illustrate, FIG. 12B shows a controller interface 1240B, which is an example of a configuration interface for the wearable playback device (here, the headphones 702a) that is paired to the controller device 104 that is displaying the controller interface 1240B (here, the controller device 104a). As shown, the controller interface 1240B includes a selectable control 1241B-1 that is selectable to toggle an enabled/disabled state of spatial audio. Similarly, a selectable control 1241B-2 is selectable to toggle an enabled/disabled state of dynamic head tracking.

The controller interface 1240B also includes a selectable control 1241B-3 that is selectable to launch a setup wizard to add a trusted home theatre primary. Conversely, a selectable control 1241B-4 is selectable to launch a setup wizard to remove a trusted accessory. Notably, the selectable control 1241B-4 is shown with shadow font to indicate that the selectable control 1241B-4 is disabled as no trusted accessory has previously been set-up to be removed.

By way of example, FIG. 12C shows a controller interface 1240C, which illustrates a first page of an example setup wizard to add a trusted home theatre primary. As shown, the controller interface 1240C is overlaid over a portion of the controller interface 1240B. A swipe control 1249C can be swiped downward to dismiss the setup wizard and return to the controller interface 1240B. Otherwise, the setup wizard may be continued by selecting the selectable control 1241C.

FIG. 12D shows a controller interface 1240D, which illustrates a second page of the example setup wizard to add a trusted home theatre primary. Here, a prompt asks for configuration that the headphone (here, the headphones 702a) should be set up to play audio from Den soundbar (which in this example is the home theatre primary 102b). A selectable control 1241D is selectable to continue with the setup wizard. Alternatively, the setup wizard may be ended using a swipe control 1249D.

FIG. 12E shows a controller interface 1240E, which illustrates a third page of the example setup wizard to add a trusted home theatre primary. Here, a prompt states that the headphone is being setup with the Den soundbar. This message indicates that the headphones 702a is being added as a trusted accessory with the playback device 102b (e.g., via the example message flow 1004 shown in FIG. 10B). After setup completes, the controller device 104a may display a confirmation.

FIG. 12F shows a controller interface 1240F, which illustrates a fourth page of the example setup wizard to add a trusted home theatre primary. Here, a prompt states that the headphone is ready to work with the Den soundbar. This message indicates that the headphones 702a is now added as a trusted accessory with the playback device 102b. The selectable control 1241F is selectable to end the setup wizard and return to the configuration interface. The system determines the number of home theatre primaries available to pair with when the setup wizard is run.

FIG. 12G shows a controller interface 1240G, which is an example of the configuration interface for the headphones 702a after the setup wizard. Here, in contrast to the selectable control 1241B-3 in FIG. 12B, the corresponding selectable control 1241G-1 is now disabled (since in this example there are no additional available home theatre primaries to pair with). If there were multiple playback devices 102 that could operate as home theatre primaries in the media playback system 100 (i.e., connect to the LAN 111), the corresponding selectable control 1241G-1 would still be enabled to facilitate additional pairings.

On the other hand, in contrast to the previously-disabled selectable control 1241B-4 in FIG. 12B, the corresponding selectable control 1241G-2 of the controller interface 1240G is now enabled. Selection of the selectable control 1241G-2 launches a setup wizard to remove a trusted accessory.

To illustrate, FIG. 12H shows a controller interface 1240H, which a first page of the setup wizard to remove a trusted accessory. Here, the playback device 102b (designated “Den soundbar”) is pre-selected since it is currently the only trusted home theatre primary configured. If multiple trusted home theatre primaries were configured, the controller interface 1240H would list additional home theatre primaries by name and serial number below the Den soundbar. The controller interface 1240H includes a selectable control 1241H, that when selected, confirms that the selected home theatre primary (here, the playback device 102b) should remove the headphones 702b as a trusted accessory and advances the setup wizard.

Notably, the controller device 104a may pull information on the trusted home theatre primary (or primaries) configured from the swap data structures 950a. That is, the playback device 102b (and/or additional trusted home theatre primaries) may appear in the control interface 1240H as possible trusted home theatre primaries to remove the headphones 702a from because they are represented in the swap data structures 950a as trusted home theatre primaries. By maintaining an up-to-date swap data structure 950a, the controller device 104a can updates its graphical interfaces 1240 accordingly.

FIG. 12I shows a controller interface 1240I, which illustrates a second page of the example setup wizard to remove a trusted accessory. Here, a prompt indicates shows “Removing . . . ” This message indicates that the headphones 702a are being removed as a trusted accessory from the home theatre primary (e.g., via the example message flow 1006 shown in FIG. 10C). After setup completes, the controller device 104a may display a confirmation.

By way of example, FIG. 12J shows a controller interface 1240J, which illustrates a third page of the example setup wizard to remove a trusted accessory. Here, a prompt states that the headphone is successfully removed from the Den soundbar. This message indicates that the headphones 702a are now removed as a trusted accessory from the playback device 102b. The selectable control 1241J is selectable to end the setup wizard and return to the configuration interface.

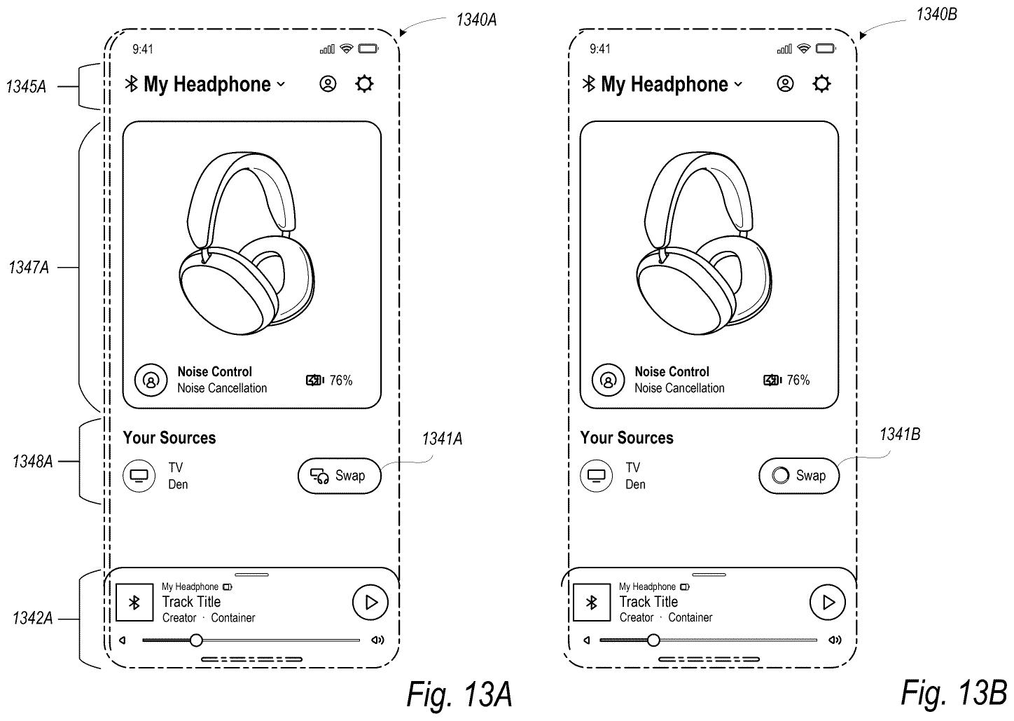

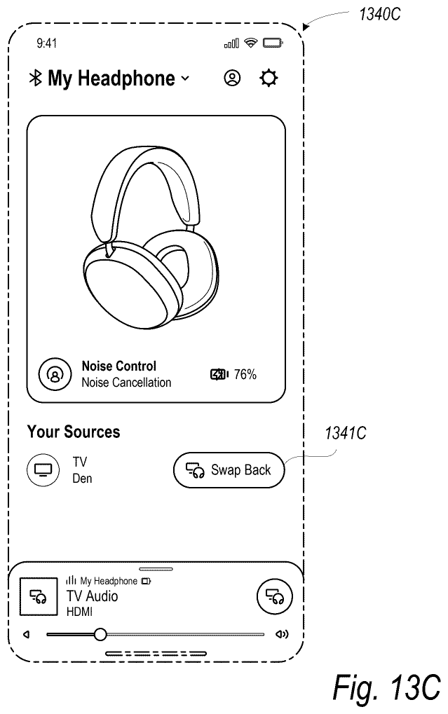

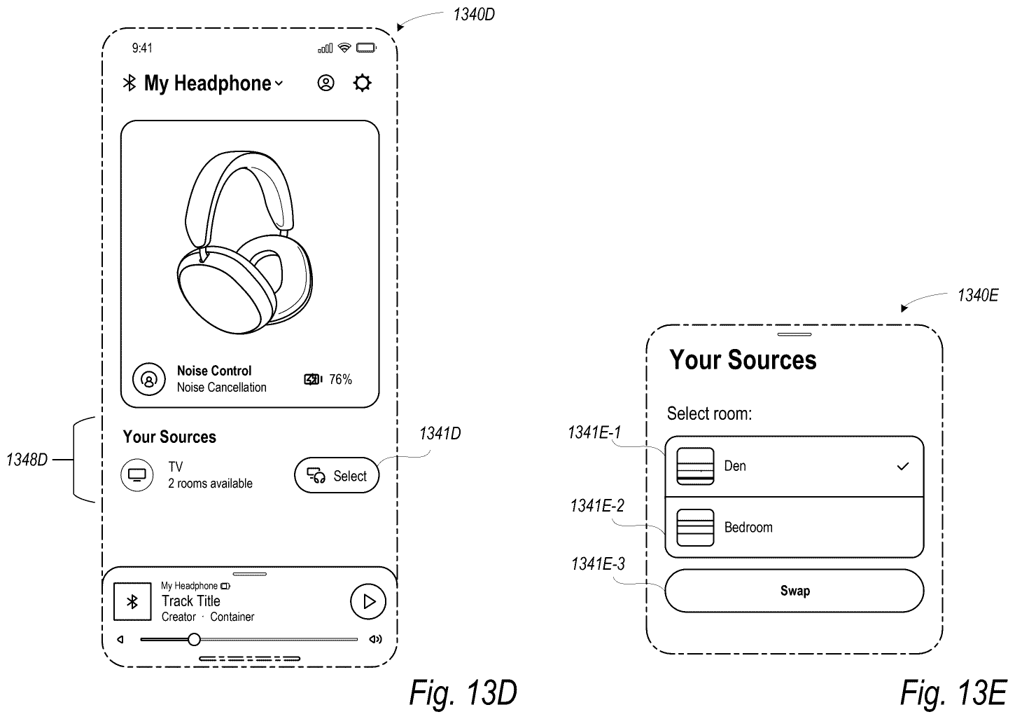

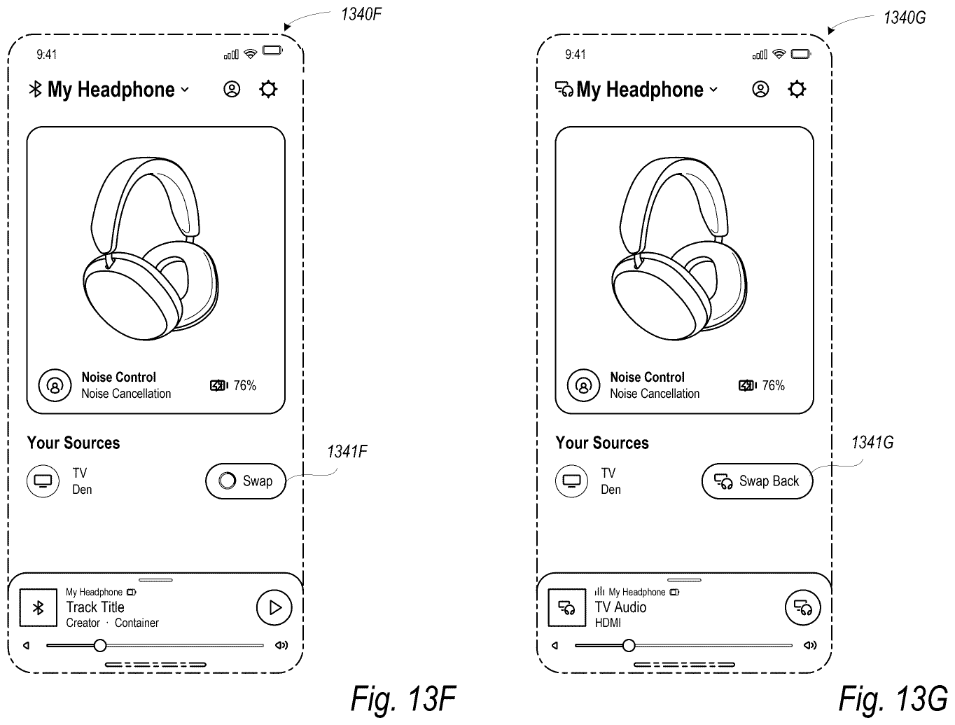

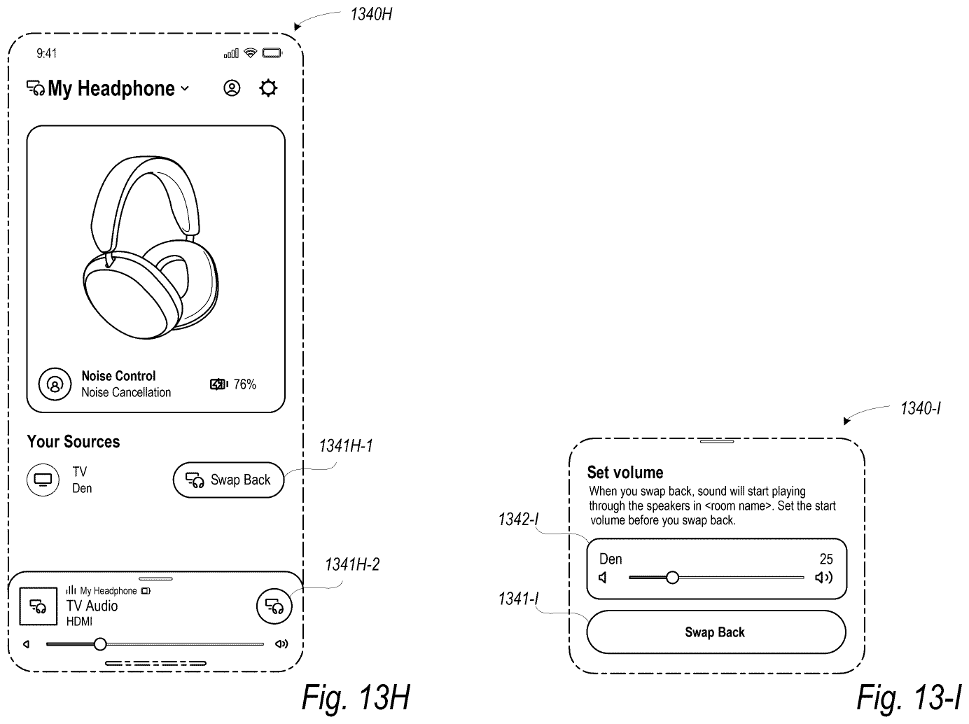

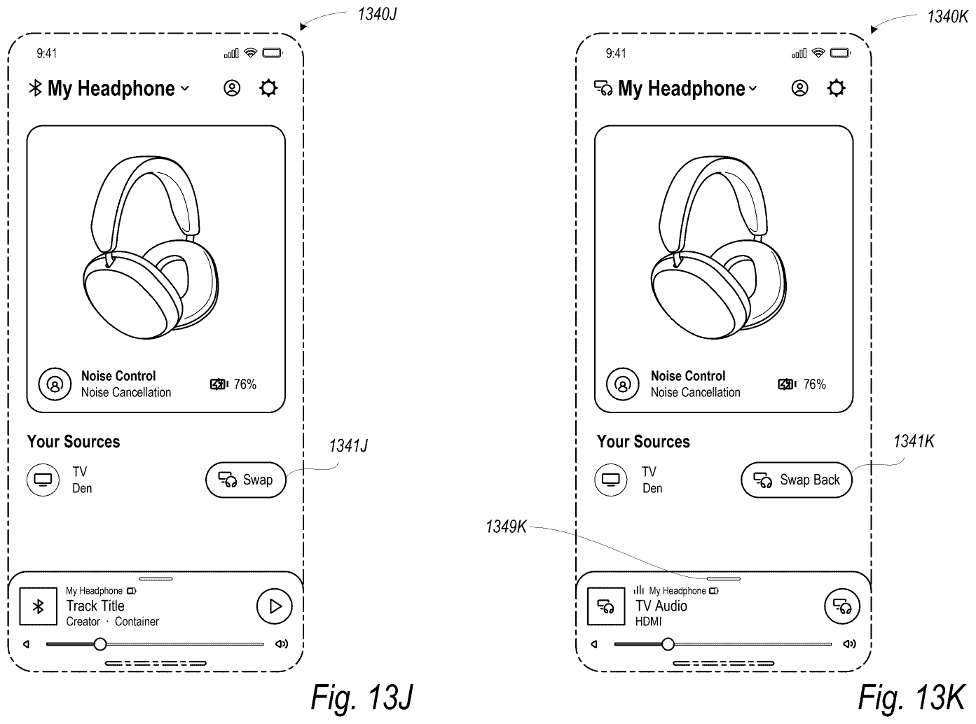

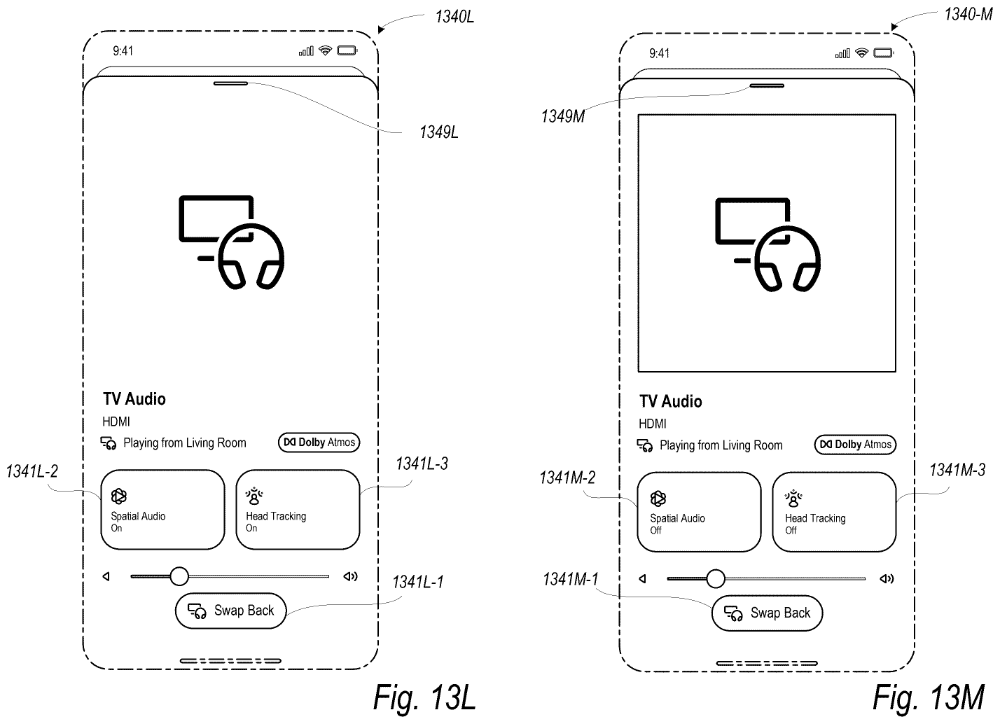

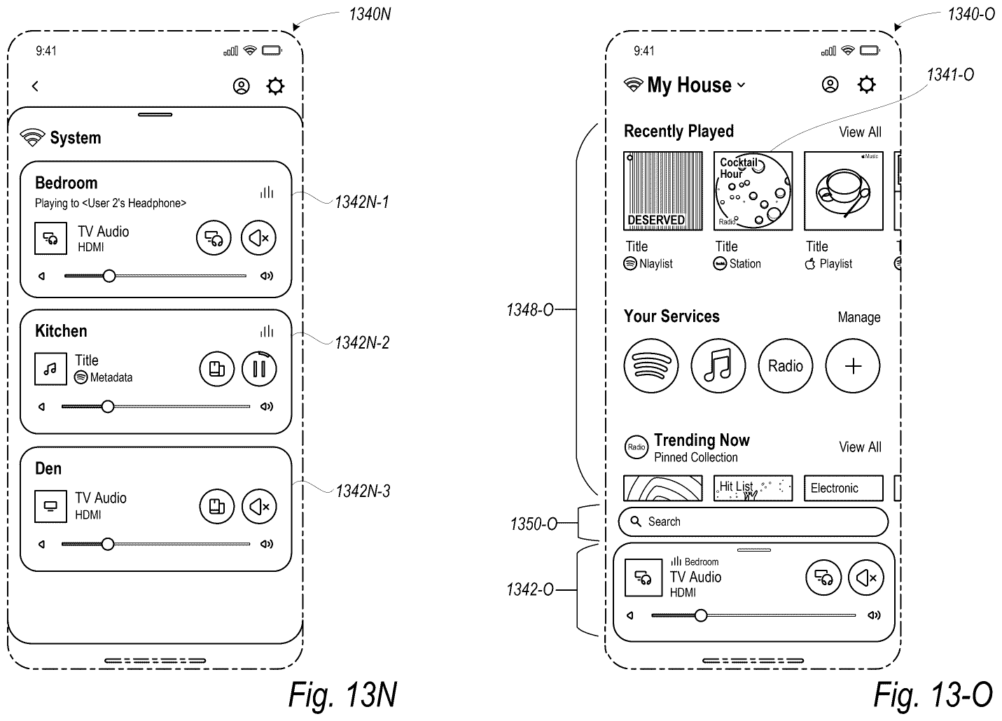

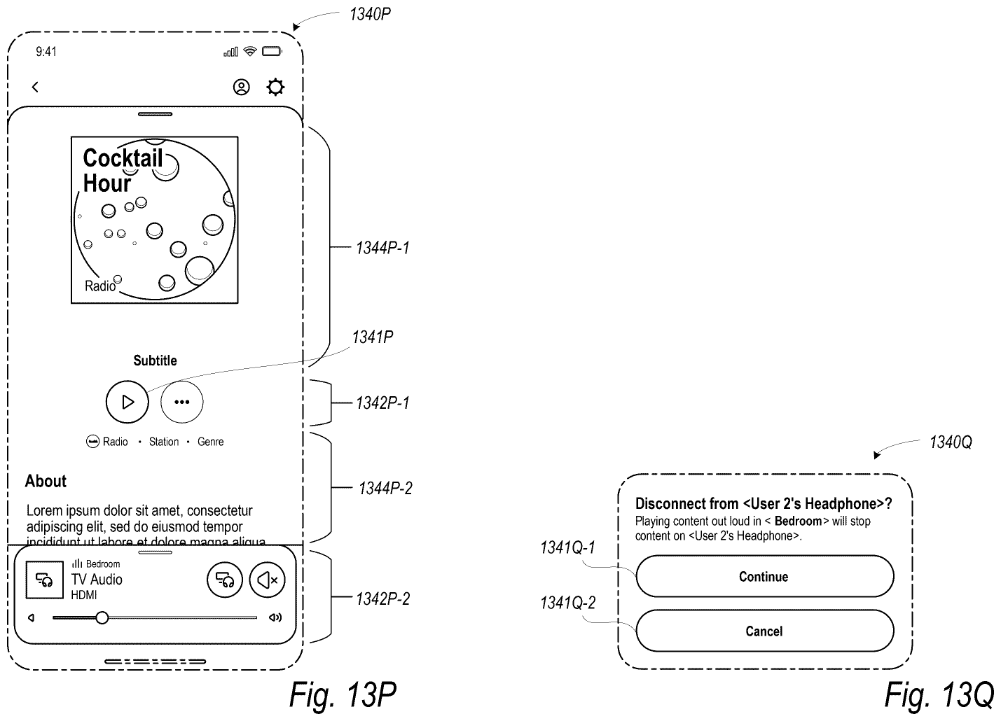

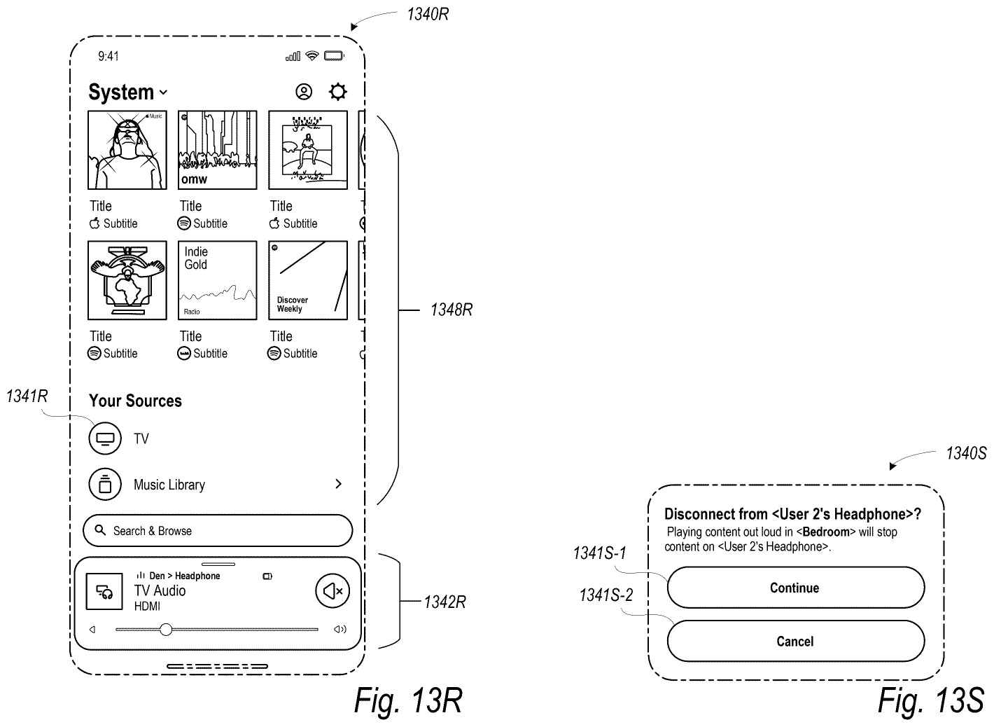

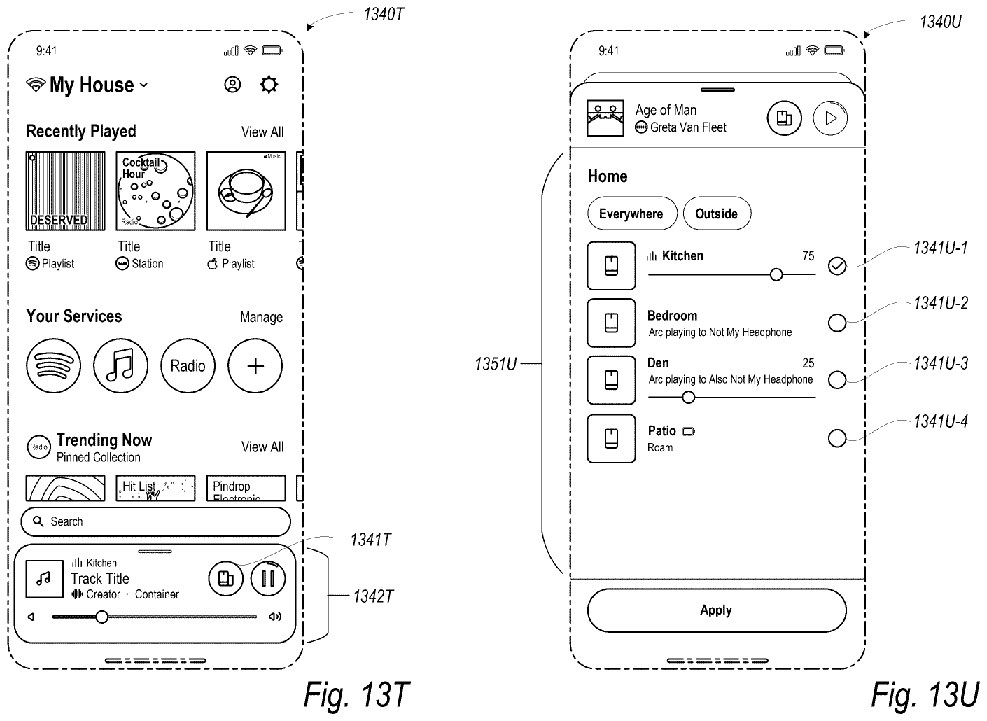

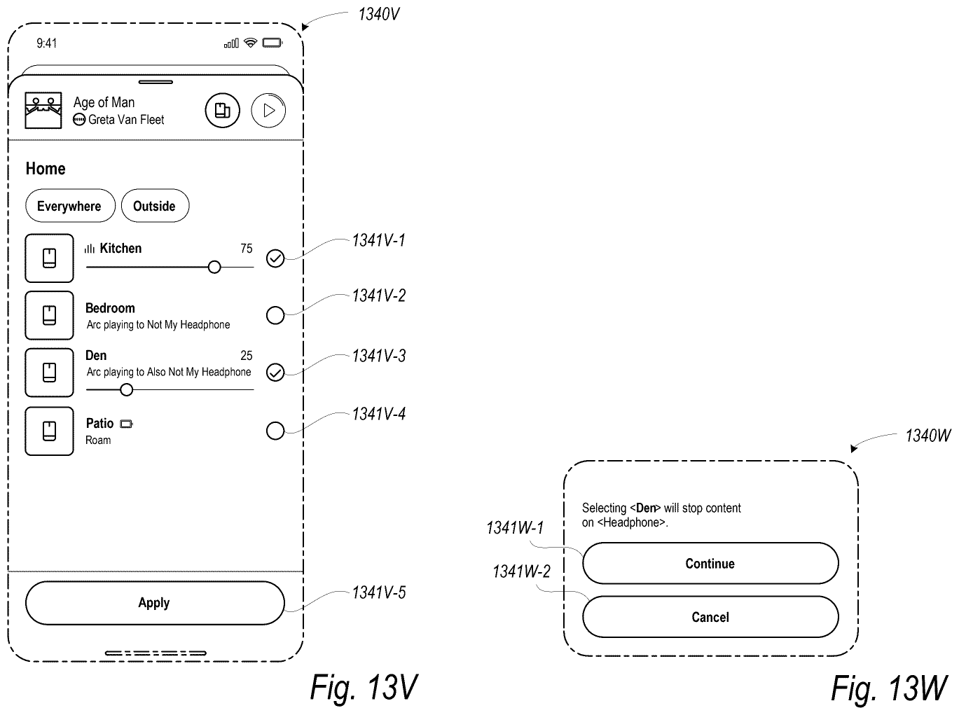

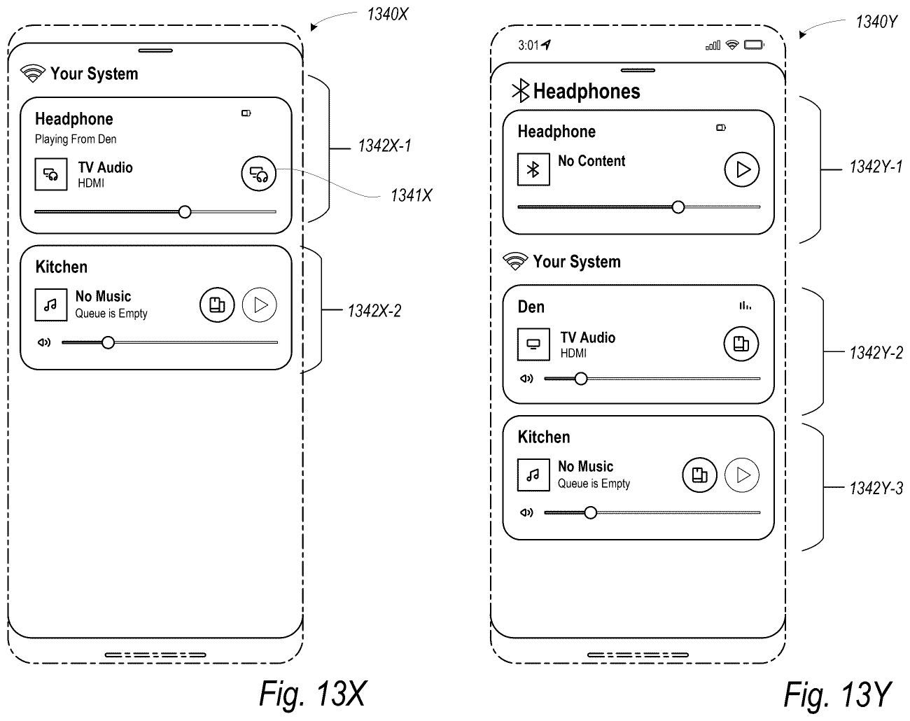

After one or more trusted accessories have been configured, the controller application of the controller device 104a may be used to facilitate sound swaps. FIGS. 13A-13Y show example controller interfaces 1340A-X, respectively (collectively referred to as the controller interfaces 1340). The controller interfaces 1340 are examples of graphical elements that may be displayed by the controller devices 104 to facilitate aspects of sound swap.

In particular, FIG. 13A shows a controller interface 1340A, which is similar to the controller interface 1240A (FIG. 12A). In this example, a headphone (e.g., the headphones 702a) has already been paired with the controller device 104 that is displaying the controller interface 1240A (e.g., the controller device 104a). The controller interface 1340A includes a control target region 1345A showing that the headphones 702a (named “Headphone”) are presently under control. Using the drop-down arrow to the right of the “Headphone” device name, a user may open a drop-down menu (not shown) to swap between control of the headphones 702a and the playback devices 102.

Below the control target region 1345A, the controller interface 1340A includes a headphone status region 1347A, a sources region 1348A, and a playback control/status region 1342A. The headphone status region 1347A shows that noise cancelling is currently enabled on the headphones 702a and that the battery level of the headphones 702a is presently 76%. The playback control/status region 1342A includes transport controls (e.g., play/pause) and volume controls (here, a volume slider), as well as metadata indicating a currently playing audio track via Bluetooth (as indicated with the Bluetooth symbol).

Within the source regions 1348A, the controller interface 1340A includes a selectable control 1341A that, when selected, causes the controller device 104a to trigger a sound swap between the headphones under present control (i.e., the headphones 702a) and a pre-configured home theatre primary (e.g., using the setup wizard described in connection with FIGS. 12C-12F). This button may be referred to as a swap button since it triggers a sound swap. The sound swap may be performed using a message flow, such as the example message flow 1008 (FIG. 10D). Here, since no home theatre swap session is in progress, the selectable control 1341A triggers a pull swap to start playback of the television audio on the headphones 702a (FIG. 8B).

The controller device 104a may show an indication that the sound swap is in progress. To illustrate, FIG. 13B shows a control interface 1340B that includes a modified version of the swap button, which is labeled as a selectable control 1341B. The selectable control 1341B is shown with a progress circle to indicate the in-progress state of the sound swap. The progress circle may also indicate a degree of progress (e.g., by percentage) of the sound swap. However, such an indication might not be necessary/useful since an example sound swap may occur relatively quickly (e.g., in a few seconds or less).

FIG. 13C shows a control interface 1340C that includes a further modified version of the swap button, which is labeled as a selectable control 1341C. The controller device 104d may display the selectable control 1341C while a home theatre swap session is in progress. Then, selection of the selectable control 1341C triggers a push swap to return playback of the television audio to the home theatre primary 102b (FIG. 8C). The text on the selectable control 1341C is different (“Swap Back”) from the selectable control 1341A (“Swap”) to indicate the relative swap directions (pull vs. push, respectively). In some instances, 1348D may show each available swap room separately with a swap button 1341D.

As noted above, in some cases, more than one home theatre primary is set up as a trusted home theatre primary. In such cases, the controller device 104d may alter the control interfaces 1340 accordingly. To illustrate, FIG. 13D shows a control interface 1340D. Here, the sources region 1348D shows that 2 rooms are available for home theatre swap. Further, relative to FIG. 13A, the swap button (labelled as a selectable control 1341D) is modified with the text “Select” rather than swap. This relabeling indicates that the selectable control 1341D does not immediately trigger swap, but instead triggers selection of a swap source from among available trusted home theatre primaries.

By way of example, FIG. 13E shows a control interface 1340E to facilitate selection of the swap source from among available trusted home theatre primaries. The control interface 1340E includes a selectable control 1341E-1 to select the playback device 102b in the Den 101d and also a selectable control 1341E-2 to select a different trusted home theatre primary 102 (e.g., in the Bedroom). Selection of the selectable control 1341E-3 triggers a pull swap with the selected trusted home theatre primaries in the control interface 1340E.

As noted above, the controller device 104a may pull information on the trusted home theatre primary (or primaries) configured from the swap data structures 950a. That is, the playback device 102b (and/or additional trusted home theatre primaries) may appear in the control interface 1240E as possible trusted home theatre primaries to swap with from because they are represented in the swap data structures 950a as trusted home theatre primaries. By maintaining an up-to-date swap data structure 950a, the controller device 104a can update its graphical interfaces 1340 accordingly.

In the control interface 1340E, the selectable control 1341E-1 is pre-selected as indicated with a checkmark. Within examples, the controller device 104a may pre-select a particular trusted home theatre primary that is in proximity to the controller device 104a (as this is most likely to be the swap source). Within examples, proximity may be determined by whether there is a BLE (Bluetooth Low Energy) connection between the controller device 104a and any of the trusted home theatre primaries as a proxy for proximity (given the limited range of BLE connections).

FIGS. 13F and 13G show a control interface 1340F and a control interface 1340G, respectively. The control interface 1340F and the control interface 1340G control are similar to the control interfaces 1340B and 1340C in that they show modifications to the swap button during and after the swap. In particular, in FIG. 13F, the swap button (labeled as a selectable control 1341F indicates that swap is in progress while in FIG. 13G, the swap button (labeled as a selectable control 1341G) is selectable to trigger a push swap to swap back.

As noted above, during a swap session, the controller device 104d may display a swap button to initiate a push swap. In some cases, there may be more than one swap button. FIG. 13H shows a control interface 1340E with two swap buttons. In the control interface 1340E, a selectable control 1341H-1 is selectable to initiate a push swap. Additionally, a selectable control 1341H-2 is also selectable to initiate a push swap.

Within examples, selection of one of the swap buttons of the control interface 1340E might not immediately initiate a push swap, but instead cause a prompt to set the volume of the home theatre primary. Such behavior may be useful to avoid unwanted and/or unexpectedly loud audio from the home theatre primary. To illustrate, FIG. 13-I shows a control interface 1340-I that may be displayed after selection of the selectable control 1341H-1 or the selectable control 1341H-2. The control interface 1340-I includes a playback control region 1342-I with a volume slider to adjust volume level of the playback devices 102 in the den 101d. A user may visually confirm or set volume level of the den 101d, and then selection of the selectable control 1341-I initiates the push swap.

After the push swap, the control interfaces 1340 revert to a state where a home theatre swap session is not on-going, as illustrated by FIG. 13J. As shown in FIG. 13J, the swap button (labelled as a selectable control 1341J) is again modified to indicate that selection of the selectable control 1341J initiates a pull swap. Here, playback on the headphones 702a is stopped, as evidenced by the play/pause button being in the play state (i.e., where selections initiates playback).

Some example wearable playback devices, such as the headphones 702a, support spatial audio, possibly with or without head tracking. Spatial audio can increase immersion by rendering the audio based on the user's head position and/or environment. At the same time, a user might not want to always have spatial audio enabled, depending on the content being played back and the activity that the user is engaged in, as well as personal preferences.

FIG. 13K shows a control interface 1340K, which is representative of a control interface during a home theatre swap session (note that a selectable control 1341K is in the “Swap Back” state to indicate selection causes a push swap to end the session). The control interface 1340K also includes a swipe control 1349K. Swiping on the swipe control 1349K causes display of another control interface with additional controls.

To illustrate, FIG. 13L shows a control interface 1340L that may be displayed after swiping on the swipe control 1349K during a home theatre swap session. As shown, the control interface 1340L includes a swap button (labelled as a selectable control 1341L-1). The control interface 1340L includes a selectable control 1341L-2 and a selectable control 1341L-3. The selectable control 1341L-2 is selectable to toggle an enabled/disabled state of spatial audio. The selectable control 1341L-2 also shows the current enabled/disabled state (here, enabled or “On”). Similarly, the selectable control 1341L-3 is selectable to toggle an enabled/disabled state of head tracking and also shows the shows the current enabled/disabled state (here, enabled or “On”). The control interface 1340L can be closed by swiping on the swipe control 1349L.

FIG. 13M shows a control interface 1340L after the spatial audio and head tracking features have been toggled to the disabled state. Here, a selectable control 1341M-2 and a selectable control 1341M-3 are similar to the selectable control 1341L-2 and the selectable control 1341L-3, but show the current state of spatial audio and head tracking as disabled (“Off”). The control interface 1340L also includes a swap button (a selectable control 1341M-1) and a swipe control 1349M to close the control interface 1340M.

In some examples, a user may want to play non-television audio (e.g., music) out-loud on a soundbar that is in a home theatre swap session (and thus has a wearable playback device 702 connected). In such examples, the controller device 104d may display a notification that causing such playback will interrupt the home theatre swap session. To illustrate, FIG. 13N shows a control interface 1340N, which is an example of a Rooms interface showing respective playback status/control regions for different rooms 101 in the media playback system 100. In particular, the control interface 1340N includes a playback status/control region 1342N-1 corresponding to the bedroom 101c, a playback status/control region 1342N-2 corresponding to the kitchen 101h, and a playback status/control region 1342N-3 corresponding to the den 101d.

The playback status/control region 1342N-1 indicates that a home theatre swap session is on-going in the bedroom 101c. Notably, the playback status/control region 1341N-1 shows that TV audio is playing and that this audio is playing to User 2's headphone (e.g., a user 844b playing on the headphones 702b). A user (e.g., the user 844a) that desires to play back non-television audio may select the playback status/control region 1342N-1, which causes display of a control interface for selecting content.

As an example, FIG. 13-O shows a control interface 1340-O that includes a sources region 1348-O, a search region 1350-O, and a playback control/status region 1342-O. The sources region 1348-O includes various tiles to select recently played containers (e.g., playlists, albums and radio stations) from various sources, other tiles to select particular services for further content selection within that service, and other tiles for trending content. Each tile is selectable to select the corresponding content or service. As one particular example, a selectable control 1341-O is selectable to select a “Cocktail Hour” radio station. When the selectable control 1341-O is selected, the controller device 104a displays another control interfaced with metadata about the selected content.

To illustrate, FIG. 13P shows a control interface 1340P. The control interface 1340P includes a playback status region 1344P-1 and a playback status region 1344P-2, each with respective metadata corresponding to the selected content. The control interface also includes a playback status/control region 1342P-1 with a play button (a selectable control 1341P) that is selectable to start playback of the selected content. Also shown is a playback status/control region 1342P-2 showing the current status of the bedroom 101c (i.e., the on-going home theatre swap session).

Here, selection of the selectable control 1341P causes playback of the selected audio content (i.e., the “Cocktail Hour” radio station), which would disrupt the on-going home theatre swap session. As such, when the selectable control 1341P is selected, the controller device 104a displays a notification that requests confirmation first. To illustrate, FIG. 13Q shows a control interface 1340Q with such a notification. The control interface 1340Q includes a selectable control 1341Q-1 that is selectable to confirm the playback (and thus stop the home theatre swap session) and also a selectable control 1341Q-2 that is selectable to cancel the playback (and thus not interrupt the home theatre swap session).

In some instances, a user may try to select a television source for out-loud playback in a room 101 that has an on-going home theatre swap session. For instance, FIG. 13R shows a control interface 1340R. The control interface 1340R may be displayed after selection of the bedroom 101c from the control interface 1340-O. As such, selection of any of the content in a sources region 1348R selects content for the bedroom 101c. For instance, a selectable control 1341R corresponds to television audio in the bedroom 101c. Presently, the user 844a of the controller device 104a that is displaying the control interface 1340T is playing television audio from the den 101d on their headphones 702a, as shown in the playback control/status region 1342T. However, this user may desire to start out-loud playback in the bedroom 101c and so selects the selectable control 1341R.

Since this will interrupt the on-going home theatre swap session in the bedroom 101c, the controller device 104d first displays a notification. To illustrate, FIG. 1340S shows a control interface 1340S with such a notification. The control interface 1340S includes a selectable control 1341S-1 that is selectable to confirm the playback (and thus stop the home theatre swap session) and also a selectable control 1341S-2 that is selectable to cancel the playback (and thus not interrupt the home theatre swap session).

In some instances, a user may desire to group a home theatre primary (e.g., via its associated room, such as grouping the den 101d (including the home theatre primary 101b) with the kitchen 101h. To facilitate grouping, FIG. 13T shows a control interface 1340T, which is similar to several of the other control interfaces 1340. Here, a selectable control 1341T is labeled within a playback control/status region 1342T. The selectable control 1341T is accessible to access a control interface to facilitate grouping. Here, content is already playing in the kitchen 101h, as shown in the playback control/status region 1342T.

By way of example, FIG. 13U shows a control interface 1340U, which is a control interface that may facilitate grouping. In particular, a grouping region 1351U includes respective indications of various rooms. In association with each room is a respective selectable control 1341U. In particular, in association with the kitchen 101h is a selectable control 1341U-1, in association with the bedroom 101c is a selectable control 1341U-2, in association with the den 101d is a selectable control 1341U-3, and in association with the patio 101i is a selectable control 1341U-4. Selection of any of the selectable controls 1341U toggles playback on/off in that zone.

Here, the selectable control 1341U-1 is already toggled on since playback was already on-going in the kitchen 101h (FIG. 13V). Selection of an additional selectable control 1341U selects an additional room for grouping between the kitchen 101h and the corresponding room. For instance, selection of the selectable control 1341U-3 selects the den 101d for grouping with the kitchen 101h.

To illustrate, FIG. 13V shows a control interface 1340V after the selectable control 1341V-3 is selected. Here, a selectable control 1341V-1 and a selectable control 1341V-3 are selected while a selectable control 1341V-2 and a selectable control 1341V-4 remain unselected. A selectable control 1341V-5 is selectable to confirm the grouping.

However, since this grouping will interrupt the on-going home theatre swap session in the den 101d, the controller device 104a may first display a notification. To illustrate, FIG. 13W shows a control interface 1340W with such a notification. The control interface 1340Y includes a selectable control 1341W-1 that is selectable to confirm the playback on the additional room (i.e., the den 101d, which thus groups the den 101d with the kitchen 101h and stops the home theatre swap session) and also a selectable control 1341W-2 that is selectable to cancel the playback (and thus not interrupt the home theatre swap session).

Information about the wearable playback devices 702, such as the headphones 704a, may be viewed concurrently with information regarding the rooms 101 in the media playback system. To illustrate, FIG. 13X shows a control interface 1340X with a system view with a playback control/status region 1342X-1 corresponding to the headphones 704a. The playback control/status region 1342A includes a swap button (the selectable control 1341X). Currently if selected the selectable control 1341X causes a swap back since a home theatre swap session is active (with the den 101d). Here, for the sake of example, only one additional control/status region 1342X is shown (a control/status region 1342X-2 corresponding to the kitchen 101h), but other examples could include a control/status region 1342X corresponding to each room 101 in the media playback system 100 (FIG. 1A). In this example, the system view could be scrollable to view additional control/status regions 1342X.

In some examples, the control/status regions are ordered and/or otherwise structured according to types and/or states of the playback devices. For instance, FIG. 13Y shows a control interface 1340Y with a system view with a playback control/status region 1342Y-1 corresponding to the headphones 704a. Here, the playback control/status region 1342Y-1 corresponding to the headphones 704a is separated in the system view from other playback control/status regions 1342Y corresponding to non-wearable playback devices 102, as illustrated by a playback control/status region 1342Y-2 and a playback control/status region 1342Y-3. Yet further, within examples the playback control/status region 1342Y-1 corresponding to the headphones 704a is displayed on top (i.e., first in the list) when the headphones 704a are connected to the controller device 104a (i.e., active and now playing). Conversely, the playback control/status region 1342Y-1 corresponding to the headphones 704a may be displayed on the bottom (i.e., last in the list) when the headphones 704a are not connected to the controller device 104a (i.e., not active).

In some examples, a request to initiate a pull swap may be prevented. For instance, a pull swap with a home theatre primary may be attempted when another wearable device is already connected to that home theatre primary. In further examples, a number of concurrent wearable playback devices 702 in a home theatre swap session is programmatically limited to facilitate good streaming performance of audio from the home theatre primary. In such cases, when a user attempts to join a session, the user's controller device 104 may inform the user of this already in use status.

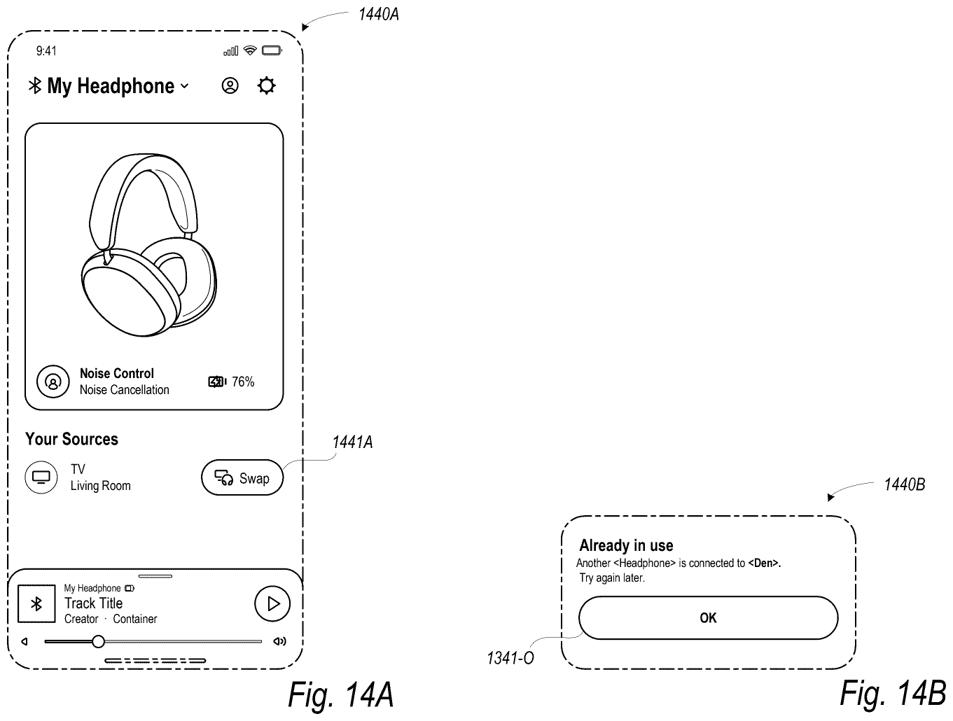

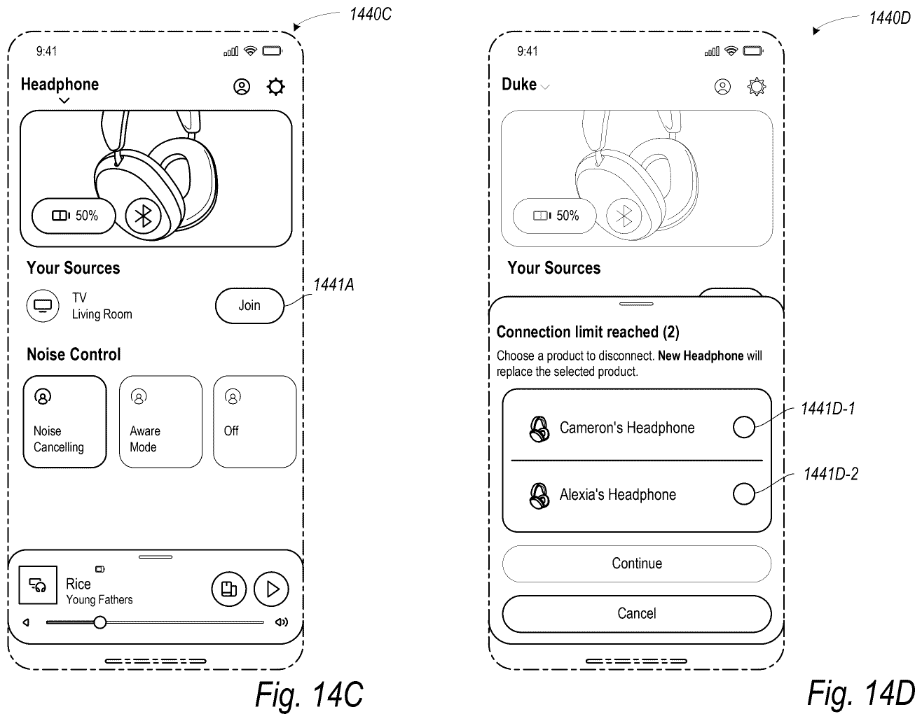

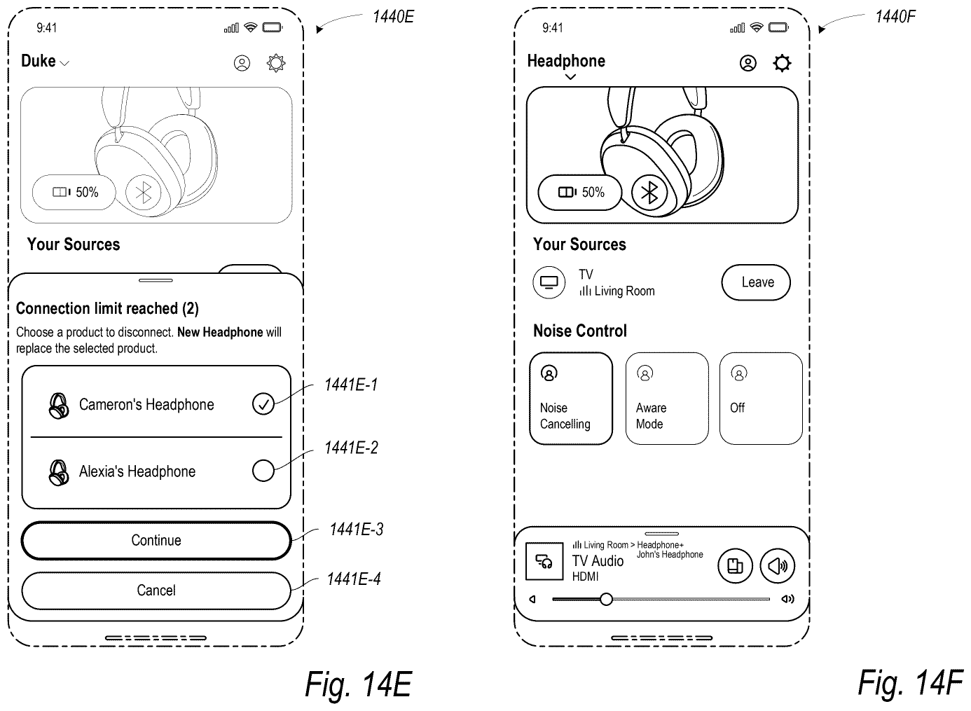

To illustrate, FIGS. 14A and 14B show a control interface 1440A and a control interface 1440B, respectively. FIG. 13A includes a swap button (a selectable control 1441A) similar to other previously discussed control interfaces 1340. Here, due to the in-use status of the home theatre primary, selection of the selectable control 1441A does not initiate a pull swap, but instead causes display of the control interface 1440B, which indicates this state. The control interface 1440B includes a selectable control 1440B that when selected, cause the control interface 1440B to close and return to another control interface (e.g., the control interface 1440A).

In further examples, when a number of concurrent wearable playback devices 702 in a home theatre swap session has been reached, the controller device 104 of the additional wearable playback device 702 displays a prompt to disconnect one of the existing wearable playback devices 702 in the home theatre swap session. To illustrate, FIG. 14C shows a control interface 1440C with a swap button (a selectable control 1441A). Here, the swap button is labeled “Join” since there is an existing home theatre swap session in progress.

Since the existing home theatre swap session is at capacity, when the selectable control 1441A is selected, a prompt is displayed to notify of this state and to optionally select one of the existing wearable playback devices 702 in the home theatre swap session to disconnect. To illustrate, FIG. 14D shows a control interface 1440D. The control interface 1440D includes a selectable toggle 1441D-1 and a selectable toggle 1441D-2 that are each selectable to select one or both of the existing wearable playback devices 702 in the home theatre swap session to disconnect.

FIG. 14E shows a control interface 1440E, which is similar to the control interface 1440E. The control interface 1440E includes a selectable toggle 1441E-1 and a selectable toggle 1441E-2 that are each selectable to select one or both of the existing wearable playback devices 702 in the home theatre swap session to disconnect. In contrast to the control interface 1440 of FIG. 14D, one of the selectable toggles has been selected (here the selectable toggle 1441E-1) and this state is indicated by a change in appearance of the toggle, as shown.

Once selections have been made, the selections can be confirmed via selection of a selectable control 1441E-3. Selection of this control causes the selected wearable playback device 702 to be removed from the existing home theatre swap session and the additional wearable playback device 702 to be added to the existing home theatre swap session. FIG. 1440F then shows a control interface 1440F with information about this state of the additional wearable playback device 702 in the session.

### IV. Example Sound Swap Methods

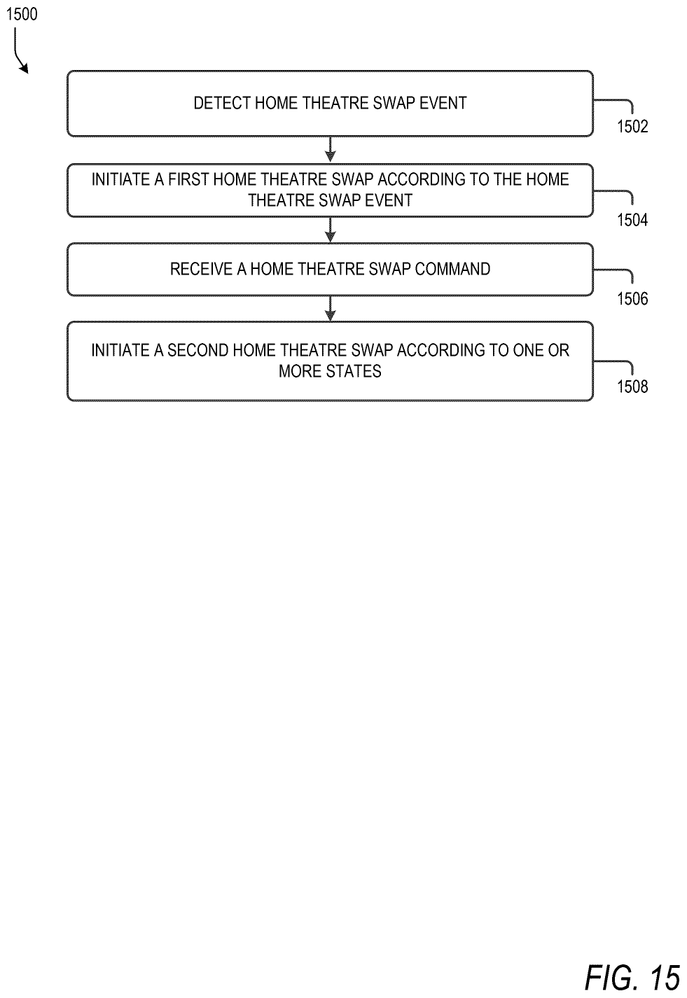

As noted previously, some example technologies may involve sound swap. To illustrate, FIG. 15 is a flow diagram showing an example method 1500 for sound swap. All or some of the method 1500 may be performed by a non-wearable playback device, such as a playback device 102 (FIGS. 1A and 1B) and a wearable playback device, such the wearable playback device 702 (FIG. 7), as well as a bonded zone of playback devices 102, or a group of playback devices 102. Alternatively, all or some of the method 1500 may be performed by any suitable device or by a system of devices, such as any of the playback devices 102, NMDs 103, controller devices 104, computing devices 105, and/or computing devices 106, or a combination thereof.

At block 1502, the method 1500 includes detecting a home theatre swap event. For instance, while a first home theatre swap session is active on a wearable playback device, such as the wearable playback device 702 (FIG. 7A), the wearable playback device 702 (or another device, such as a controller device 104 or a playback device 102) detects a home theatre swap event. Alternatively, detection of a home theatre swap event may occur while no home theatre swap session is active.

During the first home theatre swap session, the wearable playback device 702 is configured to play back one or more first audio tracks that are streamed from a playback device 102 during the first home theatre swap session. The first home theatre swap session may be initiated via a pull swap (FIG. 8B). The one or more first audio tracks are based on first audio received via an input interface from a television (FIG. 8A).

Examples of home theatre swap events are shown in the diagrams of FIG. 11C and FIG. 11D, as well as discussed throughout. In some examples, detecting the home theatre swap event involves detecting a change in state on the wearable playback device 702, the playback device 102 or the television 845, such as connection/disconnection from power, powering on/off, or a change in playback content. Other examples include direct commands, such as a swap or swap back command received via a user interface. Further examples include other events, such as incoming phone calls or donning/doffing the wearable playback device 702. Other examples are discussed throughout.

At block 1504, the method 1500 includes initiating a first home theatre swap according to the home theatre swap event. For example, the wearable playback device 702 (or another device, as noted above) may initiate a home theatre push swap according to the home theatre swap event (FIG. 8C). The wearable playback may initiate such a swap (e.g., push or pull) in respond to detection of the home theatre swap event. The home theatre push swap ends the first home theatre swap session, and when the first home theatre swap session ends, the wearable playback device 702 ceases playback of the one or more first audio tracks. Initiating a home theatre swap may involve a message flow, such as the example message flow, such as the message flows of 10A-10E, among other examples.

Within examples, different home theatre swap events initiate home theatre swaps with different end conditions (i.e., results). Such results may also differ based on one or more states. Examples of different results of a home theatre swap with different home theatre swap events and/or states are shown in FIGS. 11A, 11B, 11C, and 11D. As such, initiating a home theatre push swap according to the home theatre swap event may involve initiate a home theatre push swap having particular results of the swap based on the particular home theatre swap event detected and/or the one or more states.

At block 1506, the method 1500 includes receiving a home theatre command. For instance, while no home theatre swap session is active on the wireless headphone, one of (a) a controller device 104 or (b) a wearable playback device 702 may receive a home theatre swap command for the wireless headphone. For instance, the controller device may receive an input to a swap button, such as any of the example swap buttons described in connection with the example controller interfaces 1340 shown in FIGS. 13A-13Y. As another example, the wearable playback device 702 may receive a home theatre swap command via a user interface, such as the slider control 740a (FIG. 7C).

At block 1508, the method 1500 includes initiating a second home theatre swap according to one or more states. For example, the wearable playback device 702 may initiate a home theatre push swap according to (i) a state of the playback device 102 and (ii) a state of the wearable playback device 702. Examples of such states are shown in FIGS. 11A and 11B, and discussed throughout this disclosure. Within examples, the wearable playback device 702 may initiate such a swap (e.g., push or pull) in response to receipt of the home theatre swap command. Initiating a home theatre swap may involve a message flow, such as the example message flow, such as the message flows of 10A-10E, among other examples.

Within examples, the home theatre pull swap starts a second home theatre swap session. During the second home theatre swap session, the wearable playback device 702 is configured to play back one or more second audio tracks that are streamed from the playback device 102 (FIG. 8B). The one or more second audio tracks are based on second audio received via the input interface from the television (FIG. 8A).

Within examples, initiating the home theatre push swap may involve selecting the playback device 102 for the home theatre pull swap from among multiple swap-eligible playback devices 102 based on the playback device 102 being in Bluetooth Low-Energy (BLE) range of the wearable playback device 702. Alternatively, the playback device 102 may pre-selected in a graphical user interface based on the playback device 102 being in Bluetooth Low-Energy (BLE) range of the wireless headphone. Examples of such selection is described in connection with FIG. 13E. In some examples, the swap-eligible playback devices have been pre-configured in a data structure stored on the controller device, as described in connection with FIG. 9B.

In some examples, the method 1500 may include features involving one or more additional wearable playback devices 702, such as a home theatre swap session that includes multiple wearable playback devices 702 concurrently. For example, the method 1500 may include while the second home theatre swap session is active on a wearable playback device 702, receiving a first home theatre swap command for an additional wearable playback device 702. In response to the first home theatre swap command, the method 1500 includes initiating a home theatre pull swap. The home theatre pull swap adds the additional wearable playback device 702 to the second home theatre swap session concurrently with the wearable playback device 702. During the second home theatre swap session, the additional wearable playback device 702 is configured to play back the one or more second audio tracks that are streamed from the playback device 102.

Yet further, while the second home theatre swap session is active on the first wireless headphone and the second wireless headphone, the method 1500 may include receiving a second home theatre swap command for the additional wearable playback device 702. In response to the second home theatre swap command, the method 1500 may include removing the additional wearable playback device 702 from the second home theatre swap session. The wearable playback device 702 remains in the second home theatre swap session after the additional wearable playback device 702 is removed from the second home theatre swap session.

As another example, the method 1500 may include, while the second home theatre swap session is active on the wearable playback device 702 and the additional wearable playback device 702, receiving a first home theatre swap command for a further wearable playback device 702. In response to the first home theatre swap command, the method 1500 may include causing the further wearable playback device 702 to play back an earcon (e.g., an audible alert) indicating that home theatre swap command was unsuccessful when the second home theatre swap session is limited to two concurrent wearable playback devices 702. As noted above, in some cases, a home theatre swap session may be programmatically limited to a certain number of concurrent wearable playback devices 702 to promote streaming performance.

Yet further, the method 1500 may include while the second home theatre swap session is active on the wearable playback device 702 and the additional wearable playback device 702, receiving a second home theatre swap command for the further wearable playback device. In such examples, the method 1500 may further include displaying on a graphical user interface that is displayed on a touch-sensitive display of a controller device, a selection control that is selectable to select among the wearable playback device 702, the additional wearable playback device 702, and the further wearable playback device 702, for removal of the selected wearable playback device 702 from the second home theatre swap session.

The above example features of the method 1500 are not intended to be exhaustive. The method 1500 may additionally or alternatively include features from any of the example technologies disclosed herein.

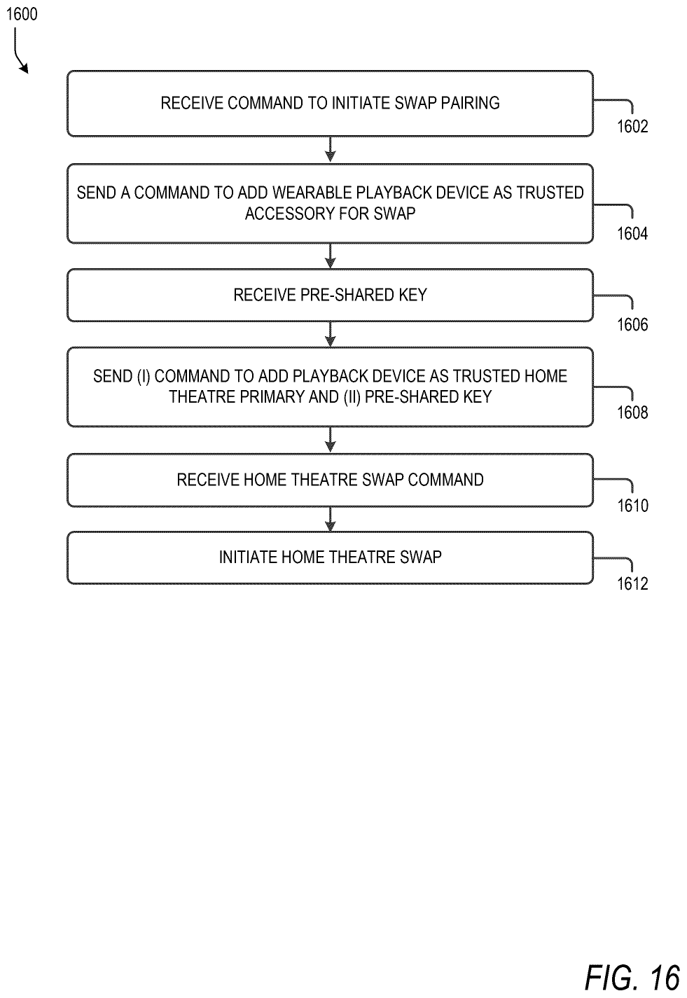

As noted previously, some example technologies may involve set up of sound swap. To illustrate, FIG. 16 is a flow diagram showing an example method 1600 for set up of sound swap. All or some of the method 1600 may be performed by a controller device, such as the controller devices 104. Alternatively, all or some of the method 1600 may be performed by any suitable device or by a system of devices, such as any of the playback devices 102, NMDs 103, computing devices 105, and/or computing devices 106, or a combination thereof.

At block 1602, the method 1600 includes receiving a command to initiate a swap pairing of a wearable playback device 702. For example, a controller device 104 may receive input data representing a command to initiate a swap pairing via a graphical user interface displayed on the controller device 104. Examples of controller interfaces that facilitate setup, including initiation of swap pairing, are shown in FIGS. 12A-12J.

At block 1604, the method 1600 includes sending a command to add a wearable playback device 702 as a trusted accessory for swap. For instance, the controller device 104 may send to a home theatre primary playback device 102, data representing a command to add the wearable playback device 702 as a trusted accessory for swap. An example of such a message is the addAccessoryWiFi( ) message at 1004a in FIG. 10B. Within examples, the controller device 104 may send such a message via a first wireless local area network (WLAN), such as the LAN 111 (FIG. 1B).

At block 1606, the method 1600 includes receiving a pre-shared key. For example, the controller device 104 may receive via the first WLAN from the playback device 102, a pre-shared key for a second WLAN. The second WLAN is used during a home theatre swap session to stream television audio (FIG. 9A). An example of such a message is the Pre-Shared Key message at 1004b in FIG. 10B.

At block 1608, the method 1600 includes sending a command to add the playback device 102 as a trusted home theatre primary and the pre-shared key. For instance, the controller device 104 may send, via a Bluetooth personal area network, data representing (i) a command to add the playback device 102 as a trusted home theatre primary and (ii) the pre-shared key. An example of such a message is the addWiFiHTprimary( ) message at 1004c in FIG. 10B. Upon receiving this message, the wireless headphone adds the playback device 102 as a trusted home theatre primary for swap.

At block 1610, the method 1600 includes receiving a home theatre swap command. For instance, the controller device 104 may receive a home theatre swap command for the wearable playback device 702 via a swap button, such as one of the selectable controls 1341 corresponding to swap buttons described in connection with FIGS. 13A-Y. Alternatively, the wearable playback device 702 may receive a home theatre swap command via the user interface 740 (FIG. 7A), such as via the slider control 740a (FIG. 7C).

At block 1612, the method 1600 includes initiating a home theatre pull swap. For instance, the controller device 104 and/or the wearable playback device 702 may initiate home theatre pull swap (or a push swap). The home theatre pull swap starts a home theatre swap session and causes the wearable playback device 702 to join the second WLAN using the pre-shared key. During the home theatre swap session, the wearable playback device 702 is configured to play back one or more audio tracks that are streamed from the home theatre primary via the second WLAN. The one or more audio tracks are based on audio received via an input interface of the home theatre primary from a television.

In some examples, the method 1600 includes adding the swap pairing between the wearable playback device 702 and the home theatre primary to a data structure. The data structure may include a swap pairing graph representing (i) trusted playback devices 102 for swap, (ii) trusted accessories for swap (e.g., the wearable playback devices 702), and (iii) mappings between the trusted playback devices 102 and the trusted accessories for swap, such as the swap data structures 950 (FIG. 9B). Further, the controller device 104 may display, in the graphical user interface, one or more graphical representations based on the swap pairing graph. Examples of such graphical representations are illustrated by the controller interfaces 1240 and the controller interfaces 1340, as described above.

In further examples, the method 1600 includes querying swap-eligible playback devices 102 for trusted accessories. Examples of such queries are shown in the message flow diagrams of FIGS. 10A-10E. The method 1600 may include receiving, from a playback device 102 in response to the query, data indicating that the wearable playback device 702 is a trusted accessory; and adding the swap pairing between the wearable playback device 702 and the playback device 102 to the data structure.

In some examples, the method 1600 includes when the swap pairing graph includes at least one pairing including the wearable playback device 702, enabling, in the graphical user interface on the controller device 104, a selectable control that is selectable to input a home theatre swap command. For instance, if there is a pairing available, the controller device 104 may display a swap button, as shown in FIG. 13A (the selectable control 1341A). Otherwise, the controller device 104 may display a setup button, as shown in FIG. 12A (the selectable control 1241A-1).

Within examples, the method 1600 includes during the home theatre swap session, querying swap-eligible playback devices 102 for connected accessories. The control device 104d may receive, from the playback device 102 in response to the query, data indicating that the wearable playback device 702 is a connected accessory and add the connection between the wireless headphone and the playback device to a data structure (e.g., the swap data structures 950 (FIG. 9B)).

In further examples, the method 1600 includes receiving, via a graphical user interface displayed on the controller device 104, input data representing a command to remove the swap pairing of the wearable playback device 702 and the playback device 102, as shown in FIGS. 12G-12J. Based on receiving the command to remove the swap pairing, the controller device 104 sends data representing a command to remove the wearable playback device 702 as a trusted accessory for swap, as illustrated in by the removeAccessory( ) message at 1006a in FIG. 10C. The controller device 104 receives a response indicating that the wearable playback device 702 was removed as a trusted accessory for swap, as shown by the acknowledgement at 1006. The controller device 104 sends data representing a command to remove the playback device 102 as a trusted home theatre primary, as illustrated by the removeHTprimary( ) message at 1006 in FIG. 10C.

The above example features of the method 1600 are not intended to be exhaustive. The method 1600 may additionally or alternatively include features from any of the example technologies disclosed herein.

### CONCLUSION

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

Example 1: A method comprising: while a first home theatre swap session is active on a wireless headphone, detecting, by one of (a) a controller device or (b) the wireless headphone, a home theatre swap event for the wireless headphone, wherein the wireless headphone is configured to play back one or more first audio tracks that are streamed from a playback device during the first home theatre swap session, and wherein the one or more first audio tracks are based on first audio received via an input interface from a television; in response to the first home theatre swap command, initiating a home theatre push swap according to the home theatre swap event, wherein the home theatre push swap ends the first home theatre swap session, and wherein the wireless headphone ceases playback of the one or more first audio tracks when the first home theatre swap session ends; while no home theatre swap session is active on the wireless headphone, receiving, by one of (a) the controller device or (b) the wireless headphone, a home theatre swap command for the wireless headphone; and in response to the home theatre swap command, initiating a home theatre pull swap according to (i) a state of the playback device and (ii) a state of the wireless headphone, wherein the home theatre pull swap starts a second home theatre swap session, wherein the wireless headphone is configured to play back one or more second audio tracks that are streamed from the playback device during the second home theatre swap session, and wherein the one or more second audio tracks are based on second audio received via the input interface from the television.

Example 2: The method of Example 1, wherein receiving the home theatre swap command for the wireless headphone comprises: receiving a particular input to a physical user interface of the wireless headphone.

Example 3: The method of Example 2, wherein detecting the home theatre swap event for the wireless headphone comprises: receiving another instance of the particular input to the physical user interface of the wireless headphone.

Example 4: The method of Example 2, wherein initiating the home theatre pull swap according to (i) the state of the playback device and (ii) the state of the wireless headphone comprises: selecting the playback device for the home theatre pull swap from among multiple swap-eligible playback devices based on the playback device being in Bluetooth Low-Energy (BLE) range of the wireless headphone, wherein the swap-eligible playback devices have been pre-configured in a data structure stored on the controller device.

Example 5: The method of any of Examples 1-4, wherein receiving the home theatre swap command for the wireless headphone comprises: receiving an input to a selectable swap control on a graphical user interface that is displayed on a touch-sensitive display of the controller device.

Example 6: The method of Example 5, wherein the method further comprises: before receiving the input to the swap control, displaying, on the graphical user interface, a selection control that is selectable to select among multiple swap-eligible playback devices for home theatre swap with the wireless headphone, wherein the playback device is pre-selected based on the playback device being in Bluetooth Low-Energy (BLE) range of the wireless headphone; and receiving an input to a selectable control that, when selected, confirms selection of the playback device for home theatre swap with the wireless headphone.

Example 7: The method of Example 5, wherein the method further comprises: during the first home theatre swap session, displaying, in place of the selectable swap control, a selectable swap back control, and wherein detecting the home theatre swap event for the wireless headphone comprises: receiving an input to the selectable swap back control.

Example 8: The method of any of Examples 1-7, wherein the wireless headphone is a first wireless headphone, wherein the method further comprises: while the second home theatre swap session is active on the first wireless headphone, receiving, by one of (a) an additional controller device or (b) a second wireless headphone, a first home theatre swap command for the second wireless headphone; and in response to the first home theatre swap command, initiating a home theatre pull swap, wherein the home theatre pull swap adds the second wireless headphone to the second home theatre swap session concurrently with the first wireless headphone, and wherein the second wireless headphone is configured to play back the one or more second audio tracks that are streamed from the playback device during the second home theatre swap session.

Example 9: The method of Example 8, wherein the method further comprises: while the second home theatre swap session is active on the first wireless headphone and the second wireless headphone, receiving, by one of (a) the additional controller device or (b) the second wireless headphone, a second home theatre swap command for the second wireless headphone; and in response to the second home theatre swap command, removing the second wireless headphone from the second home theatre swap session, wherein the first wireless headphone remains in the second home theatre swap session after the second wireless headphone is removed from the second home theatre swap session.

Example 10: The method of Example 8, wherein the at least one non-transitory computer-readable medium further comprises program instructions that are executable by the at least one processor such that the system is configured to: while the second home theatre swap session is active on the first wireless headphone and the second wireless headphone, receive, by a third wireless headphone, a first home theatre swap command for the third wireless headphone; in response to the first home theatre swap command, causing the third wireless headphone to play back an earcon indicating that home theatre swap command was unsuccessful, wherein the second home theatre swap session is limited to two concurrent wireless headphones; while the second home theatre swap session is active on the first wireless headphone and the second wireless headphone, receiving, by a further controller device, a second home theatre swap command for the third wireless headphone; and in response to the second home theatre swap command, displaying, on a graphical user interface that is displayed on a touch-sensitive display of the further controller device, a selection control that is selectable to select among the first wireless headphone, the second wireless headphone, and the third wireless headphone for removal of the selected wireless headphone from the second home theatre swap session.

Example 11: The method of any of Examples 1-10, wherein the state of the playback device is playing back the second audio received via the input interface from the television, and wherein initiating the home theatre pull swap according to (i) the state of the playback device and (ii) the state of the wireless headphone comprises: stopping playback of the second audio on the playback device; and starting playback of the one or more second audio tracks on the wireless headphone.

Example 12: The method of any of Examples 1-11, wherein the state of the playback device is not playing back the second audio received via the input interface from the television, and wherein initiating the home theatre pull swap according to (i) the state of the playback device and (ii) the state of the wireless headphone comprises: causing the television to turn on via the input interface; and starting playback of the one or more second audio tracks on the wireless headphone.

Example 13: The method of Examples 12, wherein the state of the playback device is (i) playing back audio from a different source than the input interface from the television or (ii) not playing audio.

Example 14: The method of any of Examples 1-13, wherein the state of the wireless headphone is playing back audio streamed via a network interface from a different source than the playback device, and wherein initiating the home theatre pull swap according to (i) the state of the playback device and (ii) the state of the wireless headphone comprises: stopping playback of the audio streamed via the network interface from the different source; and starting playback of the one or more second audio tracks on the wireless headphone.

Example 15: The method of any of Examples 1-14, wherein initiating the home theatre push swap according to the home theatre swap event comprises: stopping playback of the one or more second audio tracks on the wireless headphone; and starting playback of the second audio on the playback device.

Example 16: The method of any of Examples 1-15, wherein the method further comprises: during the second home theatre swap session, receiving, via a graphical user interface of the controller device, input data representing (i) a selection of the playback device for playback and (ii) a selection of particular audio content; in response receiving the input data representing (i) a selection of the playback device for playback and (ii) a selection of particular audio content, displaying a prompt that includes a selectable confirmation control; and in response to receiving the input data representing selection of the selectable confirmation control: (a) ending the second home theatre swap session and (b) starting playback of the particular audio content on the playback device.

Example 17: The method of any of Examples 1-16, wherein the method further comprises: during the second home theatre swap session, receiving, via a graphical user interface of the controller device, data representing instructions to start an Airplay session on the playback device; in response to receiving the data representing instructions to start an Airplay session on the playback device, displaying a prompt that includes a selectable confirmation control; and in response to receiving the input data representing selection of the selectable confirmation control: (a) ending the second home theatre swap session and (b) starting the Airplay session on the playback device.

Example 18: The method of any of Examples 1-17, wherein the method further comprises: during the second home theatre swap session, receiving, via a graphical user interface of the controller device, data representing instructions to group the playback device with one or more additional playback devices; in response to receiving the data representing instructions to group the playback device with one or more additional playback devices, displaying a prompt that includes a selectable confirmation control; and in response to receiving the input data representing selection of the selectable confirmation control: (a) ending the second home theatre swap session and (b) grouping the playback device with the one or more additional playback devices.

Example 19: The method of any of Examples 1-18, wherein the home theatre push swap causes the playback device to continue playback of the first audio when the home theatre push swap ends the first home theatre swap session.

Example 20: The method of any of Examples 1-19, wherein the method further comprises: when the home theatre push swap ends the first home theatre swap session, causing a volume level of the playback device to be set to one of (i) a default volume, (ii) a user-defined volume, or (iii) a modified volume setting corresponding to a volume setting of the first wireless headphone when the first home theatre swap session is ended.

Example 21: A tangible, non-transitory, computer-readable medium having instructions stored thereon that are executable by one or more processors to cause a media playback system to perform the method of any one of Examples 1-20.

Example 22: A media playback system comprising a playback device and a headphone device, the media playback system configured to perform the method of any one of Examples 1-20.

Example 23: A controller device comprising a network interface, one or more processors, and a data storage having instructions stored thereon that are executable by the one or more processors to cause the playback device to perform the method of any of Examples 1-20.

Example 24: A wearable playback device comprising a network interface, one or more processors, and a data storage having instructions stored thereon that are executable by the one or more processors to cause the headphone device to perform the method of any of Examples 1-20.

Example 25: A method comprising: receiving, via a graphical user interface displayed on a controller device, input data representing a command to initiate swap pairing of the wireless headphone; based on receiving the command to initiate the swap pairing, sending, via a first wireless local area network (WLAN) to a playback device, data representing a command to add the wireless headphone as a trusted accessory for swap; receiving, via the first WLAN from the playback device, a pre-shared key for a second WLAN; sending, via a Bluetooth personal area network, data representing (i) a command to add the playback device as a paired home theatre primary and (ii) the pre-shared key, wherein the wireless headphone adds the playback device as a trusted playback device for swap; receiving, by one of (a) the controller device or (b) the wireless headphone, a home theatre swap command for the wireless headphone; and in response to the home theatre swap command, initiating a home theatre pull swap, wherein the home theatre pull swap starts a home theatre swap session and causes the wireless headphone to join the second WLAN using the pre-shared key, wherein the wireless headphone is configured to play back one or more audio tracks that are streamed from the playback device via the second WLAN during the home theatre swap session, and wherein the one or more audio tracks are based on audio received via an input interface of the playback device from a television.

Example 26: The method of Example 25, wherein the method further comprises: adding the swap pairing between the wireless headphone and the playback device to a data structure comprising a swap pairing graph representing (i) trusted playback devices for swap, (ii) trusted accessories for swap, and (iii) mappings between the trusted playback devices and the trusted accessories for swap; and displaying, in the graphical user interface, one or more graphical representations based on the swap pairing graph.

Example 27: The method of Example 26, wherein the method further comprises: querying swap-eligible playback devices for trusted accessories; receiving, from the playback device in response to the query, data indicating that the wireless headphone is a trusted accessory; and wherein adding the swap pairing between the wireless headphone and the playback device to the data structure comprising the swap pairing graph comprises: adding the swap pairing between the wireless headphone and the playback device to the data structure comprising the swap pairing graph when the data indicating that the wireless headphone is a trusted accessory is received from the playback device in response to the query.

Example 28: The method of Example 26, wherein displaying, in the graphical user interface, the one or more graphical representations based on the swap pairing graph comprises: when the swap pairing graph includes at least one pairing including the wireless headphone, enabling, in the graphical user interface on the controller device, a selectable control that is selectable to input a home theatre swap command.

Example 29: The method of Example 26, wherein displaying, in the graphical user interface, the one or more graphical representations based on the swap pairing graph comprises: when the swap pairing graph does not include at least one pairing including the wireless headphone and a swap-eligible playback device is detected, enable, in the graphical user interface on the controller device, a selectable control that is selectable to initiate the swap pairing of the wireless headphone.

Example 30: The method of any of Examples 25-29, wherein displaying, in the graphical user interface, the one or more graphical representations based on the swap pairing graph comprises: after adding the swap pairing between the wireless headphone and the playback device to the data structure, display a selectable control that is selectable to input a home theatre swap command in place of a selectable control that is selectable to initiate the swap pairing of the wireless headphone.

Example 31: The method of any of Examples 25-30, wherein the method further comprises: during the home theatre swap session, querying swap-eligible playback devices for connected accessories; receiving, from the playback device in response to the query, data indicating that the wireless headphone is a connected accessory; and adding the connection between the wireless headphone and the playback device to a data structure comprising a swap session graph representing (i) connected accessories, and (iii) mappings between the connected accessories and the playback device.

Example 32: The method of Example 31, wherein the method further comprises: when the swap session graph includes at least one mapping including the wireless headphone, enabling, in the graphical user interface on the controller device, a selectable control that is selectable to input a home theatre swap push command; receiving input data representing selection of the selectable control that selectable to input a home theatre swap push command; and based on receiving the input data representing selection of the selectable control that is selectable to input a home theatre swap push command, end the home theatre swap session.

Example 33: The method of Example 31, wherein the method further comprises: when the swap session graph includes at least one mapping including the wireless headphone, enabling, in the graphical user interface on the controller device, one or more selectable controls that are selectable to enable spatial audio on the wireless headphone during the home theatre swap session.

Example 34: The method of any of Examples 25-33, wherein the method further comprises: receiving, via the graphical user interface displayed on the controller device, input data representing a command to remove the swap pairing of the wireless headphone and the playback device; based on receiving the command to remove the swap pairing, send, via the first WLAN to the playback device, data representing a command to remove the wireless headphone as a trusted accessory for swap; receiving, via the first WLAN from the playback device, a response indicating that the that the wireless headphone was removed as a trusted accessory for swap; and sending, via the Bluetooth personal area network, data representing a command to remove the playback device as a paired home theatre primary.

Example 35: A tangible, non-transitory, computer-readable medium having instructions stored thereon that are executable by one or more processors to cause a media playback system to perform the method of any one of Examples 25-34.

Example 36: A media playback system comprising a playback device and a headphone device, the media playback system configured to perform the method of any one of Examples 25-34.

Example 37: A controller device comprising a network interface, one or more processors, and a data storage having instructions stored thereon that are executable by the one or more processors to cause the playback device to perform the method of any of Examples 25-34.

Example 38: A wearable playback device comprising a network interface, one or more processors, and a data storage having instructions stored thereon that are executable by the one or more processors to cause the headphone device to perform the method of any of Examples 25-34.

We claim:

1. A system comprising:
a controller device;
a wireless headphone;
one or more processors; and
at least one non-transitory computer-readable medium comprising program instructions that are executable by the one or more processors such that the system is configured to:
while a first home theatre swap session is active on the wireless headphone, detect, by one of (a) the controller device or (b) the wireless headphone, a home theatre swap event for the wireless headphone, wherein the wireless headphone is configured to play back one or more first audio tracks that are streamed from a playback device during the first home theatre swap session, and wherein the one or more first audio tracks are based on first audio received via an input interface from a television;
in response to detection of the home theatre swap event, initiate a home theatre push swap according to the home theatre swap event, wherein the home theatre push swap ends the first home theatre swap session, and wherein the wireless headphone ceases playback of the one or more first audio tracks when the first home theatre swap session ends;
while no home theatre swap session is active on the wireless headphone, receive, by one of (a) the controller device or (b) the wireless headphone, a home theatre swap command for the wireless headphone; and
in response to receipt of the home theatre swap command, initiate a home theatre pull swap according to (i) a state of the playback device and (ii) a state of the wireless headphone, wherein the home theatre pull swap starts a second home theatre swap session, wherein the wireless headphone is configured to play back one or more second audio tracks that are streamed from the playback device during the second home theatre swap session, and wherein the one or more second audio tracks are based on second audio received via the input interface from the television.

2. The system of claim 1, wherein the program instructions that are executable by the at least one processor such that the system is configured to receive the home theatre swap command for the wireless headphone comprise program instructions that are executable by the at least one processor such that the system is configured to:
receive a particular input to a physical user interface of the wireless headphone.

3. The system of claim 2, wherein the program instructions that are executable by the at least one processor such that the system is configured to detect the home theatre swap event for the wireless headphone comprise program instructions that are executable by the at least one processor such that the system is configured to:
receive another instance of the particular input to the physical user interface of the wireless headphone.

4. The system of claim 2, wherein the program instructions that are executable by the at least one processor such that the system is configured to initiate a home theatre pull swap according to (i) the state of the playback device and (ii) the state of the wireless headphone comprise program instructions that are executable by the at least one processor such that the system is configured to:
select the playback device for the home theatre pull swap from among multiple swap-eligible playback devices based on the playback device being in Bluetooth Low-Energy (BLE) range of the wireless headphone, wherein the swap-eligible playback devices have been pre-configured in a data structure stored on the controller device.

5. The system of claim 1, wherein the program instructions that are executable by the at least one processor such that the system is configured to receive the home theatre swap command for the wireless headphone comprise program instructions that are executable by the at least one processor such that the system is configured to:
receive an input to a selectable swap control on a graphical user interface that is displayed on a touch-sensitive display of the controller device.

6. The system of claim 5, wherein the at least one non-transitory computer-readable medium further comprises program instructions that are executable by the at least one processor such that the system is configured to:
before receipt of the input to the swap control, display, on the graphical user interface, a selection control that is selectable to select among multiple swap-eligible playback devices for home theatre swap with the wireless headphone, wherein the playback device is pre-selected based on the playback device being in Bluetooth Low-Energy (BLE) range of the wireless headphone; and
receive an input to a selectable control that, when selected, confirms selection of the playback device for home theatre swap with the wireless headphone.

7. The system of claim 5, wherein the at least one non-transitory computer-readable medium further comprises program instructions that are executable by the at least one processor such that the system is configured to:
during the first home theatre swap session, display, in place of the selectable swap control, a selectable swap back control, and wherein the program instructions that are executable by the at least one processor such that the system is configured to detect the home theatre swap event command for the wireless headphone comprise program instructions that are executable by the at least one processor such that the system is configured to:
receive an input to the selectable swap back control.

8. The system of claim 1, wherein the wireless headphone is a first wireless headphone, wherein the system further comprises a second wireless headphone, wherein the at least one non-transitory computer-readable medium further comprises program instructions that are executable by the at least one processor such that the system is configured to:
while the second home theatre swap session is active on the first wireless headphone, receive, by one of (a) an additional controller device or (b) the second wireless headphone, a first home theatre swap command for the second wireless headphone; and
in response to the first home theatre swap command, initiate a home theatre pull swap, wherein the home theatre pull swap adds the second wireless headphone to the second home theatre swap session concurrently with the first wireless headphone, and wherein the second wireless headphone is configured to play back the one or more second audio tracks that are streamed from the playback device during the second home theatre swap session.

9. The system of claim 8, wherein the at least one non-transitory computer-readable medium further comprises program instructions that are executable by the at least one processor such that the system is configured to:
while the second home theatre swap session is active on the first wireless headphone and the second wireless headphone, receive, by one of (a) the additional controller device or (b) the second wireless headphone, a second home theatre swap command for the second wireless headphone; and
in response to the second home theatre swap command, remove the second wireless headphone from the second home theatre swap session, wherein the first wireless headphone remains in the second home theatre swap session after the second wireless headphone is removed from the second home theatre swap session.

10. The system of claim 8, wherein the system further comprises a third wireless headphone, and wherein the at least one non-transitory computer-readable medium further comprises program instructions that are executable by the at least one processor such that the system is configured to:
while the second home theatre swap session is active on the first wireless headphone and the second wireless headphone, receive, by the third wireless headphone, a first home theatre swap command for the third wireless headphone;
in response to the first home theatre swap command, cause the third wireless headphone to play back an earcon indicating that home theatre swap command was unsuccessful, wherein the second home theatre swap session is limited to two concurrent wireless headphones;
while the second home theatre swap session is active on the first wireless headphone and the second wireless headphone, receive, by a further controller device, a second home theatre swap command for the third wireless headphone; and
in response to the second home theatre swap command, display, on a graphical user interface that is displayed on a touch-sensitive display of the further controller device, a selection control that is selectable to select among the first wireless headphone, the second wireless headphone, and the third wireless headphone for removal of the selected wireless headphone from the second home theatre swap session.

11. The system of claim 1, wherein the second state of the playback device is playing back the second audio received via the input interface from the television, and wherein the program instructions that are executable by the at least one processor such that the system is configured to initiate the home theatre pull swap according to (i) the state of the playback device and (ii) the state of the wireless headphone comprise program instructions that are executable by the at least one processor such that the system is configured to:
stop playback of the second audio on the playback device; and
start playback of the one or more second audio tracks on the wireless headphone.

12. The system of claim 1, wherein the second state of the playback device is not playing back the second audio received via the input interface from the television, and wherein the program instructions that are executable by the at least one processor such that the system is configured to initiate the home theatre pull swap according to (i) the state of the playback device and (ii) the state of the wireless headphone comprise program instructions that are executable by the at least one processor such that the system is configured to:
cause the television to turn on via the input interface; and
start playback of the one or more second audio tracks on the wireless headphone.

13. The system of claim 12, wherein the state of the playback device is (i) playing back audio from a different source than the input interface from the television or (ii) not playing audio.

14. The system of claim 1, wherein the state of the wireless headphone is playing back audio streamed via a network interface from a different source than the playback device, and wherein the program instructions that are executable by the at least one processor such that the system is configured to initiate the home theatre pull swap according to (i) the state of the playback device and (ii) the state of the wireless headphone comprise program instructions that are executable by the at least one processor such that the system is configured to:
stop playback of the audio streamed via the network interface from the different source; and
start playback of the one or more second audio tracks on the wireless headphone.

15. The system of claim 1, wherein the program instructions that are executable by the at least one processor such that the system is configured to initiate the home theatre push swap according to the home theatre swap event comprise program instructions that are executable by the at least one processor such that the system is configured to:
stop playback of the one or more second audio tracks on the wireless headphone; and
start playback of the second audio on the playback device.

16. The system of claim 1, wherein the at least one non-transitory computer-readable medium further comprises program instructions that are executable by the at least one processor such that the system is configured to:
during the second home theatre swap session, receive, via a graphical user interface of the controller device, input data representing (i) a selection of the playback device for playback and (ii) a selection of particular audio content;
in response to receipt of the input data representing (i) a selection of the playback device for playback and (ii) a selection of particular audio content, display a prompt that includes a selectable confirmation control; and
in response to receipt of the input data representing selection of the selectable confirmation control: (a) end the second home theatre swap session and (b) start playback of the particular audio content on the playback device.

17. The system of claim 1, wherein the at least one non-transitory computer-readable medium further comprises program instructions that are executable by the at least one processor such that the system is configured to:
during the second home theatre swap session, receive, via a graphical user interface of the controller device, data representing instructions to start an Airplay session on the playback device;
in response to receipt of the data representing instructions to start an Airplay session on the playback device, display a prompt that includes a selectable confirmation control; and
in response to receipt of input data representing selection of the selectable confirmation control: (a) end the second home theatre swap session and (b) start the Airplay session on the playback device.

18. The system of claim 1, wherein the at least one non-transitory computer-readable medium further comprises program instructions that are executable by the at least one processor such that the system is configured to:
during the second home theatre swap session, receive, via a graphical user interface of the controller device, data representing instructions to group the playback device with one or more additional playback devices;
in response to receipt of the data representing instructions to group the playback device with one or more additional playback devices, display a prompt that includes a selectable confirmation control; and
in response to receipt of the input data representing selection of the selectable confirmation control: (a) end the second home theatre swap session and (b) group the playback device with the one or more additional playback devices.

19. The system of claim 1, wherein the home theatre push swap causes the playback device to continue playback of the first audio when the home theatre push swap ends the first home theatre swap session.

20. The system of claim 19, wherein the at least one non-transitory computer-readable medium further comprises program instructions that are executable by the at least one processor such that the system is configured to:
when the home theatre push swap ends the first home theatre swap session, cause a volume level of the playback device to be set to one of (i) a default volume, (ii) a user-defined volume, or (iii) a modified volume setting corresponding to a volume setting of the first wireless headphone when the first home theatre swap session is ended.

21. At least one non-transitory computer-readable medium comprising program instructions that are executable by one or more processors such that a system is configured to:
while a first home theatre swap session is active on a wireless headphone, detect, by one of (a) a controller device or (b) the wireless headphone, a home theatre swap event for the wireless headphone, wherein the wireless headphone is configured to play back one or more first audio tracks that are streamed from a playback device during the first home theatre swap session, and wherein the one or more first audio tracks are based on first audio received via an input interface from a television;
in response to detection of the home theatre swap event, initiate a home theatre push swap according to the home theatre swap event, wherein the home theatre push swap ends the first home theatre swap session, and wherein the wireless headphone ceases playback of the one or more first audio tracks when the first home theatre swap session ends;
while no home theatre swap session is active on the wireless headphone, receive, by one of (a) the controller device or (b) the wireless headphone, a home theatre swap command for the wireless headphone; and
in response to receipt of the home theatre swap command, initiate a home theatre pull swap according to (i) a state of the playback device and (ii) a state of the wireless headphone, wherein the home theatre pull swap starts a second home theatre swap session, wherein the wireless headphone is configured to play back one or more second audio tracks that are streamed from the playback device during the second home theatre swap session, and wherein the one or more second audio tracks are based on second audio received via the input interface from the television.

22. A method comprising:
while a first home theatre swap session is active on a wireless headphone, detecting, by one of (a) a controller device or (b) the wireless headphone, a home theatre swap event for the wireless headphone, wherein the wireless headphone is configured to play back one or more first audio tracks that are streamed from a playback device during the first home theatre swap session, and wherein the one or more first audio tracks are based on first audio received via an input interface from a television;
in response to detecting the home theatre swap event, initiating a home theatre push swap according to the home theatre swap event, wherein the home theatre push swap ends the first home theatre swap session, and wherein the wireless headphone ceases playback of the one or more first audio tracks when the first home theatre swap session ends;
while no home theatre swap session is active on the wireless headphone, receiving, by one of (a) the controller device or (b) the wireless headphone, a home theatre swap command for the wireless headphone; and
in response to receiving the home theatre swap command, initiating a home theatre pull swap according to (i) a state of the playback device and (ii) a state of the wireless headphone, wherein the home theatre pull swap starts a second home theatre swap session, wherein the wireless headphone is configured to play back one or more second audio tracks that are streamed from the playback device during the second home theatre swap session, and wherein the one or more second audio tracks are based on second audio received via the input interface from the television.
